(19) United States
(12) Patent Application Publication
(10) Pub. No.: US 2026/0344688 A1
(43) Pub. Date: Nov. 5, 2026

(54) Inhibiting or Reducing Biological Contaminants in a Biological Matter During Long Term Isochoric Freezing Preservation

(71) Applicants: The Regents of the University of California, Oakland, CA (US); United States Department of Agriculture, Washington, DC (US)

(72) Inventors: Cristina Bilbao-Sainz Albany, Albany, CA (US); Alan Maida Albany, Berkeley, CA (US); Mathew Powell-Palm, Bozeman, MO (US); Tara McHugh, Albany, CA (US); Boris Rubinsky, El Cerrito, CA (US)

(21) Appl. No.: 19/490,207

(22) PCT Filed: Jun. 13, 2024
(86) PCT No.: PCT/US2024/033896

§ 371 Date: Dec. 4, 2025

Related U.S. Application Data
(60) Provisional application No. 63/472,914, filed on Jun. 14, 2023.

(51) Int. Cl. A23B 7/153

(52) U.S. Cl. CPC A23B 7/153

(57) ABSTRACT

The present disclosure provides methods and devices for inhibiting or reducing biological contaminants in biological matters during long term preservation while maintaining desired properties of the biological matter by applying the biological matter specific long term isochoric freezing or mild isochoric freezing treatment parameters.

### CROSS-REFERENCE TO RELATED APPLICATIONS

This application claims priority to U.S. Provisional Application Ser. No. 63/472,914 filed Jun. 14, 2023, the disclosure of which is incorporated by reference herein in its entirety.

### STATEMENT REGARDING FEDERALLY SPONSORED RESEARCH

This invention was made with government support under Grant Number 2018-67017-27826 awarded by the United States Department of Agriculture. The government has certain rights in the invention.

### TECHNICAL FIELD

The present disclosure relates to methods and devices for inhibiting or reducing biological contaminants in biological matters during long term preservation while maintaining desired properties of the biological matter by applying to the biological matter specific long term isochoric freezing or mild isochoric freezing treatment parameters.

### P

### BACKGROUND

Food preservation is fundamental to addressing the global challenge of food wastage, as food begins to spoil as soon as it is harvested. The primary goal of preservation is to inhibit biochemical reactions and prevent the growth of bacteria or fungi, thereby extending shelf life and minimizing waste. Traditional methods such as heating, drying, and freezing are widely implemented across industries and are effective in reducing pathogens and spoilage. However, these methods often come with significant drawbacks including nutrient loss, energy wastage, and changes in food texture and flavor, which can degrade the overall quality of the food product.

Specifically, heating can lead to the loss of essential nutrients and alter the food integrity, while conventional freezing involves complex thermodynamic and kinetic processes that may not always preserve the desired qualities of food. Freezing reduces the temperature of food to its freezing point, removes the latent heat of crystallization, and further decreases the temperature for storage. This process, while effective in extending shelf life, can also result in structural damage as water converts to ice. Given these challenges, there is a pressing need for innovative preservation methods that maintain food quality, nutritional content, and sensory properties.

Nowadays, consumers are more aware of the high nutritional value and health promoting benefits of fresh produce and have shown interest for minimally processed fruits and vegetables with natural color and flavor, high nutritional quality, and long shelf-life. There are many applications in which there is the need for storage of matter prone to biological contamination for extended period, from days to years. These applications include food, agricultural products, biological matter, and biotechnological matter.

There are several methods and devices for such a mode of preservation. The best-known method for long term preservation of biological matter, still employs the Napoleonic era invention of the tightly enclosed sterilized can. There has been no method or device that can maintain biological matter without biological growth for very long periods of time, similar to sealed canisters, except for isobaric (constant pressure) freezing. However, freezing causes the deterioration of the quality of the preserved matter. The food industry commonly uses thermal treatments at high temperatures, such as pasteurization, to extend the shelf life and assure the food safety of food. Novel technologies have emerged as an alternative to heat treatment to increase shelf life of food. One of the most popular technologies is high pressure processing (HPP) or high hydrostatic pressure. HPP is a commercially viable technology used for food pasteurization that can extend the shelf life of juices by applying pressures of up to 600 MPa for a few minutes. HPP involves low enough process temperatures to ensure that the thermolabile compounds do not degrade and sufficiently high pressures to inactivate microorganisms. It is common to preserve the food after sterilization by refrigerating it at 4 °C. However, microorganisms can grow at 4 °C and the product is sterile for limited periods of time of days. Thus, there is still a need to find good preservation technologies that inhibits or reduce growth of microbial contaminants while maintaining their fresh-like characteristics and nutritional value since none of these technologies have been adopted for commercial use by the food industry.

As one example, extracted pomegranate arils need to be preserved for a long period of time. Pomegranate is a highly perishable fruit and very sensitive to climatic conditions, such as heat, cold, water scarcity, heavy rain, and hail, causing disorders such as sun-burnt husk, husk scald or splits, and cracks in the husks. Also, pomegranates have a short two to three months harvest season. Furthermore, “ready-to-eat” pomegranate arils have become popular due to their convenience since the extraction of arils from pomegranate peel is a time-consuming process that can limit its consumption (Kapetanakou et al., 2015). However, extracted pomegranate arils have a greatly reduced postharvest life compared with whole fruit (Gil et al., 1996a). Microbial contamination and rapid metabolic processes, such as increased respiration and oxidation, quickly reduce the quality of the extracted arils and limit post-harvest life (Kapetanakou et al., 2015).

As another example, carrots (Daucus carota L.) are often consumed raw but are also used for juice production. Fresh carrot juice has a very short shelf life due to the high risk of microbial contamination from the high level of natural microbes (bacteria, yeasts, and molds) in the carrot root and its low acidity (pH~6.0) (Park, Lee, and Park, 2002). In addition, high enzymes activities from mainly peroxidase (POD), polyphenol oxidase (PPO), and pectin methylesterase (PME) cause significant degradation of carrot juice during juice extraction and storage. Both PPO and POD are involved in the enzyme browning mechanism that contributes to the deterioration of sensory quality and the reduction in content of biologically active ingredients like polyphenols (Marszałek, Krzyżanowska, Woźniak, & Skapska, 2016). Moreover, PME can lead to precipitation of pectin in juice with subsequent loss of cloudiness and viscosity (Sims, Balaban, & Matthews, 1993). As such, fresh carrot juice is recommended to be consumed within 1 to 2 days (Alklint, Wadsö, & Sjöholm, 2004). Thus, carrot juice needs to be preserved for a long period of time without growth of microbial contaminants in the juice.

Furthermore, raw milk, in its unprocessed and unpasteurized form, offers numerous health benefits that can enhance one's overall well-being. First and foremost, raw milk retains its natural enzymes, which aid in digestion and help the body absorb essential nutrients such as calcium and vitamins. These enzymes also contribute to the breakdown of lactose, making raw milk more easily digestible for individuals with lactose intolerance. Additionally, raw milk contains beneficial bacteria and probiotics that support a healthy gut microbiome, promoting optimal immune function and reducing the risk of allergies and asthma. Furthermore, raw milk is rich in vitamins A, D, and B12, as well as omega-3 fatty acids, which are crucial for brain development and cardiovascular health. When it comes to storage, maintaining the freshness and quality of raw milk is essential. To store raw milk properly, it is recommended to keep it in clean, airtight glass containers and store it in a refrigerator set at a temperature below 40 °F (4 °C). Additionally, raw milk should be consumed within a few days of obtaining it to maintain its freshness and minimize the risk of bacterial growth. Proper storage and timely consumption of raw milk can ensure its maximum nutritional benefits and provide a wholesome and nourishing experience.

As such, new postharvest storage technologies are required to extend the storage life of a biological matter without growth of microbial contamination in the biological matter, such as extracted arils, carrot juice or raw milk, while maintaining their fresh-like characteristics and nutritional value. This will extend the availability of biological matter in the market and increase the use thereof.

### SUMMARY

Special preservation methods and/or devices with specific combinations of isochoric parameters are needed for the combined goal of sterilization and maintaining the nutritional quality of the biological matter. Some properties (such as sterilization) of the post-preservation of biological matter may be more important than others (such as maintaining nutritional quality, structure of protein) and some requirements for destruction of microorganisms may be more important than others. Therefore, users can decide which aspects are more important to them, such as longer storage at higher subfreezing temperatures with better preservation of food quality or shorter storage at lower temperatures that ensures destruction of microorganisms at the expense of food quality.

Aspects of the present disclosure include a method for inhibiting biological contaminants during long term preservation of a biological matter comprising placing a biological matter in a fluid in an isochoric chamber and applying long term isochoric freezing to the fluid in the isochoric chamber at subfreezing temperature, thereby inhibiting biological contaminants of a biological matter during long term preservation of the biological matter while preserving both the microbial safety and the nutritional and sensory qualities of biological matter.

Aspects of the present disclosure also include a method for reducing or eliminating biological contaminants during long term preservation of a biological matter comprising placing a biological matter in a fluid in an isochoric chamber and applying long term isochoric freezing to the fluid in the isochoric chamber at subfreezing temperature, thereby reducing or eliminating biological contaminants of a biological matter during long term preservation of the biological matter while preserving both the microbial safety and the nutritional and sensory qualities of biological matter.

Aspects of the present disclosure also include a method for eliminating biological contaminants during long term preservation of a biological matter comprising placing a biological matter in a fluid in an isochoric chamber and applying short term isochoric freezing to the fluid in the isochoric chamber at subfreezing temperature, thereby eliminating biological contaminants of a biological matter during long term preservation of the biological matter while preserving both the microbial safety and the nutritional and sensory qualities of biological matter

In some aspects of the method, the biological matter is placed inside an isochoric chamber filled with an aqueous solution. In the isochoric freezing, a substantial portion of the volume remains unfrozen which is associated with an increase in pressure. In some embodiments, the biological matter is directly placed in the isochoric chamber. In other embodiments, the biological matter is placed in a matter container that can transfer pressure but does not transfer mass. In some embodiments, the isochoric chamber further contains a nucleating agent.

In some aspects of the method, long term is from hours to years. In some embodiments, long term is more than 24 hours and up to about 10 years.

In some aspects of the method, the subfreezing temperature is in the range of between 0 °C to −15 °C. In some embodiments, the subfreezing temperature is in the range of 0 °C to −10 °C, 0 °C to −7 °C, or 0 °C to −5 °C. In some embodiments, the isochoric freezing is at a pressure in the range of 0.1 MPa to 150 Mpa. In certain embodiments, the pressure of the isochoric freezing is in the range of 0.1 MPa to 100 Mpa, 0.1 Mpa to 60 Mpa, or 0.1 Mpa to 35 Mpa.

In some aspects of the method, the isochoric freezing is a mild isochoric freezing. In some embodiments, conditions of the mild isochoric freezing comprise mild pressures and mild sub-freezing temperatures. The mild isochoric freezing preservation significantly extends the shelf life of the biological matter while preserving both the microbial safety and the nutritional and sensory qualities of biological matter. In some embodiments, the mild subfreezing temperature is in the range of 0 °C to −5 °C. In some embodiments, the mild isochoric freezing pressure is in the range of between 0.1 Mpa to 15 Mpa.

In some aspects of the method, the biological matter is a cell, an organ, an organism, a biomedical product, an agricultural product, a food product, a fruit, or a beverage. In some embodiments, the beverage includes, but is not limited to, carrot juice, pomegranate juice, or milk. In other embodiments, the fruit includes pomegranate arils. In some embodiments, the food includes a dairy product, and a milk product. In certain embodiments, the biological matter is not pasteurized before the isochoric freezing preservation process.

In some aspects of the method, the contaminants are microorganisms, mold, fungi, pathogens, viruses, or spores.

Aspects of the present disclosure further include a device for long term preservation of a biological matter while maintaining desired nutritional value and inhibiting or reducing biological contaminants in the biological matter, comprising an isochoric chamber containing a biological matter, wherein the isochoric chamber is applied to long term isochoric freezing at subfreezing temperature.

Aspects of the present disclosure further include a device for long term preservation of a biological matter while maintaining desired nutritional value since and inhibiting or reducing biological contaminants in the biological matter, comprising an isochoric chamber containing a biological matter, wherein the isochoric chamber is applied to short term isochoric freezing at subfreezing temperature.

Certain aspects of the presently disclosed subject matter having been stated hereinabove, which are addressed in whole or in part by the presently disclosed subject matter, other aspects will become evident as the description proceeds when taken in connection with the accompanying Examples and Figures as best described herein below.

### BRIEF DESCRIPTION OF THE FIGURES

FIG. 1 shows a temperature-pressure phase diagram for water and comparison of path of freezing in an isochoric system and an isobaric system.

FIG. 2 shows the plot of the percentage of ice during isochoric freezing, more specifically the percentage of ice in an isochoric system as the temperature is lowered to the triple point.

FIG. 3 illustrates a typical isochoric chamber for isochoric freezing.

FIG. 4 illustrates one embodiment of an isochoric system comprising an isochoric chamber for preserving pomegranate arils.

FIG. 5 illustrates one embodiment of an isochoric system comprising an isochoric chamber for preserving whole pomegranates.

FIG. 6 illustrates one embodiment of an isochoric system comprising an isochoric chamber for preserving carrot juice.

FIG. 7 shows how a biological matter can be preserved at subfreezing temperatures while avoiding the formation of ice. As shown in FIG. 7, it is possible to reduce the temperature in isochoric freezing while avoiding damage from the formation of ice by placing the matter to be preserved in the unfrozen part of the volume.

FIG. 8 shows an isochoric freezing configuration with an isochoric chamber and a matter container for biological matter preservation.

FIG. 9 shows two containers that transfer pressure but not mass in the isochoric chamber, one with the biological material and the other with the sacrificial freezing solution while the entire isochoric chamber is filled with a fluid that does not freeze at the storage temperature (e.g., the fluid freezes at a temperature lower than the storage temperature.)

FIG. 10 shows appearance of fresh arils as well as preserved arils in whole fruit and fresh-cut arils after 30 days.

FIG. 11A shows effects of postharvest preservation technology on hardness of arils preserved in whole fruit or as fresh-cut arils after 30 days. FIG. 11B shows effects of postharvest preservation technology on crispiness of arils preserved in whole fruit or as fresh-cut arils after 30 days.

FIG. 11C shows effects of postharvest preservation technology on crunchiness of arils preserved in whole fruit or as fresh-cut arils after 30 days.

FIG. 12 is Cryo-SEM image of fresh pomegranate aril. Scale bar is 10 μm.

FIG. 13 is Cryo-SEM images of pomegranate arils preserved for 30 days using different techniques. (A) and (E) show cold storage at 5 °C/95% RH for arils preserved in whole fruit and fresh-cut arils, respectively. (B) and (F) show isochoric supercooling at −2.5 °C/0.1 MPa for arils preserved in whole fruit and fresh-cut arils, respectively. (C) and (G) show isochoric freezing at −2.5 °C/12 MPa for arils preserved in whole fruit and fresh-cut arils, respectively. (D) and (H) show isobaric freezing at −2.5 °C/0.1 MPa for arils preserved in whole fruit and fresh-cut arils, respectively. Scale bar is 10 μm.

FIG. 14 shows effects of postharvest preservation technology on anthocyanin content in arils from whole pomegranate and fresh-cut arils preserved for 30 days.

FIG. 15 shows effects of postharvest technology on ascorbic acid contents in arils from whole pomegranate and fresh-cut arils preserved for 30 days.

FIGS. 16A-16B show effects of postharvest technology on antioxidant activity in arils from whole pomegranate and fresh-cut arils preserved for 30 days. DPPH and ABTS·+ assays are used to determine the total antioxidant capacity of the arils. The correlation coefficient between the DPPH and ABTS·+ assays is 0.90, suggesting they are consistent in total antioxidant activity measurements. The antioxidant activity in fresh pomegranate arils is determined to be 3.96±0.37 mg TE·g-1 from the DPPH assay and 3.94±0.34 mg TE·g-1, from the ABTS·+ assay. FIG. 16A shows that antioxidant activity of arils from whole pomegranates declined during cold storage. In comparison, antioxidant activity increased for isochoric supercooled and isobaric frozen samples. FIG. 16B also shows that fresh-cut arils have lower antioxidant activity when compared with arils from whole pomegranates, regardless of the postharvest preservation technology. The cold stored and isochoric supercooled arils have the highest antioxidant activities, whereas the isochoric frozen and isobaric frozen arils show the greatest loss in antioxidant activities.

FIGS. 17A-17E show effects of heat treatment (HT) followed by cold storage at 4 °C and isochoric freezing (IF) on the chromatic parameters of carrot juice. Data represents means and interval plots at 95% confidence interval. The red dashed lines across the charts indicated the values for fresh carrot juice. FIG. 17A shows that lightness (L*) of fresh carrot juice is 42.5±1.7. FIG. 17B shows redness (a) of fresh carrot juice is 17.8±3.5. FIG. 17C shows that yellowness (b*) of fresh carrot juice is 25.3±3.0. The IF −5 °C sample has greater increases in L, a*, b* values (7%, 26%, and 24%, respectively) than the IF −10 °C sample (3.4%, 18% and 19%, respectively). FIG. 17D show that hue (h*) decreases (p≤0.05) by 5.4% for IF −5 °C and 4.0% for IF −10 °C. The hue (h*) represents the visual color of the juice based on a* and b* values indicating red color development. FIG. 17E shows chroma (C*) of fresh carrot juice. The chroma also increases by 28% for both IF samples. These results indicate that IF samples have a deeper orange color, which might be due to the increases in carotenoid contents from better extractability value.

FIG. 18 shows effects of heat treatment (HT) followed by cold storage at 4 °C and isochoric freezing (IF) on total carotenoid content of carrot juice. Data represented means and interval plots at 95% confidence interval. The red dashed line across the chart indicated the value for fresh carrot juice.

FIG. 19 show effects of heat treatment (HT) followed by cold storage at 4 °C and isochoric freezing (IF) on total soluble phenolics of carrot juice. Data represented means and interval plots at 95% confidence interval. The red dashed line across the chart indicated the value for fresh carrot juice.

FIG. 20 shows effects of heat treatment (HT) followed by cold storage at 4 °C and isochoric freezing (IF) on antioxidant capacity of carrot juice. Data represented means and interval plots at 95% confidence interval. The red dashed line across the chart indicated the value for fresh carrot juice.

FIG. 21 shows percent change in color difference between different IF treatments and RF (refrigerated) raw milk: ΔE %=[(ΔL* %)²+(Δa* %)²+(Δb*)²]^{0.5}

FIG. 22 shows effects of different IF treatments and RF (refrigerated) raw milk. Values are the means of data sets, and the standard deviation is indicated by the vertical error bars.

FIG. 23 shows comparison of microbial evolution in Total Aerobic Mesophiles (TAM) under different storage conditions: atmospheric pressure (0.1 MPa) at 4 °C (RF), supercooled at −1.5 °C (S), and isochoric freezing (IF) at −1.5 °C/15 MPa.

FIG. 24 shows comparison of microbial evolution in Pseudomonas Species (PS) under different storage conditions: atmospheric pressure (0.1 MPa) at 4 °C (RF), supercooled at −1.5 °C (S), and isochoric freezing (IF) at −1.5 °C/15 MPa.

### DETAILED DESCRIPTION

The present disclosed subject matter now will be described more fully hereinafter with reference to the accompanying Figures, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Figures. Therefore, it is to be understood that the presently disclosed subject matter is not to be limited to the specific embodiments disclosed and that modifications and other embodiments are intended to be included within the scope of the appended claims.

Section headings as used in this section and the entire disclosure herein are merely for organizational purposes and are not intended to be limiting.

### 1. DEFINITIONS

Before the present invention is further described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications mentioned herein are incorporated herein by reference to disclose and describe the methods and/or materials in connection with which the publications are cited.

As used herein, the term “isochoric freezing” refers to the freezing of aqueous solutions in a constant volume chamber or in a rigid chamber. In isochoric freezing, the phase transition encompasses the entire volume when cooling below the liquidus line and a substantial portion of the volume remains unfrozen to the triple point temperatures and pressures and is associated with an increase in pressure.

As used herein, the term “mild isochoric freezing” refers to isochoric freezing comprising mild sub-freezing temperature and mild pressure conditions which are high enough to exert inhibitory effects on bacteria, but gentle enough to not affect the structure of pressure-sensitive biological matters such as milk proteins and overall composition.

As used herein, the term “isobaric freezing” refers to a freezing process at constant pressure. In isobaric freezing, the entire system freezes as soon as the temperature is below the liquidus line intersection with the constant pressure line.

As used herein, the term “sterilized” or “sterilization” is used interchangeably with “sanitized”, and the “sterilization” refers to a process destroying yeasts, molds, vegetative bacteria, and spore formers to extend the shelf-life. For example, the “sterilized food” is food treated by process destroying yeasts, molds, vegetative bacteria, and spore formers to extend the shelf-life.

As used herein, the term “pasteurized” or “pasteurization” refers to the application of heat to a food product in order to destroy pathogenic (disease-producing) microorganisms, to inactivate spoilage-causing enzymes, and to reduce or destroy spoilage microorganisms.

As used herein, the term “nutrients” refers to substances that provide energy and physical components to the organism, allowing it to survive, grow, and reproduce. Nutrients can be basic elements or complex macromolecules and can be found in any organic matter.

The use of the terms “a,” “an,” and “the,” and similar referents in the context of describing the disclosure (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the embodiments of the disclosure and does not pose a limitation on the scope of the disclosure unless otherwise claimed. No language in the specification should be construed as indicating any non-claimed element as essential to the practice of the embodiments of the disclosure.

As used herein, the term “about” used in connection with an amount indicates that the amount can vary by 10% of the stated amount. For example, “about 100” means an amount of from 90-110. Where about is used in the context of a range, the “about” used in reference to the lower amount of the range means that the lower amount includes an amount that is 10% lower than the lower amount of the range, and “about” used in reference to the higher amount of the range means that the higher amount includes an amount 10% higher than the higher amount of the range. For example, from about 100 to about 1000 means that the range extends from 90 to 1100.

The term “and/or” as used herein a phrase such as “A and/or B” is intended to include both A and B; A or B; A (alone); and B (alone). Likewise, the term “and/or” as used herein a phrase such as “A, B, and/or C” is intended to encompass each of the following embodiments: A, B, and C; A, B, or C; A or C; A or B; B or C; A and C; A and B; B and C; A (alone); B (alone); and C (alone).

It is understood that aspects and embodiments of the present disclosure described herein include “comprising,” “consisting,” and “consisting essentially of” aspects and embodiments.

It is appreciated that certain features of the present disclosure, which are, for clarity, described in the context of separate embodiments, may also be provided in combination in a single embodiment. Conversely, various features of this disclosure, which are, for brevity, described in the context of a single embodiment, may also be provided separately or in any suitable sub-combination. All combinations of the embodiments pertaining to this disclosure are specifically embraced by the present disclosure and are disclosed herein just as if each and every combination was individually and explicitly disclosed. In addition, all sub-combinations of the various embodiments and elements thereof are also specifically embraced by the present disclosure and are disclosed herein just as if each and every such sub-combination was individually and explicitly disclosed herein.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### 2. METHODS FOR INHIBITING BIOLOGICAL CONTAMINANTS IN A BIOLOGICAL MATTER DURING LONG TERM PRESERVATION WHILE PRESERVING BOTH THE MICROBIAL SAFETY AND THE NUTRITIONAL AND SENSORY QUALITIES OF BIOLOGICAL MATTER

Aspects of the present disclosure provide methods for inhibiting or preventing biological contaminants in a biological matter during long term preservation while preserving both the microbial safety and the nutritional and sensory qualities of biological matter. In one aspect, the present disclosure provides methods for inhibiting or preventing growth of biological contaminants in a biological matter during long term preservation while preserving both the microbial safety and the nutritional and sensory qualities of biological matter. In another aspect, the present disclosure provides methods for maintaining a level of biological contaminants in a biological matter during long term preservation while preserving both the microbial safety and the nutritional and sensory qualities of biological matter. In still another aspect, the present disclosure provides methods for sterilizing a biological matter during long term preservation while preserving both the microbial safety and the nutritional and sensory qualities of biological matter.

More specifically, the method of the present disclosure comprises placing the biological matter in a fluid in an isochoric chamber and applying long term isochoric freezing to the fluid in the isochoric chamber at subfreezing temperature, thereby inhibiting or preventing biological contaminants in the biological matter during long term preservation while preserving both the microbial safety and the nutritional and sensory qualities of biological matter.

In some aspects, the present disclosure provides methods of preserving biological matters in long term mild isochoric freezing (IF) conditions. In some embodiments, the mild isochoric freezing preservation of the present disclosure significantly extends the shelf life of biological matter, such as perishable liquids, while preserving both the microbial safety and the nutritional and sensory qualities of biological matter.

### Isochoric Freezing System for Long Term Preservation of a Biological Matter

The method of the present disclosure comprises (i) placing a biological matter in a fluid in an isochoric chamber and (ii) applying long term isochoric freezing to the fluid in the isochoric chamber at subfreezing temperature. Herein, the isochoric freezing refers to the freezing of aqueous solutions in a constant volume chamber. The term “constant volume chamber” is used interchangeably herein with “isochoric chamber” or “rigid chamber”.

In the isochoric freezing system of the present disclosure, a biological matter such as food product is placed inside an isochoric chamber filled with an aqueous solution. In the isochoric freezing, a substantial portion of the volume remains unfrozen which is associated with an increase in pressure. The process of isochoric freezing occurs along the liquidus line in a temperature-pressure phase diagram as the temperature is dropped because the volume in an isochoric chamber is constant.

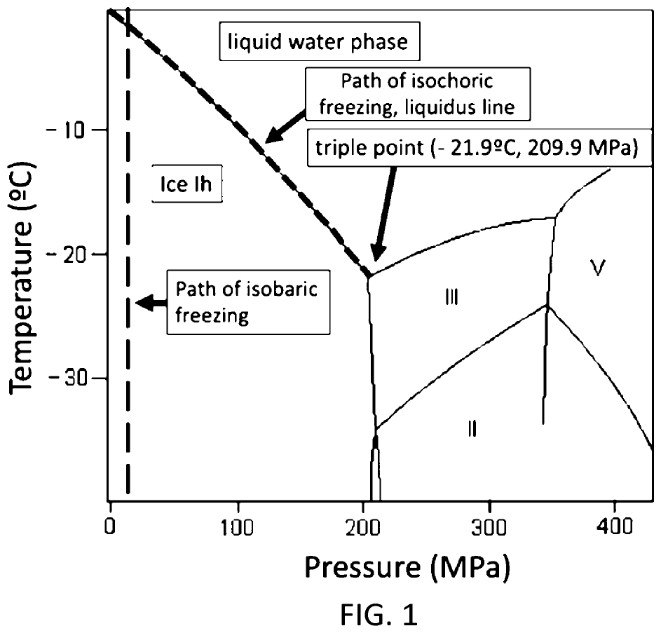

FIG. 1 illustrates the difference between isobaric freezing and isochoric freezing in a temperature-pressure phase diagram for water. It shows the triple point for water after which at lower temperatures, there is no liquid water. It also shows that at constant pressure, as soon as the temperature is below the liquidus line intersection with the constant pressure line, the entire system freezes. In contrast, in an isochoric system, pressure and temperature are interrelated through the liquidus curve in the phase diagram of the aqueous solution. Consequently, only part of the water can freeze to become ice at thermodynamic equilibrium under the pressure and constant volume conditions. This avoids the formation of ice crystals inside the biological matter if the biological matter remains in the unfrozen region. Therefore, isochoric freezing relies on pressure to avoid ice formation inside the preserved biological matter at subfreezing temperatures. See, e.g., Rubinsky, B., Perez, P. A. and Carlson, M. E., “The thermodynamic principles of isochoric cryopreservation”, 2005, Cryobiology, 50(2), pp. 121-138 herein incorporated by reference in their entireties.

In the method of the present disclosure, isochoric freezing relies on Le Chatelier's principle, which states that as water expands upon freezing within a constant volume chamber (isochoric chamber), the enhanced pressures generated hinder further formation of ice. Therefore, the freezing process in an isochoric system follows the liquidus curve in the phase diagram for water depicted in FIG. 1. This minimizes the pressure for the given temperature and its potential harmful effects, such as impacting physicochemical and nutritional properties. In some embodiments, Le Chatelier's principle also allows the transformation of an aqueous liquid solution into two coexisting phases, a solid ice phase and a liquid phase, after lowering the temperature of the liquid solution to subfreezing temperatures. In this way, a biological matter such as a food product can be stored in the liquid phase inside the chamber at subfreezing temperatures without ice formation inside the products. This controlled freezing process allows food products to be placed within the liquid region of the chamber, preventing ice crystal formation and the according biophysical injury. For example, fruits and vegetables treated in this way can keep their original freshness with minimal changes in physicochemical and nutritional properties. Therefore, in some embodiments, an isochoric freezing can help retain the freshness of the biological matter such as harvested fruits and vegetables without substantially impacting their physicochemical and nutritional properties.

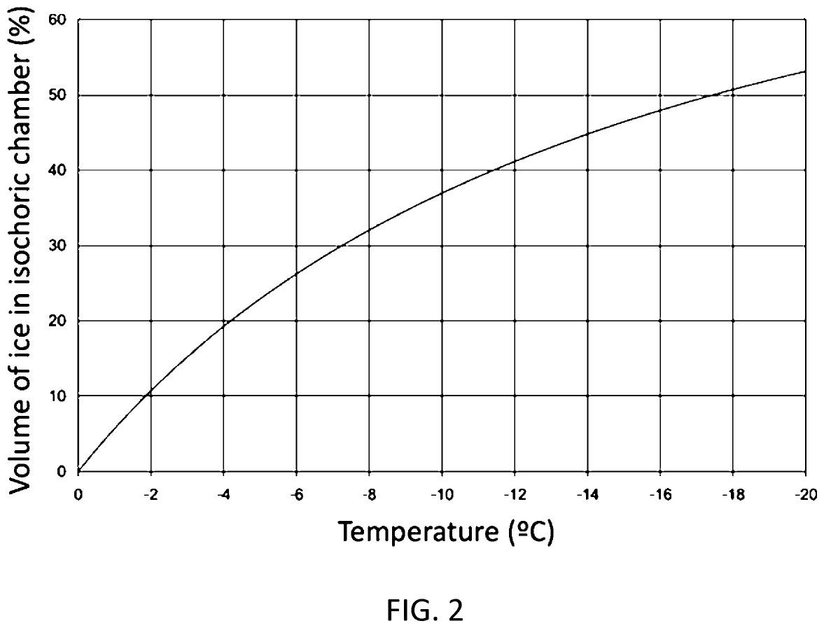

One of the major mechanisms of damage during preservation of a biological matter in aqueous solutions is the formation of ice. FIG. 2 shows that a substantial percentage of the volume in a liquid state to the triple point and the percentage of ice in an isochoric system as the temperature is lowered to the triple point. Therefore, in isochoric freezing it is possible to reduce the temperature while avoiding damage from the formation of ice by placing the matter to be preserved in the unfrozen part of the volume.

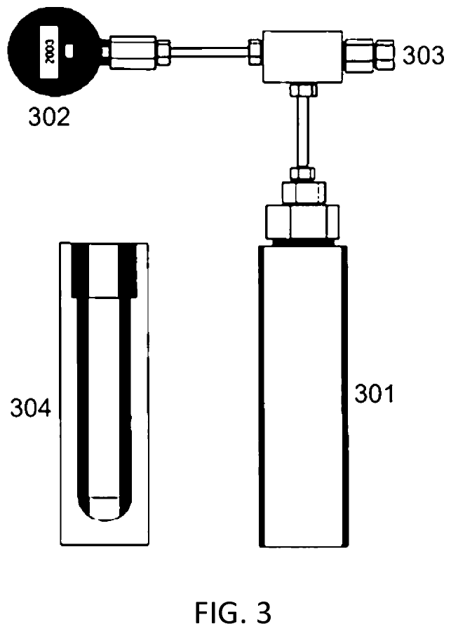

In some aspects of the method, the biological matter is placed inside the constant volume chamber filled with an aqueous solution in isochoric freezing. The constant volume chamber is filled with a fluid in such a way as to minimize the amount of air in the chamber. For example, FIG. 3 illustrates an exemplary isochoric chamber system for isochoric freezing. In FIG. 3, the isochoric chamber system comprises a constant volume chamber in pressure vessel 301, a pressure gauge 302, and a rupture disk 303. The constant volume chamber in pressure vessel 301 is seen in cross-sectional view 304. The constant volume chamber in pressure vessel 301 is preferably hermetically sealed, and the pressure therein is monitored with pressure gage 302. Optionally, the constant volume chamber in pressure vessel 301 can be made of stainless steel, but the present invention is not limited. In some embodiments, the isochoric chamber can be also a closed chamber with rigid walls. The constant volume chamber in pressure vessel 301 is filled with fluid. In some embodiments, the fluid in the constant volume chamber is aqueous solution or pure water. In the isochoric freezing, if ice nucleates in the constant volume chamber, the pressure of the system increases, and the nucleation can be detected by the pressure gage. For example, U.S. Patent Publication No. 2007-0042337A1, incorporated by reference herein, which discusses isochoric freezing system and method for cryopreservation of a biological sample.

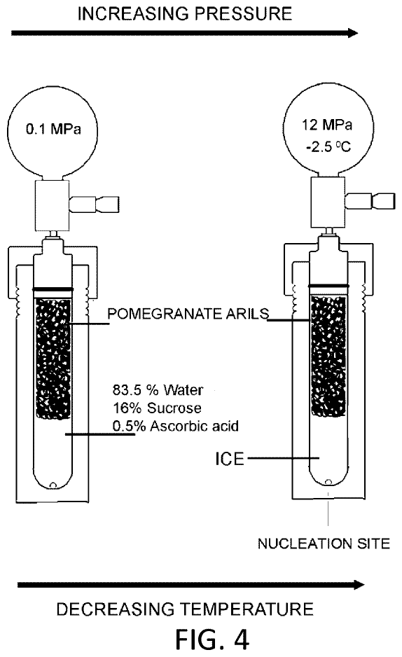

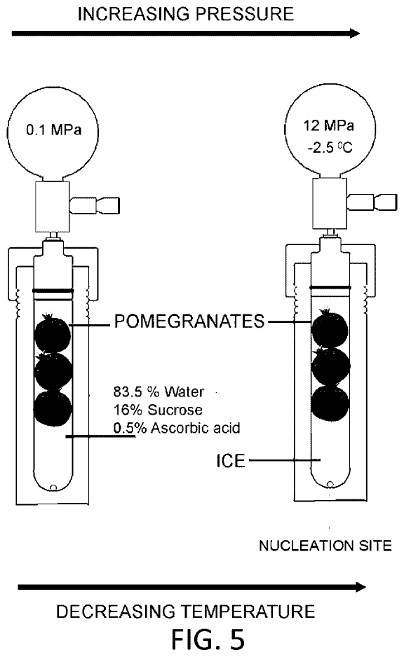

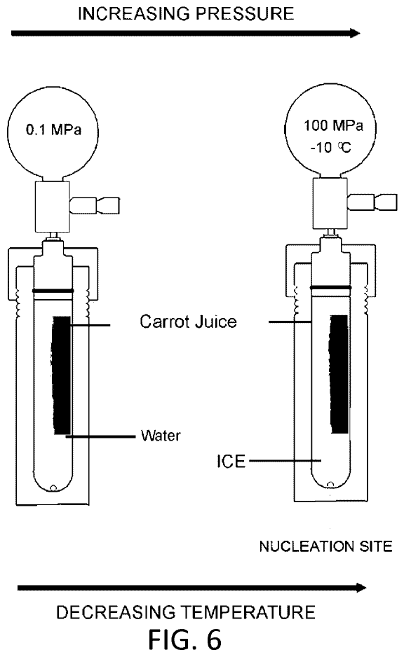

As generally shown in FIGS. 4, 5 and 6, the isochoric system comprises a high-pressure isochoric chamber that is enclosed with a sealing cap. The isochoric chamber can be made of grade 7075 aluminum with a total volume capacity of 2 liters and pressure-rated for up to 110 MPa. The chamber can be connected to an electronic pressure transducer to monitor the pressure inside the chamber. A safety head with a rupture disk is in fluid communication with the interior of the isochoric chamber to ensure that the conditions inside the chamber do not exceed safety standards. In FIG. 4, pomegranate arils are selected as an example. See, Example section 1. In FIG. 5, pomegranates are selected as an example. See, Example section 1. In FIG. 6, carrot juice is selected as an example. See, Example section 2.

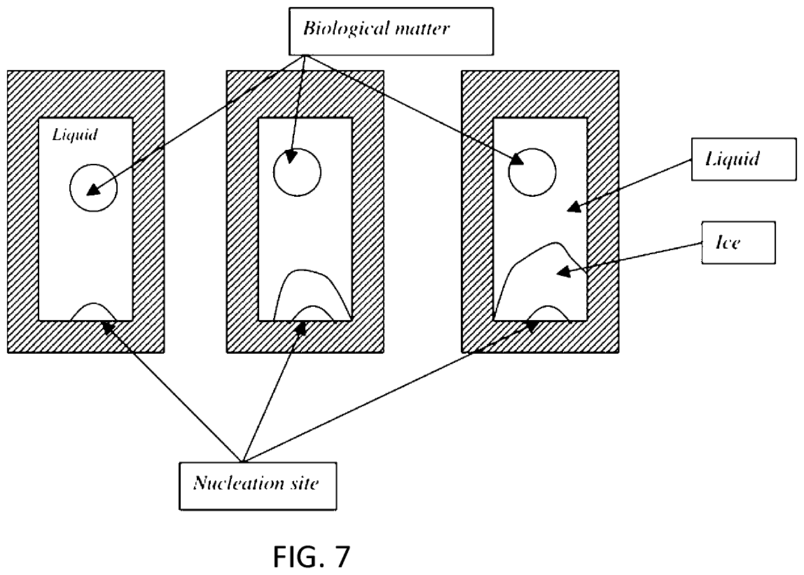

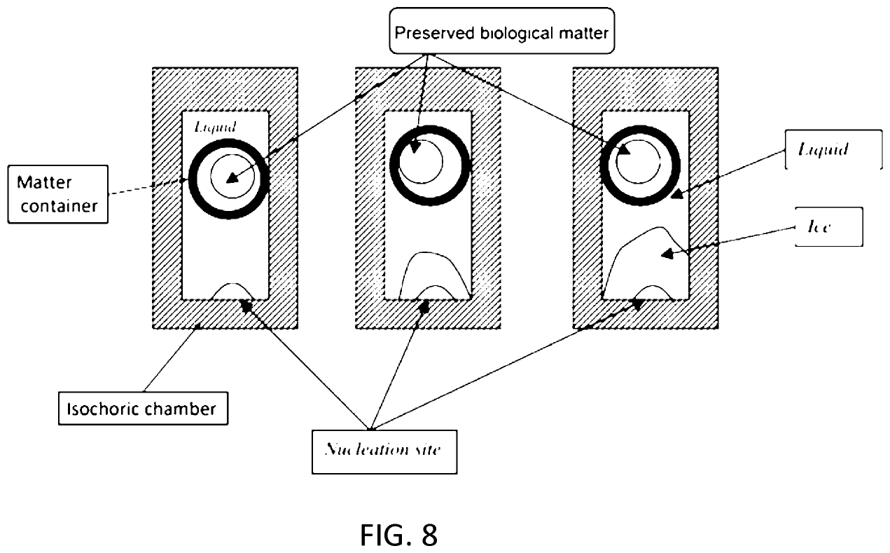

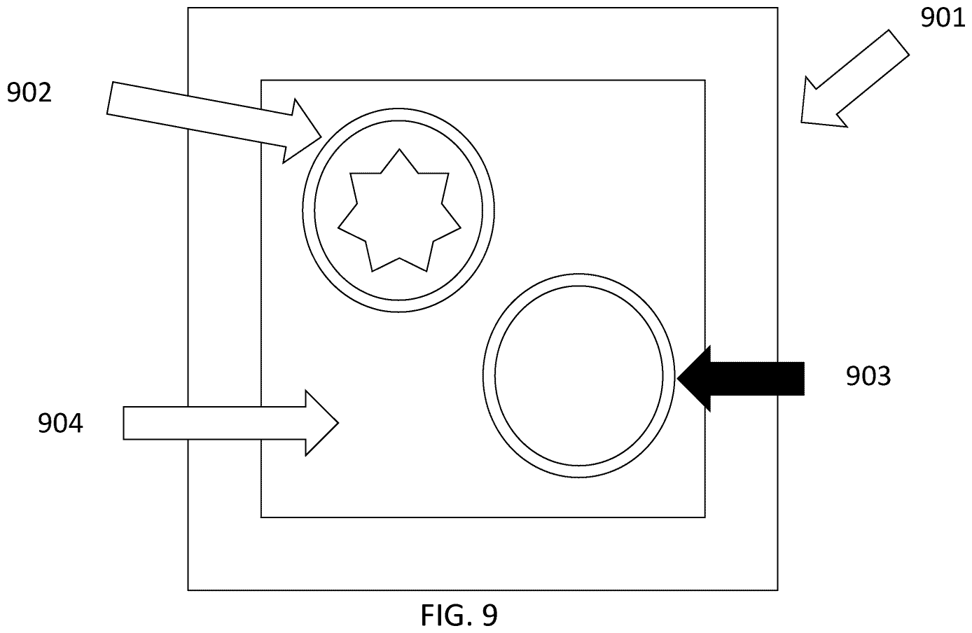

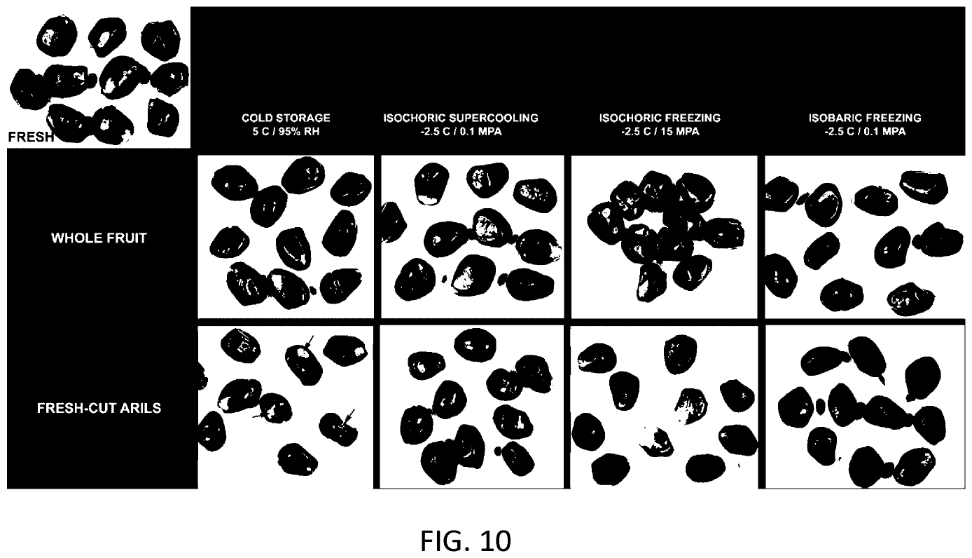

In some embodiments of the above method, a biological matter can be directly placed in the isochoric chamber. FIG. 7 illustrates an exemplary embodiment of isochoric freezing configuration with an isochoric chamber for preserving a biological mass while avoiding the formation of ice. In other embodiments, a biological matter can be placed in a container that allows transfer of pressure mass and heat. In still other embodiments, a biological matter can be placed in a container that allows transfer of only pressure and heat but not mass. FIG. 8 illustrates an exemplary embodiment of isochoric freezing configuration with an isochoric chamber and a matter container for preserving a biological mass while avoiding the formation of ice. Also, FIG. 9 illustrates an exemplary embodiment of isochoric freezing configuration with an isochoric chamber 901 and a matter container 902 for preserving a biological material while avoiding the formation of ice. FIG. 9 shows two containers that transfer pressure but not mass in the isochoric chamber, a first container 902 with the biological material and a second container 903 with the sacrificial freezing solution while the entire isochoric chamber 901 is filled with a fluid 904 that does not freeze at the storage temperature. The second container 903 includes fluid that freezes at a temperature higher than the biological material. The isochoric chamber 901 further contains fluid 904 that freezes at a temperature lower than preservation temperature.

In some embodiments, liquid biological matter, such as fruit juice or vegetable juice, is collected in an impermeable but flexible container. For example, liquid biological matter is collected in a polyethylene sterile bag. The bag is then sealed with negligible headspace and placed inside the isochoric chamber.

In some embodiments, the fluid in the constant volume chamber is aqueous solution or pure water with or without organic molecules therein. In some embodiments, the aqueous solution that is primarily water may contain other chemicals so that the freezing point of the water-based solution may be modified as required for a specific application. For example, the water-based solution may contain salt. In certain embodiments, the external solution is water. In some embodiments, the fluid in the container can be the same as the fluid in the isochoric chamber surrounding the container. In other embodiments, the fluid in the matter container can be different from the fluid in the isochoric chamber surrounding the matter container. In other words, the fluid inside the matter container and the fluid outside the matter container can be of different types in osmotic equilibrium with the preserved biological matter. In some embodiments the isochoric chamber is filled with a fluid that does not freeze at the storage temperature, such as a solution of glycerol.

In some aspects of the method, the isochoric chamber contains a nucleating agent. The nucleating agent forms an ice crystal thereby the biological matter can be preserved in the unfrozen part of the volume. The ice crystal formed by the nucleating agent generates pressures of the isochoric chamber, and the enhanced pressures hinder further formation of ice. In some embodiments, the nucleating agent can be a structural element of the isochoric freezing device. For example, the nucleating agent can be walls of the isochoric chamber itself, or walls of the matter container itself. In other embodiments, the nucleating agent can be any agent that promotes the formation of ice crystal in the isochoric chamber. For example, the ice nucleating agent is, but not limited to, minute solid particles, such as dust or food particles, large molecules, ice-nucleating proteins. In some embodiments, the nucleating agent is placed in the bottom of the isochoric chamber, and the chamber is completely filled with an aqueous solution. In some embodiments, a biological matter is placed in a container in an isochoric chamber that allows transfer of only pressure and heat but not mass and the isochoric chamber is filled with a fluid and nucleation agents that cause the fluid to freeze before the biological matter in the container freezes.

After the chamber is prepared and loaded, the chamber is cooled to subfreezing temperatures described in the present disclosure, preferably in a conventional freezer. Once the biological matter is needed, the chamber is gradually warmed above the freezing temperature of the water, allowing the ice in the chamber to melt and the pressure to decrease. The chamber is then opened, and the biological is removed for the intended use.

### Isochoric Freezing Conditions of the Method

In some aspects of the method, long term refers to the time applied for isochoric freezing. In other aspects of the method, the time applied for isochoric freezing is the time for preserving a biological matter in an isochoric chamber. In some embodiments, long term of the present disclosure refers to a length of time from hours to years. In other embodiments, long term of the present disclosure refers to a length of time from days to years. In still other embodiments, long term of the present disclosure refers to a length of time from weeks to years. In yet other embodiments, long term of the present disclosure refers to a length of time from months to years. In certain embodiments, the minimum isochoric freezing time of the present disclosure is 1 hour or more. In certain embodiments, the minimum isochoric freezing time of the present disclosure is 12 hours or more. In certain embodiments, the minimum isochoric freezing time of the present disclosure is 24 hours or more. In certain embodiments, the minimum isochoric freezing time is 24 hours or more, 30 hours or more, 36 hours or more, 42 hours or more, or 48 hours or more. In some embodiments, the maximum isochoric freezing time of the present disclosure is not limited as long as applying isochoric freezing conditions to a biological matter in an isochoric chamber. In certain embodiments, the maximum isochoric freezing time of the present disclosure is, but not limited to, 10, 15, 20, 25, 30, 40, or 50 years. In some embodiments, long term is, but not limited to, 1 hour, 6 hours, 12 hours, 18 hours, 1 day, 2 days, 3 days, 4 days, 5 days, 6 days, 7 days, 8 days, 9 days, 10 days, 11 days, 12 days, 13 days, 14 days, 15 days, 16 days, 17 days, 18 days, 19 days, 20 days, 21 days, 22 days, 23 days, 24 days, 25 days, 26 days, 27 days, 28 days, 29 days, or 30 days. In other embodiments, long term is, but not limited to, 1 week, 2 weeks, 3 weeks, 4 weeks, 5 weeks, 6 weeks, 7 weeks, 8 weeks, 9 weeks, 10 weeks, 11 weeks, or 12 weeks. In still other embodiments, long term includes, but is not limited to, 1 month, 2 months, 3 months, 4 months, 5 months, 6 months, 7 months, 8 months, 9 months, 10 months, 11 months, or 12 months. In further embodiments, long term includes, but is not limited to, 1 year, 2 years, 3 years, 4 years, 5 years, 6 years, 7 years, 8 years, 9 years, 10 years, 15 years, 20 years, 25 years, 30 years, 35 years, 40 years, or 50 years. In one embodiment, long term is in the range of more than 24 hours to 10 years. In another embodiment, long term is in the range of more than 48 hours to 10 years.

In some aspects of the method, the subfreezing temperature for inhibiting biological contaminants in a biological matter during long term preservation is much higher than the triple point along the liquidus line in a temperature pressure phase diagram depicted in FIG. 1. The triple point in the temperature pressure phase diagram depicted in FIG. 1 is about −21 °C. In some embodiments, the subfreezing temperature of the present disclosure is at least 5 °C higher than the triple point along the liquidus line in a temperature pressure phase diagram depicted in FIG. 1. In other embodiments, the subfreezing temperature of the present disclosure is at least 10 °C higher than the triple point along the liquidus line in a temperature pressure phase diagram depicted in FIG. 1. In some embodiments, the subfreezing temperature of the present disclosure is in the range of between 0 °C and −15 °C, 0 °C and −10 °C, 0 °C and −5 °C. In other words, the subfreezing temperature of the present disclosure is lower than 0 °C and higher than −15 °C or higher than −10 °C. In some embodiments, the subfreezing temperature of the present disclosure is in the range of 0 °C to −14 °C, 0 °C to −13 °C, 0 °C to −12 °C, 0 °C to −11 °C, 0 °C to −10 °C, 0 °C to −9 °C, 0 °C to −8 °C, 0 °C to −7 °C, 0 °C to −6 °C, or 0 °C to −5 °C. In some embodiments, the subfreezing temperature of the present disclosure is −1 °C, −2 °C, −3 °C, −4 °C, −5 °C, −6 °C, −7 °C, −8 °C, −9 °C, −10 °C, −11 °C, −12 °C, −13 °C, or −14 °C. In certain embodiments, the subfreezing temperature of the present disclosure is 0 °C to −10 °C, 0 °C to −7 °C, 0 °C to −5 °C, −2.5 °C to −7 °C, or −2.5 °C to −5 °C.

In some aspects of the method, the long term isochoric freezing conditions combining the above-described subfreezing temperature and the pressure which occurs at the above-described subfreezing temperature when the closed isochoric chamber is in a state of thermodynamic equilibrium is effective in inhibiting biological contaminants in a biological matter during long term preservation. In the present disclosure, such a small elevation in pressure induced by the isochoric freezing condition has a profound effect on inhibiting biological contaminants. In comparison, standard methods for high pressure sterilization employ pressures on the order of 600 MPa. Furthermore, the pressures induced by the isochoric freezing of the present disclosure have further effects on avoiding ice crystal formation inside the preserved biological matter at the subfreezing temperature. In some aspects of the method, the applied pressure occurs at the above-described subfreezing temperature when the closed isochoric chamber is in a state of thermodynamic equilibrium. Therefore, the isochoric system of the present disclosure provides convenient ways to achieve subfreezing temperature and elevated pressures only by controlling the temperature without the need for mechanical means to elevated pressure.

In some embodiments, the isochoric freezing of the present disclosure is at a pressure in the range of 0.1 MPa to 150 Mpa, 0.1 MPa to 145 Mpa, 0.1 MPa to 140 Mpa, 0.1 MPa to 135 Mpa, 0.1 MPa to 130 Mpa, 0.1 MPa to 125 Mpa, 0.1 MPa to 120 Mpa, 0.1 MPa to 115 Mpa, 0.1 MPa to 110 Mpa, 0.1 MPa to 105 Mpa, 0.1 MPa to 100 Mpa, 0.1 MPa to 95 Mpa, 0.1 MPa to 90 Mpa, 0.1 MPa to 85 Mpa, 0.1 MPa to 80 Mpa, 0.1 MPa to 75 Mpa, 0.1 MPa to 70 Mpa, 0.1 MPa to 65 Mpa, 0.1 MPa to 60 Mpa, 0.1 MPa to 55 Mpa, 0.1 MPa to 50 Mpa, 0.1 MPa to 45 Mpa, 0.1 MPa to 40 Mpa, 0.1 MPa to 35 Mpa, or 0.1 MPa to 30 Mpa. In certain embodiments, the pressure of the isochoric freezing is in the range of 0.1 Mpa to 35 Mpa or 0.1 Mpa to 60 Mpa. In some embodiments, the pressure of the isochoric freezing is 150 Mpa, 145 Mpa, 140 Mpa, 135 Mpa, 130 Mpa, 125 Mpa, 120 Mpa, 115 Mpa, 110 Mpa, 105 Mpa, 100 Mpa, 95 Mpa, 90 Mpa, 85 Mpa, 80 Mpa, 75 Mpa, 70 Mpa, 65 Mpa, 60 Mpa, 55 Mpa, 50 Mpa, 45, 40, 35, 30 MPa. In other embodiments, the pressure of the isochoric freezing is lower than 150 Mpa or lower than 100 Mpa. In certain embodiments, the pressure of the isochoric freezing is 35 MPa, and 12 Mpa.

### Mild Isochoric Freezing Conditions of the Method

In some aspects of the method, the isochoric freezing is a mild isochoric freezing. The mild isochoric freezing preservation significantly extends the shelf life of biological matter, such as perishable liquids, while preserving both the microbial safety and the nutritional and sensory qualities of biological matter. Furthermore, the mild isochoric freezing preservation of the present disclosure is an effective and non-chemical preservation technique for extending food preservation without the need for additives. In some embodiments, conditions of the mild isochoric freezing comprise mild pressures and mild sub-freezing temperatures.

In some embodiments, the mild subfreezing temperature is in the range of −0.1 °C to −5 °C, −0.1 °C to −4.5 °C, −0.1 °C to −4.0 °C, −0.1 °C to −3.5 °C, 0 °C to −3.0 °C, 0 °C to −2.5 °C, 0 °C to −2.0 °C, −0.1 °C to −1.5 °C, or −0.1 °C to −1.0 °C. In certain embodiments, the mild subfreezing temperature is in the range of −0.1 °C to −1.5 °C. In some embodiments, the mild subfreezing temperature is −0.1 °C, −0.2 °C, −0.3 °C, −0.4 °C, −0.5 °C, −0.6 °C, −0.7 °C, −0.8 °C, −0.9 °C, −1.0 °C, −1.1 °C, −1.2 °C, −1.3 °C, −1.4 °C, −1.5 °C, −1.6 °C, −1.7 °C, −1.8 °C, −1.9 °C, −2.0 °C, −2.1 °C, −2.2 °C, −2.3 °C, −2.4 °C, −2.5 °C, −2.6 °C, −2.7 °C, −2.8 °C, −2.9 °C, −3.0 °C, −3.1 °C, −3.2 °C, −3.3 °C, −3.4 °C, −3.5 °C, −3.6 °C, −3.7 °C, −3.8 °C, −3.9 °C, −4.0 °C, −4.1 °C, −4.2 °C, −4.3 °C, −4.4 °C, −4.5 °C, −4.6 °C, −4.7 °C, −4.8 °C, −4.9 °C, or −5.0 °C. In certain embodiments, the mild subfreezing temperature is −1.5 °C.

In some embodiments, the mild isochoric freezing is at a pressure in the range of between 0.1 Mpa to 80 Mpa, 0.1 Mpa to 60 Mpa, 0.1 Mpa to 35 Mpa, 0.1 Mpa to 15 Mpa, 0.1 Mpa to 14 Mpa, 0.1 Mpa to 13 Mpa, 0.1 Mpa to 12 Mpa, 0.1 Mpa to 11 Mpa, 0.1 Mpa to 10 Mpa, 0.1 Mpa to 9 Mpa, 0.1 Mpa to 8 Mpa, 0.1 Mpa to 7 Mpa, 0.1 Mpa to 6 Mpa, or 0.1 Mpa to 5 Mpa. In certain embodiments, the pressure of the mild isochoric freezing is 15 Mpa, 14 Mpa, 13 Mpa, 12 Mpa, 11 Mpa, 10 Mpa, 9 Mpa, 8 Mpa, 7 Mpa, 6 Mpa, or 5 Mpa.

In some embodiments, the mild isochoric freezing preservation of the present disclosure significantly extends the shelf life of biological matter. In some embodiments, the shelf life extends to at least 5 days, at least 10 days, at least 20 days, at least 1 month, at least 3 moths, at least 5 months, at least 9 months, at least 1 year, at least 2 years, at least 3 years, at least 5 years, at least 10 years, at least 20 years, or at least 50 years.

In some embodiments, the mild isochoric freezing preservation of the present disclosure preserves microbial safety of the biological matter. The isochoric freezing preservation inhibits microbial growths, such as bacteria or fungi in biological matter, thereby extending shelf life and minimizing waste. For example, the mild isochoric freezing preservation of the present disclosure preserves microbial safety of perishable raw milk products.

In some embodiments, the mild isochoric freezing preservation of the present disclosure preserves nutritional qualities of biological matter because the isochoric freezing conditions prevent ice crystal formation inside the preserved biological matter. In other words, the mild isochoric freezing preservation preserves the appropriate levels of individual nutrients in the biological matter. For example, nutritional quality indicators are, but not limited to, microbiology, pH, titratable acidity, enzyme activity, viscosity, and volatile organic compounds.

In some embodiments, the mild isochoric freezing preservation of the present disclosure preserves sensory qualities of biological matter, such as appearance, odor, flavor, taste, and texture of biological matter detectable by human senses. In other embodiments, the mild isochoric freezing preservation of the present disclosure does not impact protein structures of biological matter due to moderate pressures and mild sub-freezing temperatures.

In some embodiments, the mild isochoric freezing preservation of the present disclosure preserves both the microbial safety and the nutritional and sensory qualities of biological matter.

### Biological Matters of the Method

In some aspects of the method, the biological matter is, but not limited to, a cell, an organ, an organism, a biomedical product, an agricultural product, a food product, a fruit, or a beverage. In some embodiments, the cell is a plant cell or an animal cell. In other embodiments, the cell is, but not limited to, a stem cell, a bone cell, a blood cell, a muscle cell, a sperm cell, a female egg cell, a fat cell, a nerve cell. In some embodiments, the organ is obtained from animals. In other embodiments, the organ is obtained from a human. For example, the organ is a pancreas, a brain, a liver, a heart, kidneys, lungs, a spleen, a stomach, or intestines. In some embodiments, the biomedical product is, but not limited to, artificial organs, drugs, and medicines. In certain embodiments, medical instruments can be sterilized by the method of the present disclosure during long term preservation.

In some embodiments, the fruit includes a whole fruit, a fresh-cut fruit, or fruit arils. In other embodiments, the fruit is, but not limited to, an apple, a pear, a pomegranate, an orange, a grapefruit, a mandarin, a lime, a lemon, a nectarine, an apricot, a peach, a plum, a banana, a mango, a strawberry, a raspberry, a blueberry, a kiwifruit, a passionfruit, watermelons, a melon, a honeydew melon, a cantaloupe, a tomato, or an avocado. In certain embodiments, the fruit includes whole pomegranate, fresh-cut pomegranate, or pomegranate arils. In some embodiments, the agricultural product includes, but is not limited to, vegetables, legumes, or grains. In other embodiments, the vegetables are, not limited to, lettuce, spinach, beet, cabbage, cauliflower, brussels sprout, broccoli, pumpkin, cucumber, zucchini, potato, sweet potato, yam, celery, asparagus, onion, garlic, shallot, or carrot. In some embodiments, the legumes are, but not limited to, tofu, soybeans, chickpea flour, lentil flour, soy flour, haricot beans, red kidney beans, chickpeas, lentils, green peas, green beans, butter beans, or snow peas.

In some embodiments, the beverage includes fruit juice, vegetable juice, or combination thereof. In other embodiments, the beverage includes milk. In certain embodiments, the fruit juice is, but not limited to, orange juice, apple juice, grape juice, tomato juice, pomegranate juice, or mixed fruit juice. In certain embodiments, the vegetable juice is, but not limited to, carrot juice, kale juice, spinach juice, or mixed vegetable juice. In some embodiments, the food product includes dairy product or milk product.

In some embodiments, liquid biological matter, such as fruit juice or vegetable juice, is collected in an impermeable but flexible container. For example, liquid biological matter is collected in a polyethylene sterile bag. The bag is then sealed with negligible headspace and placed inside the isochoric chamber.

In some embodiments, the biological matter may be optionally sterilized before the preservation process. In some embodiments, the biological matter may be pasteurized, sanitized, or sterilized by well-known techniques before long term preservation. In some embodiments, the present disclosure provides a method for inhibiting or preventing growth of biological contaminants in the sterilized biological matter during long term preservation. In other embodiments, the present disclosure provides methods for maintaining the level of biological contaminants in the sterilized biological matter during long term preservation.

### Biological Contaminants in a Biological Matter

In some aspects of the method, the contaminants include, but are not limited to, microorganisms, mold, fungi, yeast, bacteria, pathogens, viruses, spores, protozoa, archaea, multicellular animal parasites. In certain embodiments, the bacteria include aerobic mesophilic bacteria. Examples of the bacteria are Salmonella and Listeria. Examples of the viruses are Norovirus. Examples of parasites are trematodes and prions. Examples of the yeasts and molds are Aspergillus flavus. Examples of fungi found in fruits and vegetables are, but not limited to, Alternaria, Botrytis, Colletotrichum, Penicillium, Rhizopus, and Monilinia.

### Effects of Long Term Isochoric Freezing Preservation of the Present Disclosure

In the method, long term isochoric freezing can preserve a biological matter without or with minimal quality loss during long term preservation. In some embodiments, the quality loss is determined by measuring color change, texture change, water content change, humidity loss, pH change, mass change, total soluble solids change, titratable acidity (TA) change, ascorbic acid (AA) change, or antioxidant activity. In other embodiments, long term isochoric freezing can inhibit or prevent biological contaminants in a biological matter during long term preservation. In still other embodiments, long term isochoric freezing can inhibit or prevent growth of biological contaminants, such as microbial growth in a biological matter during long term preservation. In yet other embodiments, the present disclosure provides methods for maintaining a level of biological contaminants in a biological matter during long term preservation. In still another aspect, the present disclosure provides methods for sterilizing a biological matter during long term preservation of the biological matter. As such, long term isochoric freezing during long term preservation of a biological matter inhibits or prevents growth of biological contaminants as well as minimizes quality loss during the preservation.

In some embodiments, the long-term isochoric freezing inhibits biological contaminants on the surface of a biological matter. In this case, the biological matter includes a solid biological matter having surfaces such as a cell, an organ, an organism, a biomedical product, an agricultural product, a food product, a fruit, and the like. In this case, the biological matter does not include liquid biological matter such as a beverage. In certain embodiments, the fruit includes a whole fruit, a fresh-cut fruit, or fruit arils. For example, the long-term isochoric freezing inhibits or prevents growth of biological contaminants on the surface of pomegranate arils, fresh-cut pomegranate, fresh-cut watermelon, fresh-cut peach, fresh-cut orange, orange arils, fresh-cut apple, fresh-cut pineapple, fresh-cut melon, fresh-cut cantaloupe, fresh-cut potato, fresh-cut garlic, fresh-cut onion, fresh-cut sweet potato, fresh-cut carrot, fresh-cut zucchini, fresh-cut cucumber, without limitation. In certain embodiments, the surface of medical instruments can be sterilized by the method of the present disclosure during long term preservation.

In some embodiments, the long-term isochoric freezing inhibits or prevents growth of biological contaminants in the interior of a biological matter. In this case, the biological matter includes solid biological matter and liquid biological matter such as a cell, an organ, an organism, a biomedical product, an agricultural product, a food product, a fruit and beverage. In certain embodiments, biological contaminants in a liquid biological matter, such as fruit juice, vegetable juice, mixed juice, milk. Examples of the liquid biological matter are carrot juice, spinach juice, kale juice, vegetable and fruit pomegranate juice, orange juice, grape juice, cherry juice, mango juice, pineapple juice, apple juice, or milk can be inhibited or prevented by the long-term isochoric freezing of the method described herein.

### 3. METHODS FOR REDUCING OR ELIMINATING BIOLOGICAL CONTAMINANTS IN A BIOLOGICAL MATTER WHILE PRESERVING BOTH THE MICROBIAL SAFETY AND THE NUTRITIONAL AND SENSORY QUALITIES OF BIOLOGICAL MATTER

Aspects of the present disclosure provide methods for reducing or eliminating biological contaminants in a biological matter during long term preservation while preserving both the microbial safety and the nutritional and sensory qualities of biological matter. In one aspect, the present disclosure provides methods for reducing growth of biological contaminants in a biological matter during long term preservation while preserving both the microbial safety and the nutritional and sensory qualities of biological matter. In another aspect, the present disclosure provides methods for reducing a level of biological contaminants in a biological matter during long term preservation while preserving both the microbial safety and the nutritional and sensory qualities of biological matter. In still another aspect, the present disclosure provides methods for sterilizing biological matter during long term preservation while preserving both the microbial safety and the nutritional and sensory qualities of biological matter.

In some embodiments, the method of the present disclosure comprises placing a biological matter in a fluid in an isochoric chamber and applying long term isochoric freezing to the fluid in the isochoric chamber at subfreezing temperature, thereby reducing or eliminating biological contaminants in the biological matter during long term preservation while preserving both the microbial safety and the nutritional and sensory qualities of biological matter.

More specifically, methods for eliminating biological contaminants during long term preservation of a biological matter comprise applying long term isochoric freezing to the fluid in the isochoric chamber at relatively high subfreezing temperature in the range of 0 °C to −10 °C and low pressure. Other embodiments include a method for eliminating biological contaminants during preservation of a biological matter, comprising applying short term isochoric freezing to the fluid in the isochoric chamber at relatively low subfreezing temperature in the range of −15 °C to −22 °C and relatively high pressure. The “short-term” of the short term isochoric freezing for eliminating biological contaminants in biological matter refers to a length of time from seconds to minutes.

The long term isochoric freezing application of the present disclosure can have effects on eliminating biological contaminants in the biological matter during long term preservation, while preserving both the microbial safety and the nutritional and sensory qualities of biological matter.

In some aspects, the present disclosure provides methods of preserving biological matters in long term mild isochoric freezing (IF) conditions. In some embodiments, the mild isochoric freezing preservation of the present disclosure significantly extends the shelf life of biological matter, such as perishable liquids, while preserving both the microbial safety and the nutritional and sensory qualities of biological matter.

### Isochoric Freezing System for Long Term Preservation of a Biological Matter

The isochoric freezing system for long term preservation of a biological matter is described in the above section 2.

### Isochoric Freezing Conditions of the Method

In some aspects of the method, long term refers to the time applied for isochoric freezing. In other aspects of the method, the time applied for isochoric freezing is the time for preserving a biological matter in an isochoric chamber. In some embodiments, long term of the present disclosure refers to a length of time from hours to years. In other embodiments, long term of the present disclosure refers to a length of time from days to years. In still other embodiments, long term of the present disclosure refers to a length of time from weeks to years. In yet other embodiments, long term of the present disclosure refers to a length of time from months to years. In certain embodiments, the minimum isochoric freezing time of the present disclosure is 1 hour or more. In certain embodiments, the minimum isochoric freezing time of the present disclosure is 6 hours or more. In certain embodiments, the minimum isochoric freezing time of the present disclosure is 12 hours or more. In certain embodiments, the minimum isochoric freezing time of the present disclosure is 24 hours or more. In certain embodiments, the minimum isochoric freezing time is 24 hours or more, 30 hours or more, 36 hours or more, 42 hours or more, or 48 hours or more. In some embodiments, the maximum isochoric freezing time of the present disclosure is not limited as long as applying Isochoric freezing conditions to a biological matter in an isochoric chamber. In certain embodiments, the maximum isochoric freezing time of the present disclosure is, but not limited to, 10, 15, 20, 25, 30, 40, or 50 years. In some embodiments, long term is, but not limited to, 1 hour, 6 hours, 12 hours, 18 hours, 1 day, 2 days, 3 days, 4 days, 5 days, 6 days, 7 days, 8 days, 9 days, 10 days, 11 days, 12 days, 13 days, 14 days, 15 days, 16 days, 17 days, 18 days, 19 days, 20 days, 21 days, 22 days, 23 days, 24 days, 25 days, 26 days, 27 days, 28 days, 29 days, or 30 days. In other embodiments, long term is, but not limited to, 1 week, 2 weeks, 3 weeks, 4 weeks, 5 weeks, 6 weeks, 7 weeks, 8 weeks, 9 weeks, 10 weeks, 11 weeks, or 12 weeks. In still other embodiments, long term includes, but is not limited to, 1 month, 2 months, 3 months, 4 months, 5 months, 6 months, 7 months, 8 months, 9 months, 10 months, 11 months, or 12 months. In further embodiments, long term includes, but is not limited to, 1 year, 2 years, 3 years, 4 years, 5 years, 6 years, 7 years, 8 years, 9 years, 10 years, 15 years, 20 years, 25 years, 30 years, 35 years, 40 years, or 50 years. In one embodiment, long term is in the range of more than 24 hours to 10 years. In another embodiment, long term is in the range of more than 48 hours to 10 years.

In some aspects of the method, the subfreezing temperature for reducing or eliminating biological contaminants in a biological matter during long term preservation is much higher than the triple point along the liquidus line in a temperature pressure phase diagram depicted in FIG. 1. The triple point in the temperature pressure phase diagram depicted in FIG. 1 is about −21 °C. In some embodiments, the subfreezing temperature of the present disclosure is at least 5 °C higher than the triple point along the liquidus line in a temperature pressure phase diagram depicted in FIG. 1. In other embodiments, the subfreezing temperature of the present disclosure is at least 10 °C higher than the triple point along the liquidus line in a temperature pressure phase diagram depicted in FIG. 1. In some embodiments, the subfreezing temperature of the present disclosure is in the range of between 0 °C and −15 °C, 0 °C and −10 °C, or 0 °C and −5 °C. In other words, the subfreezing temperature of the present disclosure is lower than 0 °C and higher than −15 °C or higher than −10 °C. In some embodiments, the subfreezing temperature of the present disclosure is in the range of 0 °C to −14 °C, 0 °C to −13 °C, 0 °C to −12 °C, 0 °C to −11 °C, 0 °C to −10 °C, 0 °C to −9 °C, 0 °C to −8 °C, 0 °C to −7 °C, 0 °C to −6 °C, or 0 °C to −5 °C. In some embodiments, the subfreezing temperature of the present disclosure is −1 °C, −2 °C, −3 °C, −4 °C, −5 °C, −6 °C, −7 °C, −8 °C, −9 °C, −10 °C, −11 °C, −12 °C, −13 °C, or −14 °C. In certain embodiments, the subfreezing temperature of the present disclosure is 0 °C to −10 °C, 0 °C to −7 °C, 0 °C and −5 °C, −2.5 °C to −7 °C, or −2.5 °C to −5 °C.

In some aspects of the method, the long term isochoric freezing conditions combining the above-described subfreezing temperature and the pressure which occurs at the above-described subfreezing temperature when the closed isochoric chamber is in a state of thermodynamic equilibrium is effective in reducing or eliminating biological contaminants in a biological matter during long term preservation. In the present disclosure, such a small elevation in pressure induced by the isochoric freezing condition has a profound effect on reducing or eliminating biological contaminants. In comparison, standard methods for high pressure sterilization employ pressures on the order of 600 MPa. Furthermore, the pressures induced by the isochoric freezing of the present disclosure have further effects on avoiding ice formation inside the preserved biological matter at the subfreezing temperature. In the method of the present disclosure, the applied pressure occurs at the above-described subfreezing temperature when the closed isochoric chamber is in a state of thermodynamic equilibrium. Therefore, the isochoric system of the present disclosure provides convenient ways to achieve subfreezing temperature and elevated pressures only by controlling the temperature without the need for mechanical means to elevated pressure.

In some embodiments, the isochoric freezing of the present disclosure is at a pressure in the range of 0.1 MPa to 150 Mpa, 0.1 MPa to 145 Mpa, 0.1 MPa to 140 Mpa, 0.1 MPa to 135 Mpa, 0.1 MPa to 130 Mpa, 0.1 MPa to 125 Mpa, 0.1 MPa to 120 Mpa, 0.1 MPa to 115 Mpa, 0.1 MPa to 110 Mpa, 0.1 MPa to 105 Mpa, 0.1 MPa to 100 Mpa, 0.1 MPa to 95 Mpa, 0.1 MPa to 90 Mpa, 0.1 MPa to 85 Mpa, 0.1 MPa to 80 Mpa, 0.1 MPa to 75 Mpa, 0.1 MPa to 70 Mpa, 0.1 MPa to 65 Mpa, 0.1 MPa to 60 Mpa, 0.1 MPa to 55 Mpa, 0.1 MPa to 50 Mpa, 0.1 MPa to 45 Mpa, 0.1 MPa to 40 Mpa, 0.1 MPa to 35 Mpa, or 0.1 MPa to 30 Mpa. In certain embodiments, the pressure of the isochoric freezing is in the range of 0.1 Mpa to 35 Mpa or 0.1 Mpa to 60 Mpa. In some embodiments, the pressure of the isochoric freezing is 150 Mpa, 145 Mpa, 140 Mpa, 135 Mpa, 130 Mpa, 125 Mpa, 120 Mpa, 115 Mpa, 110 Mpa, 105 Mpa, 100 Mpa, 95 Mpa, 90 Mpa, 85 Mpa, 80 Mpa, 75 Mpa, 70 Mpa, 65 Mpa, 60 Mpa, 55 Mpa, 50 Mpa, 45 Mpa, 40 Mpa, 35 Mpa, or 30 MPa. In other embodiments, the pressure of the isochoric freezing is lower than 150 Mpa or lower than 100 Mpa. In certain embodiments, the pressure of the isochoric freezing is 35 MPa, and 12 Mpa.

### Mild Isochoric Freezing Conditions of the Method

In some aspects of the method, the isochoric freezing is a mild isochoric freezing. The mild isochoric freezing preservation significantly extends the shelf life of biological matter, such as perishable liquids, while preserving both the microbial safety and the nutritional and sensory qualities of biological matter. Furthermore, the mild isochoric freezing preservation of the present disclosure is an effective and non-chemical preservation technique for extending food preservation without the need for additives. In some embodiments, conditions of the mild isochoric freezing comprise mild pressures and mild sub-freezing temperatures.

In some embodiments, the mild subfreezing temperature is in the range of −0.1 °C to −5 °C, −0.1 °C to −4.5 °C, −0.1 °C to −4.0 °C, −0.1 °C to −3.5 °C, 0 °C to −3.0 °C, 0 °C to −2.5 °C, 0 °C to −2.0 °C, −0.1 °C to −1.5 °C, or −0.1 °C to −1.0 °C. In certain embodiments, the mild subfreezing temperature is in the range of −0.1 °C to −1.5 °C. In some embodiments, the mild subfreezing temperature is −0.1 °C, −0.2 °C, −0.3 °C, −0.4 °C, −0.5 °C, −0.6 °C, −0.7 °C, −0.8 °C, −0.9 °C, −1.0 °C, −1.1 °C, −1.2 °C, −1.3 °C, −1.4 °C, −1.5 °C, −1.6 °C, −1.7 °C, −1.8 °C, −1.9 °C, −2.0 °C, −2.1 °C, −2.2 °C, −2.3 °C, −2.4 °C, −2.5 °C, −2.6 °C, −2.7 °C, −2.8 °C, −2.9 °C, −3.0 °C, −3.1 °C, −3.2 °C, −3.3 °C, −3.4 °C, −3.5 °C, −3.6 °C, −3.7 °C, −3.8 °C, −3.9 °C, −4.0 °C, −4.1 °C, −4.2 °C, −4.3 °C, −4.4 °C, −4.5 °C, −4.6 °C, −4.7 °C, −4.8 °C, −4.9 °C, or −5.0 °C. In certain embodiments, the mild subfreezing temperature is −1.5 °C.

In some embodiments, the mild isochoric freezing is at a pressure in the range of between 0.1 Mpa to 80 Mpa, 0.1 Mpa to 60 Mpa, 0.1 Mpa to 15 Mpa, 0.1 Mpa to 14 Mpa, 0.1 Mpa to 13 Mpa, 0.1 Mpa to 12 Mpa, 0.1 Mpa to 11 Mpa, 0.1 Mpa to 10 Mpa, 0.1 Mpa to 9 Mpa, 0.1 Mpa to 8 Mpa, 0.1 Mpa to 7 Mpa, 0.1 Mpa to 6 Mpa, or 0.1 Mpa to 5 Mpa. In certain embodiments, the pressure of the mild isochoric freezing is 15 Mpa, 14 Mpa, 13 Mpa, 12 Mpa, 11 Mpa, 10 Mpa, 9 Mpa, 8 Mpa, 7 Mpa, 6 Mpa, or 5 Mpa.

In some embodiments, the mild isochoric freezing preservation of the present disclosure significantly extends the shelf life of biological matter. In some embodiments, the shelf life extends to at least 5 days, at least 10 days, at least 20 days, at least 1 month, at least 3 moths, at least 5 months, at least 9 months, at least 1 year, at least 2 years, at least 3 years, at least 5 years, at least 10 years, at least 20 years, or at least 50 years.

In some embodiments, the mild isochoric freezing preservation of the present disclosure preserves microbial safety of the biological matter. The isochoric freezing preservation inhibits microbial growths, such as bacteria or fungi in biological matter, thereby extending shelf life and minimizing waste. For example, the mild isochoric freezing preservation of the present disclosure preserves microbial safety of perishable raw milk products.

In some embodiments, the mild isochoric freezing preservation of the present disclosure preserves nutritional qualities of biological matter because the isochoric freezing conditions prevent ice crystal formation inside the preserved biological matter. In other words, the mild isochoric freezing preservation preserves the appropriate levels of individual nutrients in the biological matter. For example, nutritional quality indicators are, but not limited to, microbiology, pH, titratable acidity, enzyme activity, viscosity, and volatile organic compounds.

In some embodiments, the mild isochoric freezing preservation of the present disclosure preserves sensory qualities of biological matter, such as appearance, odor, flavor, taste, and texture of biological matter detectable by human senses. In other embodiments, the mild isochoric freezing preservation of the present disclosure does not impact protein structures of biological matter due to moderate pressures and mild sub-freezing temperatures.

In some embodiments, the mild isochoric freezing preservation of the present disclosure preserves both the microbial safety and the nutritional and sensory qualities of biological matter.

### Short Term Subfreezing Application

In some embodiments, applying short term isochoric freezing to the fluid in the isochoric chamber enables to eliminate or killing biological contaminants in biological matter during long term preservation.

Herein, the “short term” of the short term isochoric freezing refers to the time applied for the isochoric freezing for eliminating or killing biological contaminants in biological matter. In some embodiments, the “short-term” of the short-term isochoric freezing for eliminating or killing biological contaminants in biological matter refers a length of time from seconds to minutes or minutes to hours. In some embodiments, the short term isochoric freezing is applied to the fluid in the isochoric chamber for about 0.1 hour, about 0.3 hour, about 0.5 hour, about 1 hour, about 2 hours, about 3 hours, about 4 hours, about 5 hours, about 6 hours, about 8 hours, about 10 hours, about 12 hours, about 15 hours, about 18 hours, about 20 hours, about 24 hours or about 48 hours.

In some embodiments, the subfreezing temperature for short term isochoric freezing is for eliminating or killing biological contaminants in biological matter in the range of about −10 °C to −22 °C, about −10 °C to −20 °C, or about −10 °C to −18 °C. For example, the subfreezing temperature for short term isochoric freezing is −10 °C, −11 °C, −12 °C, −13 °C, −14 °C, −15 °C, −16 °C, −17 °C, −18 °C, −19 °C, −20 °C or −21 °C.

In some embodiments, the pressure for short term isochoric freezing for eliminating or killing biological contaminants in biological matter is in the range of about 90 MPa to 210 MPa, 100 MPa to 180 MPa or 100 to 150 MPa. For example, the pressure for short term isochoric freezing is 180 MPa, 170 MPa, 160 MPa, 150 MPa, 140 MPa, 130 MPa, 120 MPa, 110 MPa, 100 MPa or 90 MPa.

### Biological Matters of the Method

In some aspects of the method, the biological matter is, but not limited to, a cell, an organ, an organism, a biomedical product, an agricultural product, a food product, a fruit, or a beverage. In some embodiments, the cell is a plant cell or an animal cell. In other embodiments, the cell is, but not limited to, a stem cell, a bone cell, a blood cell, a muscle cell, a sperm cell, a female egg cell, a fat cell, a nerve cell. In some embodiments, the organ is obtained from animals. In other embodiments, the organ is obtained from a human. For example, the organ is a pancreas, a brain, a liver, a heart, kidneys, lungs, a spleen, a stomach, or intestines. In some embodiments, the biomedical product is, but not limited to, artificial organs, drugs, and medicines. In certain embodiments, medical instruments can be sterilized by the method of the present disclosure during long term preservation. In some embodiments, the fruit includes a whole fruit, a fresh-cut fruit, or fruit arils. In other embodiments, the fruit is, but not limited to, an apple, a pear, a pomegranate, an orange, a grapefruit, a mandarin, a lime, a lemon, a nectarine, an apricot, a peach, a plum, a banana, a mango, a strawberry, a raspberry, a blueberry, a kiwifruit, a passionfruit, watermelons, a melon, a honeydew melon, a cantaloupe, a tomato, or an avocado. In certain embodiments, the fruit includes whole pomegranate, fresh-cut pomegranate, or pomegranate arils. In some embodiments, the agricultural product includes, but is not limited to, vegetables, legumes, or grains. In other embodiments, the vegetables are, not limited to, lettuce, spinach, beet, cabbage, cauliflower, brussels sprout, broccoli, pumpkin, cucumber, zucchini, potato, sweet potato, yam, celery, asparagus, onion, garlic, shallot, or carrot. In some embodiments, the legumes are, but not limited to, tofu, soybeans, chickpea flour, lentil flour, soy flour, haricot beans, red kidney beans, chickpeas, lentils, green peas, green beans, butter beans, or snow peas.

In some embodiments, the beverage includes fruit juice, vegetable juice, or combination thereof. In other embodiments, the beverage includes milk. In certain embodiments, the fruit juice is, but not limited to, orange juice, apple juice, grape juice, tomato juice, pomegranate juice, or mixed fruit juice. In certain embodiments, the vegetable juice is, but not limited to, carrot juice, kale juice, spinach juice, or mixed vegetable juice. In some embodiments, the food product includes dairy product or milk product.

In some embodiments, liquid biological matter, such as fruit juice or vegetable juice, is collected in an impermeable but flexible container. For example, liquid biological matter is collected in a polyethylene sterile bag. The bag is then sealed with negligible headspace and placed inside the isochoric chamber.

In some embodiments, the biological matter is not sterilized before the preservation process. In some exemplary embodiments, the biological matter is raw milk, unpasteurized milk, unpasteurized cheese, or unpasteurized yogurt. In other exemplary embodiments, the biological matter is unsterilized orange juice, unsterilized pomegranate juice, unsterilized carrot juice. In still other exemplary embodiments, the biological matter is unsterilized pomegranate arils. As such, the present disclosure provides a method for reducing or eliminating biological contaminants in an unsterilized biological matter during long term preservation.

### Biological Contaminants in a Biological Matter

In some aspects of the method, the contaminants include, but are not limited to, microorganisms, mold, fungi, yeast, bacteria, pathogens, viruses, spores, protozoa, archaea, multicellular animal parasites. In certain embodiments, the bacteria include aerobic mesophilic bacteria. Examples of the bacteria are Salmonella and Listeria. Examples of the viruses are Norovirus. Examples of parasites are trematodes and prions. Examples of the yeasts and molds are Aspergillus flavus. Examples of fungi found in fruits and vegetables are, but not limited to, Alternaria, Botrytis, Colletotrichum, Penicillium, Rhizopus, and Monilinia.

### Effects of Long Term Isochoric Freezing Preservation of the Present Disclosure

In some aspects of the method, long term isochoric freezing can preserve a biological matter without or with minimal quality loss during long term preservation. In some embodiments, the quality loss is determined by measuring color change, texture change, water content change, humidity loss, pH change, mass change, total soluble solids change, titratable acidity (TA) change, ascorbic acid (AA) change, or antioxidant activity. In other embodiments, long term isochoric freezing can reduce biological contaminants in a biological matter during long term preservation. In still other embodiments, long term isochoric freezing can eliminate biological contaminants in a biological matter during long term preservation. In yet other embodiments, long term isochoric freezing can reduce growth of biological contaminants, such as microbial growth in a biological matter during long term preservation. In further embodiments, the present disclosure provides methods for reducing a level of biological contaminants in a biological matter during long term preservation. In still further embodiments, long term isochoric freezing can inactivate biological contaminants in a biological matter during long term preservation. In some aspects of the method, long term isochoric freezing during long term preservation of a biological matter reduces growth of biological contaminants as well as minimizes quality loss during the preservation.

In some embodiments, the long-term isochoric freezing reduces biological contaminants on the surface of a biological matter. In other embodiments, the long-term isochoric freezing eliminates biological contaminants on the surface of a biological matter. In this case, the biological matter includes a solid biological matter having surfaces such as a cell, an organ, an organism, a biomedical product, an agricultural product, a food product, a fruit, and the like. In this case, the biological matter does not include liquid biological matter such as a beverage. In certain embodiments, the food product includes raw food or undercooked food. In certain embodiments, the food product also includes cooked food. In certain embodiments, the fruit includes a whole fruit, a fresh-cut fruit, or fruit arils. For example, the long-term isochoric freezing reduces or eliminates biological contaminants on the surface of raw or undercooked fish, raw or undercooked meat, raw or undercooked poultry, raw shellfish, pomegranate arils, fresh-cut pomegranate, fresh-cut watermelon, fresh-cut peach, fresh-cut orange, orange arils, fresh-cut apple, fresh-cut pineapple, fresh-cut melon, fresh-cut cantaloupe, fresh-cut potato, fresh-cut garlic, fresh-cut onion, fresh-cut sweet potato, fresh-cut carrot, fresh-cut zucchini, fresh-cut cucumber, without limitation. In certain embodiments, the surface of medical instruments can be sterilized by the method of the present disclosure during long term preservation.

In some embodiments, the long-term isochoric freezing reduces biological contaminants in the interior of a biological matter. In some embodiments, the long-term isochoric freezing eliminates biological contaminants in the interior of a biological matter. In this case, the biological matter includes both solid biological matter and liquid biological matter, such as a cell, an organ, an organism, a biomedical product, an agricultural product, a food product, a fruit and beverage. In certain embodiments, biological contaminants can exist in the liquid biological matter, which is, but not limited to, fruit juice, vegetable juice, mixed juice, and milk. Examples of the liquid biological matter are carrot juice, spinach juice, kale juice, vegetable and fruit pomegranate juice, orange juice, grape juice, cherry juice, mango juice, pineapple juice, apple juice, and milk. As such, the biological contaminants in the liquid biological matter can be reduced or eliminated by the long-term isochoric freezing of the method of the present disclosure.

### 4. DEVICES FOR LONG TERM PRESERVATION OF A BIOLOGICAL MATTER AND INHIBITING OR REDUCING CONTAMINANTS IN THE BIOLOGICAL MATTER

Aspects of the present disclosure provide isochoric freezing system for inhibiting biological contaminants in a biological matter as well as enabling long term preservation of the biological matter while preserving both the microbial safety and the nutritional and sensory qualities of biological matter. Aspects of the present disclosure provide isochoric freezing system for reducing or eliminating biological contaminants in a biological matter as well as enabling long term preservation of the biological matter while preserving both the microbial safety and the nutritional and sensory qualities of biological matter. In one aspect, the present disclosure provides an isochoric freezing system for inhibiting or reducing growth of biological contaminants in a biological matter during long term preservation while preserving both the microbial safety and the nutritional and sensory qualities of biological matter. In another aspect, the present disclosure provides an isochoric freezing system for maintaining or reducing a level of biological contaminants in a biological matter during long term preservation while preserving both the microbial safety and the nutritional and sensory qualities of biological matter. In still another aspect, the present disclosure provides an isochoric freezing system for sterilizing a biological matter during long term preservation while preserving both the microbial safety and the nutritional and sensory qualities of biological matter. In yet another aspect, the present disclosure provides an isochoric freezing system for inactivating biological contaminants in a biological matter during long term preservation while preserving both the microbial safety and the nutritional and sensory qualities of biological matter.

In some embodiments, the isochoric freezing system of the present disclosure represents a device for long term preservation of a biological matter and inhibiting or reducing biological contaminants in the biological matter while preserving both the microbial safety and the nutritional and sensory qualities of biological matter. More specifically, the device of the present disclosure comprises an isochoric chamber filled with a fluid and a biological matter in the fluid in the isochoric chamber, wherein the isochoric chamber is applied to long term isochoric freezing at subfreezing temperature. In other embodiments, the device of the present disclosure comprises an isochoric chamber filled with a fluid and a biological matter in the fluid in the isochoric chamber, wherein the isochoric chamber is applied to long term mild isochoric freezing with moderate pressures and mild subfreezing temperatures. In other embodiments, the device of the present disclosure comprises an isochoric chamber filled with a fluid and a biological matter in the fluid in the isochoric chamber, wherein the isochoric chamber is applied to short term isochoric freezing with higher pressures and lower subfreezing temperatures.

### Isochoric Freezing System for Long Term Preservation of a Biological Matter

The device of the present disclosure comprises (i) an isochoric chamber filled with a fluid and (ii) a biological matter in the fluid in the isochoric chamber, wherein the isochoric chamber is applied to long term isochoric freezing at subfreezing temperature. Herein, the isochoric freezing refers to the freezing of aqueous solutions in a constant volume chamber. The term “isochoric chamber” is used interchangeably herein with “constant volume chamber” or “rigid chamber”.

In the isochoric freezing system of the present disclosure, a biological matter such as food product is placed inside an isochoric chamber filled with an aqueous solution. In the isochoric freezing, a substantial portion of the volume remains unfrozen which is associated with an increase in pressure. The process of isochoric freezing occurs along the liquidus line in a temperature-pressure phase diagram as the temperature is dropped because the volume in an isochoric chamber is constant.

FIG. 1 illustrates the difference between isobaric freezing and isochoric freezing in a temperature-pressure phase diagram for water. It shows the triple point for water after which at lower temperatures, there is no liquid water. It also shows that at constant pressure, as soon as the temperature is below the liquidus line intersection with the constant pressure line, the entire system freezes. In contrast, in an isochoric system, pressure and temperature are interrelated through the liquidus curve in the phase diagram of the aqueous solution. Consequently, only part of the water can freeze to become ice at thermodynamic equilibrium under the pressure and constant volume conditions. This avoids the formation of ice crystals inside the biological matter if the biological matter remains in the unfrozen region. Therefore, isochoric freezing relies on pressure to avoid ice formation inside the preserved biological matter at subfreezing temperatures. See, e.g., Rubinsky, B., Perez, P. A. and Carlson, M. E., “The thermodynamic principles of isochoric cryopreservation”, 2005, Cryobiology, 50(2), pp. 121-138 herein incorporated by reference in their entireties.

In the device of the present disclosure, isochoric freezing relies on Le Chatelier's principle, which states that as water expands upon freezing within a constant volume chamber (isochoric chamber), the enhanced pressures generated hinder further formation of ice. Therefore, the freezing process in an isochoric system follows the liquidus curve in the phase diagram for water depicted in FIG. 1. This minimizes the pressure for the given temperature and its potential harmful effects, such as impacting physicochemical and nutritional properties. In some embodiments, Le Chatelier's principle also allows the transformation of an aqueous liquid solution into two coexisting phases, a solid ice phase and a liquid phase, after lowering the temperature of the liquid solution to subfreezing temperatures. In this way, a biological matter such as a food product can be stored in the liquid phase inside the chamber at subfreezing temperatures without ice formation inside the products. For example, fruits and vegetables treated in this way can keep their original freshness with minimal changes in physicochemical and nutritional properties. Therefore, in some embodiments, an isochoric freezing can help retain the freshness of the biological matter such as harvested fruits and vegetables without substantially impacting their physicochemical and nutritional properties.

One of the major mechanisms of damage during preservation of a biological matter in aqueous solutions is the formation of ice. FIG. 2 shows that a substantial percentage of the volume in a liquid state to the triple point and the percentage of ice in an isochoric system as the temperature is lowered to the triple point. Therefore, in isochoric freezing it is possible to reduce the temperature while avoiding damage from the formation of ice by placing the matter to be preserved in the unfrozen part of the volume.

In some aspects of the device, the biological matter is placed inside the constant volume chamber filled with an aqueous solution in isochoric freezing. The constant volume chamber is filled with a fluid in such a way as to minimize the amount of air in the chamber. In some embodiments, the constant volume chamber is made of rigid materials such as metals or alloy metals. For example, the constant volume chamber is made of stainless steel, bronze, brass, aluminum, copper, iron or combination thereof. For example, FIG. 3 illustrates an exemplary isochoric chamber system for isochoric freezing. In FIG. 3, the isochoric chamber system comprises a constant volume chamber in pressure vessel 301, a pressure gauge 302, and a rupture disk 303. The constant volume chamber in pressure vessel 301 is seen in cross-sectional view 304. The constant volume chamber in pressure vessel 301 is preferably hermetically sealed, and the pressure therein is monitored with pressure gage 302. Optionally, the constant volume chamber in pressure vessel 301 can be made of stainless steel, but the present invention is not limited. The constant volume chamber in pressure vessel 301 is filled with fluid. In some embodiments, the fluid in the constant volume chamber is aqueous solution or pure water. In the isochoric freezing, if ice nucleates in the constant volume chamber, the pressure of the system increases, and the nucleation can be detected by the pressure gage. For example, U.S. Patent Publication No. 2007-0042337A1, incorporated by reference herein, which discusses isochoric freezing system and method for cryopreservation of a biological sample.

As exemplary embodiments, FIGS. 4 to 6 show that the isochoric system comprises a high-pressure isochoric chamber that is enclosed with a sealing cap. The isochoric chamber can be made of grade 7075 aluminum with a total volume capacity of 2 liters and pressure-rated for up to 110 MPa. The chamber can be connected to an electronic pressure transducer to monitor the pressure inside the chamber. A safety head with a rupture disk is in fluid communication with the interior of the isochoric chamber to ensure that the conditions inside the chamber do not exceed safety standards. In FIG. 4, pomegranate arils are selected as an example. Sec, Example section 1. In FIG. 5, pomegranates are selected as an example. See, Example section 1. In FIG. 6, carrot juice is selected as an example. See, Example section 2.

In some embodiments, a biological matter can be directly placed in the isochoric chamber. FIG. 7 illustrates an exemplary embodiment of isochoric freezing configuration with an isochoric chamber for preserving a biological mass while avoiding the formation of ice. In other embodiments, a biological matter can be placed in a container that allows transfer of pressure mass and heat. In still other embodiments, a biological matter can be placed in a container that allows transfer of only pressure and heat but not mass. FIG. 8 illustrates an exemplary embodiment of isochoric freezing configuration with an isochoric chamber and a matter container for preserving a biological mass while avoiding the formation of ice. Also, FIG. 9 illustrates an exemplary embodiment of isochoric freezing configuration with an isochoric chamber 901 and a matter container 902 for preserving a biological mass while avoiding the formation of ice. FIG. 9 shows two containers that transfer pressure but not mass in the isochoric chamber, a first container 902 with the biological material and a second container 903 with the sacrificial freezing solution while the entire isochoric chamber 901 is filled with a fluid 904 that does not freeze at the storage temperature. The second container 903 includes fluid that freezes at a temperature higher than the biological material. The isochoric chamber 901 further contains fluid 904 that freezes at a temperature lower than preservation temperature.

In some embodiments, liquid biological matter, such as fruit juice or vegetable juice, is collected in an impermeable but flexible container. For example, liquid biological matter is collected in a polyethylene sterile bag. The bag is then sealed with negligible headspace and placed inside the isochoric chamber.

In some embodiments, the fluid in the constant volume chamber is aqueous solution or pure water with or without organic molecules therein. In some embodiments, the aqueous solution that is primarily water may contain other chemicals so that the freezing point of the water-based solution may be modified as required for a specific application. For example, the water-based solution may contain salt. In certain embodiments, the external solution is water. In some embodiments, the fluid in the container can be the same as the fluid in the isochoric chamber surrounding the container. In other embodiments, the fluid in the matter container can be different from the fluid in the isochoric chamber surrounding the matter container. In other words, the fluid inside the matter container and the fluid outside the matter container can be of different types in osmotic equilibrium with the preserved biological matter.

In some aspects of the device, the isochoric chamber contains a nucleating agent. The nucleating agent forms an ice crystal thereby the biological matter can be preserved in the unfrozen part of the volume. The ice crystal formed by the nucleating agent generates pressures of the isochoric chamber, and the enhanced pressures hinder further formation of ice. In some embodiments, the nucleating agent can be a structural element of the isochoric freezing device. For example, the nucleating agent can be walls of the isochoric chamber itself, or walls of the matter container itself. In other embodiments, the nucleating agent can be any agent that promotes the formation of ice crystal in the isochoric chamber. For example, the ice nucleating agent is, but not limited to, minute solid particles, such as dust or food particles, large molecules, ice-nucleating proteins. In some embodiments, the nucleating agent is placed in the bottom of the isochoric chamber, and the chamber is completely filled with an aqueous solution.

After the chamber is prepared and loaded, the chamber is cooled to subfreezing temperatures described in the present disclosure, preferably in a conventional freezer. Once the biological matter is needed, the chamber is gradually warmed above the freezing temperature of the water, allowing the ice in the chamber to melt and the pressure to decrease. The chamber is then opened, and the biological is removed for the intended use.

### Isochoric Conditions of the Device

In some aspects of the device, long term refers to the time applied for isochoric freezing. In other aspects of the device, the time applied for isochoric freezing is the time for preserving a biological matter in an isochoric chamber. In some embodiments, long term of the present disclosure refers to a length of time from hours to years. In other embodiments, long term of the present disclosure refers to a length of time from days to years. In still other embodiments, long term of the present disclosure refers to a length of time from weeks to years. In yet other embodiments, long term of the present disclosure refers to a length of time from months to years. In certain embodiments, the minimum isochoric freezing time of the present disclosure is 1 hour or more. In certain embodiments, the minimum isochoric freezing time of the present disclosure is 6 hours or more. In certain embodiments, the minimum isochoric freezing time of the present disclosure is 12 hours or more. In certain embodiments, the minimum isochoric freezing time of the present disclosure is 24 hours or more. In certain embodiments, the minimum isochoric freezing time is 24 hours or more, 30 hours or more, 36 hours or more, 42 hours or more, or 48 hours or more. In some embodiments, the maximum isochoric freezing time of the present disclosure is not limited as long as applying isochoric freezing conditions to a biological matter in an isochoric chamber. In certain embodiments, the maximum isochoric freezing time of the present disclosure is, but not limited to, 10, 15, 20, 25, 30, 40, or 50 years. In some embodiments, long term is, but not limited to, 1 hour, 12 hours, 1 day, 2 days, 3 days, 4 days, 5 days, 6 days, 7 days, 8 days, 9 days, 10 days, 11 days, 12 days, 13 days, 14 days, 15 days, 16 days, 17 days, 18 days, 19 days, 20 days, 21 days, 22 days, 23 days, 24 days, 25 days, 26 days, 27 days, 28 days, 29 days, or 30 days. In other embodiments, the long term is, but not limited to, 1 week, 2 weeks, 3 weeks, 4 weeks, 5 weeks, 6 weeks, 7 weeks, 8 weeks, 9 weeks, 10 weeks, 11 weeks, or 12 weeks. In still other embodiments, long term includes, but is not limited to, 1 month, 2 months, 3 months, 4 months, 5 months, 6 months, 7 months, 8 months, 9 months, 10 months, 11 months, or 12 months. In further embodiments, long term includes, but is not limited to, 1 year, 2 years, 3 years, 4 years, 5 years, 6 years, 7 years, 8 years, 9 years, 10 years, 15 years, 20 years, 25 years, 30 years, 35 years, 40 years, or 50 years. In one embodiment, long term is in the range of more than 24 hours to 10 years. In another embodiment, long term is in the range of more than 48 hours to 10 years.

In some aspects of the device, the subfreezing temperature for inhibiting biological contaminants in a biological matter during long term preservation is much higher than the triple point along the liquidus line in a temperature pressure phase diagram depicted in FIG. 1. The triple point in the temperature pressure phase diagram depicted in FIG. 1 is about −21 °C. In some embodiments, the subfreezing temperature of the present disclosure is at least 5 °C higher than the triple point along the liquidus line in a temperature pressure phase diagram depicted in FIG. 1. In other embodiments, the subfreezing temperature of the present disclosure is at least 10 °C higher than the triple point along the liquidus line in a temperature pressure phase diagram depicted in FIG. 1. In some embodiments, the subfreezing temperature of the present disclosure is in the range of between 0 °C and −15 °C, 0 °C and −10 °C, or 0 °C and −5 °C. In other words, the subfreezing temperature of the present disclosure is lower than 0 °C and higher than −15 °C or higher than −10 °C. In some embodiments, the subfreezing temperature of the present disclosure is in the range of 0 °C to −14 °C, 0 °C to −13 °C, 0 °C to −12 °C, 0 °C to −11 °C, 0 °C to −10 °C, 0 °C to −9 °C, 0 °C to −8 °C, 0 °C to −7 °C, 0 °C to −6 °C, or 0 °C to −5 °C. In some embodiments, the subfreezing temperature of the present disclosure is −1 °C, −2 °C, −3 °C, −4 °C, −5 °C, −6 °C, −7 °C, −8 °C, −9 °C, −10 °C, −11 °C, −12 °C, −13 °C, or −14 °C. In certain embodiments, the subfreezing temperature of the present disclosure is 0 °C to −10 °C, 0 °C to −7 °C, 0 °C and −5 °C, −2.5 °C to −10 °C, −2.5 °C to −7 °C, or −2.5 °C to −5 °C.

In some aspects of the device, the long term isochoric freezing conditions combining the above-described subfreezing temperature and the pressure which occurs at the above-described subfreezing temperature when the closed isochoric chamber is in a state of thermodynamic equilibrium is effective in inhibiting or reducing biological contaminants in a biological matter during long term preservation. In the present disclosure, such a small elevation in pressure induced by the isochoric freezing condition has a profound effect on inhibiting or reducing biological contaminants. In comparison, standard methods for high pressure sterilization employ pressures on the order of 600 Mpa. Furthermore, the pressures induced by the isochoric freezing of the present disclosure have further effects on avoiding ice formation inside the preserved biological matter at the subfreezing temperature. In some aspects of the device, the applied pressure occurs at the above-described subfreezing temperature when the closed isochoric chamber is in a state of thermodynamic equilibrium. Therefore, the isochoric system of the present disclosure provides convenient ways to achieve subfreezing temperature and elevated pressures only by controlling the temperature without the need for mechanical means to elevated pressure.

In some embodiments, the isochoric freezing of the present disclosure is at a pressure in the range of 0.1 Mpa to 150 Mpa, 0.1 Mpa to 145 Mpa, 0.1 Mpa to 140 Mpa, 0.1 Mpa to 135 Mpa, 0.1 Mpa to 130 Mpa, 0.1 Mpa to 125 Mpa, 0.1 Mpa to 120 Mpa, 0.1 Mpa to 115 Mpa, 0.1 Mpa to 110 Mpa, 0.1 Mpa to 105 Mpa, 0.1 Mpa to 100 Mpa, 0.1 Mpa to 95 Mpa, 0.1 Mpa to 90 Mpa, 0.1 Mpa to 85 Mpa, 0.1 Mpa to 80 Mpa, 0.1 Mpa to 75 Mpa, 0.1 Mpa to 70 Mpa, 0.1 Mpa to 65 Mpa, 0.1 Mpa to 60 Mpa, 0.1 Mpa to 55 Mpa, 0.1 Mpa to 50 Mpa, 0.1 Mpa to 45 Mpa, 0.1 Mpa to 40 Mpa, 0.1 Mpa to 35 Mpa, or 0.1 Mpa to 30 Mpa. In certain embodiments, the pressure of the isochoric freezing is in the range of 0.1 Mpa to 35 Mpa or 0.1 Mpa to 60 Mpa. In some embodiments, the pressure of the isochoric freezing is 150 Mpa, 145 Mpa, 140 Mpa, 135 Mpa, 130 Mpa, 125 Mpa, 120 Mpa, 115 Mpa, 110 Mpa, 105 Mpa, 100 Mpa, 95 Mpa, 90 Mpa, 85 Mpa, 80 Mpa, 75 Mpa, 70 Mpa, 65 Mpa, 60 Mpa, 55 Mpa, 50 Mpa, 45 Mpa, 40 Mpa, 35 Mpa, or 30 Mpa. In other embodiments, the pressure of the isochoric freezing is lower than 150 Mpa or lower than 100 Mpa. In certain embodiments, the pressure of the isochoric freezing is 35 Mpa, and 12 Mpa.

### Mild Isochoric Freezing Conditions of the Device

In some aspects of the device, the isochoric freezing is a mild isochoric freezing. In some embodiments, conditions of the mild isochoric freezing comprise mild pressures and mild sub-freezing temperatures. The mild isochoric freezing preservation significantly extends the shelf life of perishable liquids while preserving both the microbial safety and the nutritional and sensory qualities of biological matter.

In some embodiments, the mild subfreezing temperature is in the range of −0.1 °C to −5 °C, −0.1 °C to −4.5 °C, −0.1 °C to −4.0 °C, −0.1 °C to −3.5 °C, 0 °C to −3.0 °C, 0 °C to −2.5 °C, 0 °C to −2.0 °C, −0.1 °C to −1.5 °C, or −0.1 °C to −1.0 °C. In certain embodiments, the mild subfreezing temperature is in the range of −0.1 °C to −1.5 °C. In some embodiments, the mild subfreezing temperature is −0.1 °C, −0.2 °C, −0.3 °C, −0.4 °C, −0.5 °C, −0.6 °C, −0.7 °C, −0.8 °C, −0.9 °C, −1.0 °C, −1.1 °C, −1.2 °C, −1.3 °C, −1.4 °C, −1.5 °C, −1.6 °C, −1.7 °C, −1.8 °C, −1.9 °C, −2.0 °C, −2.1 °C, −2.2 °C, −2.3 °C, −2.4 °C, −2.5 °C, −2.6 °C, −2.7 °C, −2.8 °C, −2.9 °C, −3.0 °C, −3.1 °C, −3.2 °C, −3.3 °C, −3.4 °C, −3.5 °C, −3.6 °C, −3.7 °C, −3.8 °C, −3.9 °C, −4.0 °C, −4.1 °C, −4.2 °C, −4.3 °C, −4.4 °C, −4.5 °C, −4.6 °C, −4.7 °C, −4.8 °C, −4.9 °C, or −5.0 °C. In certain embodiments, the mild subfreezing temperature is −1.5 °C.

In some embodiments, the mild isochoric freezing is at a pressure in the range of between 0.1 Mpa to 80 Mpa, 0.1 Mpa to 60 Mpa, 0.1 Mpa to 15 Mpa, 0.1 Mpa to 14 Mpa, 0.1 Mpa to 13 Mpa, 0.1 Mpa to 12 Mpa, 0.1 Mpa to 11 Mpa, 0.1 Mpa to 10 Mpa, 0.1 Mpa to 9 Mpa, 0.1 Mpa to 8 Mpa, 0.1 Mpa to 7 Mpa, 0.1 Mpa to 6 Mpa, or 0.1 Mpa to 5 Mpa. In certain embodiments, the pressure of the mild isochoric freezing is 15 Mpa, 14 Mpa, 13 Mpa, 12 Mpa, 11 Mpa, 10 Mpa, 9 Mpa, 8 Mpa, 7 Mpa, 6 Mpa, or 5 Mpa.

In some embodiments, the mild isochoric freezing preservation of the present disclosure significantly extends the shelf life of biological matter. In some embodiments, the shelf life extends to at least 5 days, at least 10 days, at least 20 days, at least 1 month, at least 3 moths, at least 5 months, at least 9 months, at least 1 year, at least 2 years, at least 3 years, at least 5 years, at least 10 years, at least 20 years, or at least 50 years.

In some embodiments, the mild isochoric freezing preservation of the present disclosure preserves microbial safety of the biological matter. The isochoric freezing preservation inhibits microbial growths, such as bacteria or fungi in biological matter, thereby extending shelf life and minimizing waste. For example, the mild isochoric freezing preservation of the present disclosure preserves microbial safety of perishable raw milk products.

In some embodiments, the mild isochoric freezing preservation of the present disclosure preserves nutritional qualities of biological matter because the isochoric freezing conditions prevent ice crystal formation inside the preserved biological matter. In other words, the mild isochoric freezing preservation preserves the appropriate levels of individual nutrients in the biological matter. For example, nutritional quality indicators are, but not limited to, microbiology, pH, titratable acidity, enzyme activity, viscosity, and volatile organic compounds.

In some embodiments, the mild isochoric freezing preservation of the present disclosure preserves sensory qualities of biological matter, such as appearance, odor, flavor, taste, and texture of biological matter detectable by human senses. In other embodiments, the mild isochoric freezing preservation of the present disclosure does not impact protein structures of biological matter due to moderate pressures and mild sub-freezing temperatures.

In some embodiments, the mild isochoric freezing preservation of the present disclosure preserves both the microbial safety and the nutritional and sensory qualities of biological matter.

### Short Term Subfreezing Application

In some embodiments, applying short term isochoric freezing to the fluid in the isochoric chamber enables to eliminate or killing biological contaminants in biological matter during long term preservation.

Herein, the “short term” of the short term isochoric freezing refers to the time applied for the isochoric freezing for eliminating or killing biological contaminants in biological matter. In some embodiments, the “short-term” of the short-term isochoric freezing for eliminating or killing biological contaminants in biological matter refers a length of time from seconds to minutes or minutes to hours. In some embodiments, the short term isochoric freezing is applied to the fluid in the isochoric chamber for about 0.1 hour, about 0.3 hour, about 0.5 hour, about 1 hour, about 2 hours, about 3 hours, about 4 hours, about 5 hours, about 6 hours, about 8 hours, about 10 hours, about 12 hours, about 15 hours, about 18 hours, about 20 hours, about 24 hours or about 48 hours.

In some embodiments, the subfreezing temperature for short term isochoric freezing is for eliminating or killing biological contaminants in biological matter in the range of about −10 °C to −22 °C, about −10 °C to −20 °C, or about −10 °C to −18 °C. For example, the subfreezing temperature for short term isochoric freezing is −10 °C, −11 °C, −12 °C, −13 °C, −14 °C, −15 °C, −16 °C, −17 °C, −18 °C, −19 °C, −20 °C or −21 °C.

In some embodiments, the pressure for short term isochoric freezing for eliminating or killing biological contaminants in biological matter is in the range of about 90 MPa to 210 MPa, 100 MPa to 180 MPa or 100 to 150 MPa. For example, the pressure for short term isochoric freezing is 180 MPa, 170 MPa, 160 MPa, 150 MPa, 140 MPa, 130 MPa, 120 MPa, 110 MPa, 100 MPa or 90 MPa.

### Biological Matters of the Device

In the device, the biological matter is, but not limited to, a cell, an organ, an organism, a biomedical product, an agricultural product, a food product, a fruit, or a beverage. In some embodiments, the cell is a plant cell or an animal cell. In other embodiments, the cell is, but not limited to, a stem cell, a bone cell, a blood cell, a muscle cell, a sperm cell, a female egg cell, a fat cell, a nerve cell. In some embodiments, the organ is obtained from animals. In other embodiments, the organ is obtained from a human. For example, the organ is a pancreas, a brain, a liver, a heart, kidneys, lungs, a spleen, a stomach, or intestines. In some embodiments, the biomedical product is, but not limited to, artificial organs, drugs, and medicines. In certain embodiments, medical instruments can be sterilized by the device of the present disclosure during long term preservation.

In some embodiments, the fruit includes a whole fruit, a fresh-cut fruit, or fruit arils. In other embodiments, the fruit is, but not limited to, an apple, a pear, a pomegranate, an orange, a grapefruit, a mandarin, a lime, a lemon, a nectarine, an apricot, a peach, a plum, a banana, a mango, a strawberry, a raspberry, a blueberry, a kiwifruit, a passionfruit, watermelons, a melon, a honeydew melon, a cantaloupe, a tomato, or an avocado. In certain embodiments, the fruit includes whole pomegranate, fresh-cut pomegranate, or pomegranate arils. In some embodiments, the agricultural product includes, but is not limited to, vegetables, legumes, or grains. In other embodiments, the vegetables are, not limited to, lettuce, spinach, beet, cabbage, cauliflower, brussels sprout, broccoli, pumpkin, cucumber, zucchini, potato, sweet potato, yam, celery, asparagus, onion, garlic, shallot, or carrot. In some embodiments, the legumes are, but not limited to, tofu, soybeans, chickpea flour, lentil flour, soy flour, haricot beans, red kidney beans, chickpeas, lentils, green peas, green beans, butter beans, or snow peas.

In some embodiments, the beverage includes fruit juice, vegetable juice, or combination thereof. In other embodiments, the beverage includes milk. In certain embodiments, the fruit juice is, but not limited to, orange juice, apple juice, grape juice, tomato juice, pomegranate juice, or mixed fruit juice. In certain embodiments, the vegetable juice is, but not limited to, carrot juice, kale juice, spinach juice, or mixed vegetable juice. In some embodiments, the food product includes dairy product or milk product.

In some embodiments, the biological matter is optionally sterilized before the preservation process. In some embodiments, the present disclosure provides devices for inhibiting or preventing biological contaminants in a sterilized biological matter during long term preservation. In other embodiments, the present disclosure provides devices for maintaining a level of biological contaminants in a sterilized biological matter during long term preservation.

In some embodiments, the biological matter is not sterilized before the preservation process. In some exemplary embodiments, the biological matter is raw milk, unpasteurized milk, unpasteurized cheese, or unpasteurized yogurt. In other exemplary embodiments, the biological matter is unsterilized orange juice, unsterilized pomegranate juice, unsterilized carrot juice. In still other exemplary embodiments, the biological matter is unsterilized pomegranate arils. In some embodiments, the present disclosure provides devices for reducing or eliminating biological contaminants in an unsterilized biological matter during long term preservation. In other embodiments, the present disclosure provides devices for sterilizing a biological matter during long term preservation.

### Biological Contaminants in a Biological Matter

In some aspects of the device, the contaminants include, but are not limited to, microorganisms, mold, fungi, yeast, bacteria, pathogens, viruses, spores, protozoa, archaea, multicellular animal parasites. In certain embodiments, the bacteria include aerobic mesophilic bacteria. Examples of the bacteria are Salmonella and Listeria. Examples of the viruses are Norovirus. Examples of parasites are trematodes and prions. Examples of the yeasts and molds are Aspergillus flavus. Examples of fungi found in fruits and vegetables are, but not limited to, Alternaria, Botrytis, Colletotrichum, Penicillium, Rhizopus, and Monilinia.

### Effects of Long Term Isochoric Freezing Preservation of the Present Disclosure

In some aspects of the device, long term isochoric freezing can preserve a biological matter without or with minimal quality loss during long term preservation. In some embodiments, the quality loss is determined by measuring color change, texture change, water content change, humidity loss, pH change, mass change, total soluble solids change, titratable acidity (TA) change, ascorbic acid (AA) change, or antioxidant activity. In some embodiments, long term isochoric freezing can inhibit or prevent biological contaminants in a biological matter during long term preservation. In other embodiments, long term isochoric freezing can reduce biological contaminants in a biological matter during long term preservation. In still other embodiments, long term isochoric freezing can eliminate biological contaminants in a biological matter during long term preservation. In still other embodiments, long term isochoric freezing can inhibit or prevent growth of biological contaminants, such as microbial growth, in a biological matter during long term preservation. In yet other embodiments, the present disclosure provides devices for maintaining or reducing a level of biological contaminants in a biological matter during long term preservation. In still further embodiments, long term isochoric freezing can inactivate biological contaminants in a biological matter during long term preservation. In still another aspect, the present disclosure provides devices for sterilizing a biological matter having biological contaminants during long term preservation.

In some embodiments, the long-term isochoric freezing inhibits biological contaminants on the surface of a biological matter. In other embodiments, the long-term isochoric freezing reduces or eliminates biological contaminants on the surface of a biological matter. In this case, the biological matter includes a solid biological matter having surfaces such as a cell, an organ, an organism, a biomedical product, an agricultural product, a food product, a fruit, and the like. In this case, the biological matter does not include liquid biological matter such as a beverage. In certain embodiments, the food product includes raw food or undercooked food. In certain embodiments, the food product also includes cooked food. In certain embodiments, the fruit includes a whole fruit, a fresh-cut fruit, or fruit arils. For example, the long-term isochoric freezing reduces biological contaminants on the surface of raw or undercooked fish, raw or undercooked meat, raw or undercooked poultry, raw shellfish, pomegranate arils, fresh-cut pomegranate, fresh-cut watermelon, fresh-cut peach, fresh-cut orange, orange arils, fresh-cut apple, fresh-cut pineapple, fresh-cut melon, fresh-cut cantaloupe, fresh-cut potato, fresh-cut garlic, fresh-cut onion, fresh-cut sweet potato, fresh-cut carrot, fresh-cut zucchini, fresh-cut cucumber, without limitation. In certain embodiments, the surface of medical instruments can be sterilized by the device of the present disclosure during long term preservation.

In some embodiments, the long-term isochoric freezing inhibits or prevents biological contaminants in the interior of a biological matter. In other embodiments, the long-term isochoric freezing reduces or eliminates biological contaminants in the interior of a biological matter. In this case, the biological matter includes both solid biological matter and liquid biological matter such as a cell, an organ, an organism, a biomedical product, an agricultural product, a food product, a fruit and beverage. In certain embodiments, biological contaminants can exist in the liquid biological matter, which is, but not limited to, fruit juice, vegetable juice, mixed juice, milk. Examples of the liquid biological matter are carrot juice, spinach juice, kale juice, vegetable and fruit pomegranate juice, orange juice, grape juice, cherry juice, mango juice, pineapple juice, apple juice, or milk. In some embodiments, long term isochoric freezing inhibits or prevents growth of biological contaminants in pasteurized milk, sterilized fruit juice, or sterilized vegetable juice. In other embodiments, long term isochoric freezing reduces or eliminates growth of biological contaminants in raw milk, unsterilized fruit juice or unsterilized vegetable juice. The biological contaminants in the liquid biological matter can be inhibited or reduced by the long-term isochoric freezing of the device described herein.

Certain aspects of the presently disclosed subject matter having been stated hereinabove, which are addressed in whole or in part by the presently disclosed subject matter, other aspects will become evident as the description proceeds when taken in connection with the accompanying Examples and Figures as best described herein below.

### EXAMPLES OF NON-LIMITING ASPECTS OF THE DISCLOSURE

Aspects, including embodiments, of the present subject matter described above may be beneficial alone or in combination, with one or more other aspects or embodiments. Without limiting the foregoing description, certain non-limiting aspects of the disclosure are provided below. As will be apparent to those of skill in the art upon reading this disclosure, each of the individually numbered aspects may be used or combined with any of the preceding or following individually numbered aspects. This is intended to provide support for all such combinations of aspects and is not limited to combinations of aspects explicitly provided below:

Aspect 1. A method for inhibiting biological contaminants during long term preservation of a biological matter while preserving nutritional and sensory qualities of the biological matter, comprising:
placing a biological matter in a fluid in an isochoric chamber; and
applying long term isochoric freezing to the fluid in the isochoric chamber at subfreezing temperature.

Aspect 2. The method of Aspect 1, wherein the long term is from hours to years.

Aspect 3. The method of Aspect 2, wherein the long term is more than 24 hours and up to about 10 years.

Aspect 4. The method of any one of Aspects 1 to 3, wherein the subfreezing temperature is in the range of between 0 °C and −15 °C.

Aspect 5. The method of Aspect 4, wherein the subfreezing temperature is in the range of 0 °C to about −10 °C.

Aspect 6. The method of Aspect 4, wherein the subfreezing temperature is in the range of 0 °C to about −5 °C, or 0 °C to about −2 °C.

Aspect 7. The method of any one of Aspects 1 to 6, wherein the isochoric freezing is at a pressure in the range of about 0.1 MPa to about 150 Mpa.

Aspect 8. The method of Aspect 7, wherein the pressure of the isochoric freezing is in the range of about 0.1 Mpa to about 100 Mpa.

Aspect 9. The method of Aspect 7, wherein the pressure of the isochoric freezing is in the range of about 0.1 Mpa to about 35 Mpa.

Aspect 10. The method of any one of Aspects 1 to 3, wherein the isochoric freezing is mild isochoric freezing and wherein pressure of the mild isochoric freezing is in the range of about 0.1 Mpa to about 15 Mpa and temperature of the mild isochoric freezing is in the range of −0.1 °C to about −5 °C.

Aspect 11. The method of any one of Aspects 1 to 10, wherein the biological matter is directly placed in the isochoric chamber.

Aspect 12. The method of any one of Aspects 1 to 10, wherein the biological matter is placed in a matter container.

Aspect 13. The method of any one of Aspects 1 to 11, wherein the isochoric chamber contains a nucleating agent.

Aspect 14. The method of any one of Aspects 1 to 13, wherein the biological matter is a cell, an organ, an organism, a biomedical product, an agricultural product, a food product, a fruit, or a beverage.

Aspect 15. The method of Aspect 14, wherein the beverage is carrot juice, pomegranate juice, or milk.

Aspect 16. The method of Aspect 14, wherein the fruit includes a whole fruit, a fresh-cut fruit, or arils.

Aspect 17. The method of Aspect 14, wherein the fruit is a whole pomegranate or pomegranate arils.

Aspect 18. The method of any one of Aspects 1 to 17, wherein the biological contaminants are microorganisms, mold, fungi, pathogens, viruses, or spores.

Aspect 19. A method for reducing or eliminating biological contaminants during long term preservation of a biological matter while preserving nutritional and sensory qualities of the biological matter, comprising:
placing a biological matter in a fluid in an isochoric chamber, and
applying long term isochoric freezing to the fluid in the isochoric chamber at subfreezing temperature.

Aspect 20. The method of Aspect 19, wherein the long term is from hours to years.

Aspect 21. The method of Aspect 20, wherein the long term is more than 24 hours and up to 10 years.

Aspect 22. The method of any one of Aspects 19 to 21, wherein the subfreezing temperature is in the range of between 0 °C and about −15 °C.

Aspect 23. The method of Aspect 22, wherein the subfreezing temperature is in the range of 0 °C to about −10 °C.

Aspect 24. The method of Aspect 22, wherein the subfreezing temperature is in the range of 0 °C to about −5 °C, or 0 °C to about −2 °C.

Aspect 25. The method of any one of Aspects 19 to 24, wherein the isochoric freezing is at a pressure in the range of about 0.1 MPa to about 150 MPa.

Aspect 26. The method of Aspect 25, wherein the pressure of the isochoric freezing is in the range of about 0.1 Mpa to about 100 MPa.

Aspect 27. The method of Aspect 25, wherein the pressure of the isochoric freezing is in the range of about 0.1 Mpa to about 35 MPa.

Aspect 28. The method of any one of Aspects 19 to 21, wherein the isochoric freezing is mild isochoric freezing, wherein pressure of the mild isochoric freezing is in the range of about 0.1 Mpa to about 15 Mpa and temperature of the mild isochoric freezing is in the range of −0.1 °C to about −5 °C.

Aspect 29. The method of any one of Aspect 19 to 28, wherein the biological matter is directly placed in the isochoric chamber.

Aspect 30. The method of any one of Aspects 19 to 28, wherein the biological matter is placed in a matter container.

Aspect 31. The method of any one of Aspects 19 to 29, wherein the isochoric chamber contains a nucleating agent.

Aspect 32. The method of any one of Aspects 19 to 31, wherein the biological matter is a cell, an organ, an organism, a biomedical product, an agricultural product, a food product, a fruit, or a beverage.

Aspect 33. The method of Aspect 32, wherein the food product is dairy product or milk product.

Aspect 34. The method of Aspect 32 or 33, wherein the biological matter is not sterilized before preservation process.

Aspect 35. The method of any one of Aspects 19 to 34, wherein the biological contaminants are microorganisms, mold, fungi, pathogens, viruses, or spores.

Aspect 36. A device for long term preservation of a biological matter and inhibiting or reducing biological contaminants in the biological matter, comprising:
an isochoric chamber filled with a fluid containing a biological matter, wherein the isochoric
chamber is applied to long term isochoric freezing at subfreezing temperature.

Aspect 37. The device of Aspect 36, wherein the long term is from hours to years.

Aspect 38. The device of Aspect 36 or 37, wherein the long term is more than 24 hours and up to about 10 years.

Aspect 39. The device of any one of Aspects 36 to 38, wherein the subfreezing temperature is in the range of between 0 °C and about −15 °C.

Aspect 40. The device of Aspect 39, wherein the subfreezing temperature is in the range of 0 °C to about −10 °C.

Aspect 41. The device of Aspect 39, wherein the subfreezing temperature is in the range of 0 °C to about −5 °C.

Aspect 42. The device of any one of Aspects 36 to 41, wherein the isochoric freezing is at a pressure in the range of about 0.1 MPa to about 150 MPa.

Aspect 43. The device of Aspect 42, wherein the pressure of the isochoric freezing is in the range of about 0.1 Mpa to about 100 MPa.

Aspect 44. The device of Aspect 42, wherein the pressure of the isochoric freezing is in the range of about 0.1 Mpa to about 35 MPa.

Aspect 45. The device of any one of Aspects 36 to 38, wherein the isochoric freezing is mild isochoric freezing, wherein pressure of the mild isochoric freezing is in the range of about 0.1 Mpa to about 15 Mpa and temperature of the mild isochoric freezing is in the range of −0.1 °C to about −5 °C.

Aspect 46. The device of any one of Aspects 36 to 45, wherein the biological matter is directly placed in the isochoric chamber.

Aspect 47. The device of any one of Aspects 36 to 45, wherein the biological matter is placed in a matter container.

Aspect 48. The device of any one of Aspects 36 to 46, wherein the fluid in the isochoric chamber is an aqueous solution or water.

Aspect 49. The device of any one of Aspects 36 to 48, wherein the isochoric chamber contains a nucleating agent.

Aspect 50. The device of any one of Aspects 36 to 49, wherein the biological matter is a cell, an organ, an organism, a biomedical product, an agricultural product, a food product, a fruit, or a beverage.

Aspect 51. The device of Aspect 50, wherein the beverage is carrot juice or pomegranate juice.

Aspect 52. The device of Aspect 50, wherein the fruit is a whole fruit, a fresh-cut fruit, or arils.

Aspect 53. The device of Aspect 50, wherein the food product is a dairy product or a milk product.

Aspect 54. The device of any one of Aspects 50 to 53, wherein the biological matter is not sterilized before preservation process.

Aspect 55. The device of any one of Aspects 36 to 54, wherein the contaminants are microorganisms, mold, fungi, pathogens, viruses, or spores.

Aspect 56. A method for preserving pomegranate or pomegranate arils, comprising:
placing the pomegranate or pomegranate arils in a container in an isochoric chamber, wherein the isochoric chamber is filled with fluid; and
applying long term isochoric freezing to the fluid in the isochoric chamber at subfreezing temperature, wherein the long term is from hours to years and the subfreezing temperature is in the range of 0 °C to about −10 °C.

Aspect 57. The method of Aspect 56, wherein the isochoric freezing is mild isochoric freezing, wherein pressure of the mild isochoric freezing is in the range of about 0.1 Mpa to about 15 Mpa and temperature of the mild isochoric freezing is in the range of −0.1 °C to about −5 °C.

Aspect 58. A method for preserving carrot juice, comprising:
placing the carrot juice in a container in an isochoric chamber, wherein the isochoric chamber is filled with fluid; and
applying long term isochoric freezing to the fluid in the isochoric chamber at subfreezing temperature, wherein the long term is from hours to years and the subfreezing temperature is in the range of 0 °C to about −10 °C.

Aspect 59. The method of Aspect 58, wherein the isochoric freezing is mild isochoric freezing, wherein pressure of the mild isochoric freezing is in the range of about 0.1 Mpa to about 15 Mpa and temperature of the mild isochoric freezing is in the range of −0.1 °C to about −5 °C.

Aspect 60. A method for preserving milk, comprising:
placing the milk in a container in an isochoric chamber, wherein the isochoric chamber is filled with fluid; and
applying long term isochoric freezing to the fluid in the isochoric chamber at subfreezing temperature, wherein the long term is from hours to years and the subfreezing temperature is in the range of 0 °C to about −10 °C.

Aspect 61. The method of Aspect 60, wherein the isochoric freezing is mild isochoric freezing, wherein pressure of the mild isochoric freezing is in the range of about 0.1 Mpa to about 15 Mpa and temperature of the mild isochoric freezing is in the range of −0.1 °C to about −5 °C.

### EXAMPLES

The following examples are put forth so as to provide those of ordinary skill in the art with a complete disclosure and description of how to make and use the present invention and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for.

All publications and patent applications cited in this specification are incorporated by reference herein as if each individual publication or patent application were specifically and individually indicated to be incorporated by reference.

The present invention has been described in terms of particular embodiments found or proposed by the present inventor to comprise preferred modes for the practice of the invention. It will be appreciated by those of skill in the art that, in light of the present disclosure, numerous modifications and changes can be made in the particular embodiments exemplified without departing from the intended scope of the invention.

### 1. Long Term Preservation of Pomegranate Fruits

### 1. The Purpose of the Example

This example with whole pomegranates and pomegranate arils demonstrates that isochoric freezing and isochoric supercooling can be used to reduce microorganism contamination during storage at the surface of solid matter. The example shows that the combination isochoric freezing which is comprised of subfreezing temperature and the pressure which occurs at these temperatures when the closed volume system is in a state of thermodynamic equilibrium is more effective in inhibiting or reducing microorganism contamination than matter in the metastable state of supercooling to the same subfreezing temperatures or isobaric (constant atmospheric pressure) freezing to the same subfreezing temperature.

More specifically, this example was to evaluate the potential of isochoric freezing and isochoric supercooling to maintain the quality attributes and safety of pomegranate arils in whole pomegranates as well as fresh cut arils for 30 days. The effects of isochoric freezing and isochoric supercooling on the main physicochemical, nutritional and safety properties of pomegranate arils were evaluated and compared with refrigerated samples at 5 °C and 95% relative humidity. To isolate the effect of isochoric conditions, samples were also processed following the same procedures used for isochoric preservation except that the system was under isobaric conditions and open to atmospheric pressure.

In the present example, the effect of isochoric supercooling at −2.5 °C and isochoric freezing at −2.5 °C/12 MPa on the qualitative attributes of arils from whole pomegranates (cv. “Wonderful”) and fresh-cut arils preserved for 30 days was investigated and compared with cold storage at +5 °C/95% RH and isobaric freezing at −2.5 °C/0.1 MPa. Mass, total soluble solids (TSS), titratable acids (TA), pH, color, texture, microstructure, and phytochemical components including anthocyanin and ascorbic acid contents were determined. The isochoric supercooling of whole pomegranates led to color and texture retention, and increased levels of total anthocyanins, ascorbic acid content and antioxidant activity. In addition, isochoric supercooling inhibited mesophilic aerobic bacteria growth and led to significantly lower counts of yeast and molds in comparison with cold storage at +5 °C. On the other hand, isochoric freezing was the most effective technology to inhibit bacterial, yeast and fungal growth and to increase ascorbic acid content. In addition, mesophilic aerobic bacteria, yeast and mold counts were significantly lower in comparison to cold storage at +5 °C.

### 2. Materials and Methods

Pomegranate fruits (cv. Wonderful) with an initial water content of 82.8%±0.5 and TSS/TA ratio of 16.7±1.5, were obtained from a Commercial Agricultural Cooperative in Berkeley (California, US). Pomegranates with healthy outer skin and uniform size and appearance were selected for this study. Whole fruits were washed with 200 μLL⁻¹ sodium hypochlorite (NaOCl) solution to reduce the initial microbial load. Pomegranate fruit husks were manually processed for aril extraction.

### 2.1. Isochoric System

Two different pressure chambers were used for the isochoric experiments. The arils were processed in an OC-9 pressure chamber made of grade 316 stainless steel (High Pressure Equipment Company, Erie, PA, USA). The total volume capacity was 500 mL. The whole pomegranates were processed in an isochoric chamber made of grade 7755 aluminum (BioChoric LLC, Bozeman, MT). The total volume capacity was 2 liters. Each chamber was connected to an electronic pressure transducer (Stork Solutions Ltd., Hampshire, UK) that was connected to a laptop to monitor the pressure. The chambers were cooled using a recirculating bath (VWR AP 15R-40, Radnor, PA, US) filled with water and ethylene glycol (50:50) solution.

### 2.2. Experimental Protocol

Four different methods were used to preserve arils in whole pomegranate fruits and fresh-cut arils for 30 days: cold storage at 5 °C/95% RH, isochoric supercooling at −2.5 °C/0.1 MPa, isochoric freezing at −2.5 °C/12 MPa and isobaric freezing at −2.5 °C/0.1 MPa.

For the cold storage treatments, 3 whole pomegranates were placed in the refrigerator at 5 °C and 95% RH which were the recommended storage conditions for pomegranate of the “Wonderful” cultivar (Elyatem and Kader, 1984). For cold stored arils, 3 pomegranate fruits were manually peeled under sterile conditions, with 3 portions (150 g of arils each) from each fruit placed into 3 sterilized beakers and covered with Glad® ClingWrap Plastic Wrap. The beakers were left in the refrigerator at 5 °C and 95% RH for 30 days.

For the isochoric supercooling treatment of whole pomegranates, 3 pomegranate fruits were placed inside an isochoric chamber. The chamber was filled with an isotonic solution of 16% sucrose(S) and 0.5% ascorbic acid (AA) (Bronson Pharmaceuticals, St. Louis, MO) in distilled water. The ratio of solution mass to fruit mass was about 1/1. For the isochoric supercooling treatment of pomegranate arils, 250 g of arils extracted from 3 pomegranates were placed inside the isochoric chamber. The chamber was filled with the same S/AA isotonic solution previously described at a ratio of about 7/1 solution mass to aril mass. Isochoric supercooling treatments were performed at −2.5 °C for 30 days. After the treatments, the samples were slowly thawed at 5 °C for 14 h and then equilibrated to 22 °C before analysis.

The isochoric freezing treatments were performed following the same procedures as the isochoric supercooling treatments, except an ice nucleating piece (screw) was placed at the bottom of the isochoric chamber to ensure ice nucleation.

For the isobaric treatment, three whole pomegranates were individually packed and immersed in S/AA isotonic solution at a ratio of 1/1 solution mass to fruit mass. Also, three portions (150 g of arils each) extracted from 3 pomegranates were individually packed and immersed in a S/AA isotonic solution at a ratio 7/1 solution mass to fruit mass. Whole pomegranates and aril packets were immersed in the recirculating bath at −2.5 °C for 30 days. After the treatments, the samples were slowly thawed at 5 °C for 14 h and then equilibrated to 22 °C before analysis.

### 2.3. Microbial Evaluations

For each treatment and control, 20 g of arils were taken from each of the three replicates and homogenized in 20 mL peptone water (0.1%) using a stomacher for 90 seconds. Decimal dilutions were prepared for the enumeration of total mesophilic aerobic bacteria, yeast, and molds. Appropriate dilutions were plated on plate count agar (PCA; Sigma Aldrich, St Louis, MO, USA) for mesophilic aerobic bacteria and incubated at 30 °C for 48 h. Dilutions were plated on potato dextrose agar for yeast and molds and incubated at 25 °C for 72 h. Microbial counts were conducted in duplicate for each repeat and results were expressed as log CFU (Lopez-Rubira et al., 2005).

### 2.3. Mass Change, Water Content, Total Soluble Solids (TSS), Titratable Acidity (TA) and pH

For each treatment, six replicates containing 50 arils each were used to determine mass loss percentages. Mass loss (%) was determined by measuring the difference between initial and final mass of each replicate and results were expressed as a percentage loss of initial mass. The moisture content was determined in triplicate using a conventional oven (Fisher Scientific Isotemp model 750 F, Pittsburgh, Pennsylvania, USA) at 105 °C for 72 h (AOAC, 1990).

Approximately 150 g of arils per treatment was juiced with a mortar and pestle and filtered using a screen to measure total soluble solids content (TSS), titratable acidity (TA), pH, ascorbic acid content, total anthocyanin content and antioxidant activity. The total soluble solids content (expressed as ° Brix) was determined by measuring the refractive index of the juice with a digital refractometer (Maselli LR-01, Masseli Misure s.p.a., Parma, Italy). Total titratable acidity (TA) (expressed as citric acid %) was determined potentiometrically by adding 0.1 N NaOH to the titration end point (pH of 8.2) of 5 mL of juice diluted with 25 mL of distilled water. The pH measurements were performed using a pH meter (Hanna instruments, USA). All analyses were performed in triplicate.

### 2.4. Color

Skin color was measured on the cheek area of 12 pomegranate arils using a tristimulus colorimeter (CM508D, Konica-Minolta Inc., Ramsey, NJ, USA) with a 3 mm diameter CM-A195 target mask. Instrumental color was measured using Illuminant D65 and 10⁰ observer angle. Color response variables were expressed according to the CIE Lab system (L*—lightness, a*—red/green and b*—yellow/blue). The chroma (C*), hue angle (h*) and color difference (ΔE*) were calculated according to the following equations:

$${C}^{*} = \sqrt{{a}^{* 2} + {b}^{* 2}} \qquad ( 1 )$$

$${h}^{*} = arctan \frac{{b}^{*}}{{a}^{*}} \times \frac{180}{π} ( degrees ) \qquad ( 2 )$$

$$Δ {E}^{*} = \sqrt{{( Δ {L}^{*} )}^{2} + {( Δ {a}^{*} )}^{2} + {( Δ {b}^{*} )}^{2}} \qquad ( 3 )$$

### 2.5. Texture Analysis

Mechanical tests were performed with a Texture Analyzer (Stable Microsystems Ltd., TA-XT2i, UK) at 23 °C on the same day after processing. Fifty arils were weighed, placed in a cup and crushed using a TA-25 C compression probe. The operating conditions were as follows: 5 mm·s⁻¹ pre-test speed, 2 mm·s⁻¹-test speed, 10.0 mm·s⁻¹ post-test speed, 0.10 N trigger force and 50% sample deformation. A total of 6 measurements were performed for each treatment. Hardness value (N) was considered as the maximum compression force. Crispiness was the number of positive peaks in the force versus time graph and crunchiness (N·s) was the linear distance of the rugged lines obtained from the same graph. A greater number of positive peaks indicated a greater number of fracture events, indicating crisper arils. A longer linear distance resulted in a longer drop from the peak for each fracture event on average, indicating crunchier arils (Luo, S. et al., 2020).

### 2.6. Cryo-SEM

Scanning electron microscopy (SEM) was used to analyze microstructural changes after 30 days of preservation. Three to five random pomegranate arils were chosen from each treatment. Each aril was vertically placed in the SEM sample holder with the seed far away from the sample holder and plunged into subcooled nitrogen (−210 °C). The frozen sample was transferred to the cryostage and then freeze fractured and platinum coated. The samples were viewed in a JEOL 7900 F field emission scanning electron microscope (JEOL, Kyoto) using a Quorum pp 3010T cryo system (Quorum Technologies, LTD, Laughton, East Sussex, UK).

### 2.7. Total Monomeric Anthocyanin Determination

The monomeric anthocyanin pigment content was determined by a pH-differential method using 2 buffer systems comprising potassium chloride (pH 1, 0.025 M) and sodium acetate (pH 4.5, 0.4 M) (Lee et al., 2005). Pomegranate juice sample (0.5 mL) was separately mixed with 10 mL of pH 1.0 and pH 4.5 buffers. A Shimadzu PharmaSpec UV-1700 spectrophotometer (Shimadzu Scientific Instruments, Inc., Columbia, MD) and a 1-cm path length disposable cell were used for spectral measurements at 510 and 700 nm. Pigment content was calculated as milligrams cyanidin-3-glucoside 0.100 mL⁻¹ pomegranate juice using the following equations:

$$A = {( A 520 - A 700 )}_{pH = 1} - {( A 520 - A 700 )}_{pH = 4.5} \qquad ( 4 )$$

$$Total monomeric anthocyanin = \frac{[ A \times MW \times DF \times 100 ]}{ε \times l} \qquad ( 5 )$$

where A was the Absorbance, MW was the anthocyanin molecular weight (449.2 g·mol⁻¹) for cyanidin-3-glucoside, DF was the dilution factor, l was the path length (1 cm) and ε was the Cyd-3-glucoside molar extinction coefficient (26,900 L·cm⁻¹·mol⁻¹). All analyses were performed in triplicate.

### 2.8. Ascorbic Acid (AA) Determination

AA was extracted from pomegranate arils immediately after processing by blending the pomegranate juice with the extraction solution at a ratio of 1:2.5. The extraction solution consisted of 30 g metaphosphoric acid, 0.5 g of EDTA and 80 mL of glacial acetic acid diluted to 1 L with distilled water. The blended sample was centrifuged (10,000 rpm) at 4 °C for 15 min. The collected supernatant was filtered and passed through solid-phase extraction cartridges (Bond Elut C18, 500 mg, 3 mL, Agilent Technologies) that were preconditioned with 2 mL of acetonitrile followed by 3 mL of distilled water. AA was analyzed by injecting 50 μL of the sample into an Agilent HPLC 1100 series liquid chromatograph (Agilent Technologies, Wilmington, DE, USA) equipped with an Agilent diode array detector set at 265 nm. An ICSep ICE-ION-300 (300×7.8 mm) column and guard column with the same packing (Transgenomic, Inc., San Jose, CA) were used as the stationary phase. The mobile phase was 20 mM of H₂SO₄ solution at a flow rate of 0.3 mL·min⁻¹. The ascorbic acid content was quantified through a standard calibration curve. Ascorbic acid contents were determined from 3 different samples for each treatment.

### 2.9. Antioxidant Activity

Radical scavenging capacity was determined using two methods: the DPPH radical scavenging activity according to Brand-Williams et al. (1995) and the ABTS·+ radical cation decolorization assay according to Re et al. (1999). One gram of pomegranate juice was homogenized in 20 mL of HPLC grade methanol in a 45 mL centrifuge tube. Tubes were capped, vortexed for 15s and then stored at 4 °C overnight. The next day, the sample was vortexed for 15 seconds and then clarified by centrifugation (15,600 rpm, 15 min at 4 °C) using a SORVALL RC 5 C Plus centrifuge (Kendro Laboratory Products, Newtown, CT). The supernatant was used to analyze for radical scavenging using DPPH− and ABTS·+ free radicals.

For the determination of DPPH radical scavenging activity, 50 μL of pomegranate extract reacted with 2950 μL of 2,2-Diphenyl-1-(2,4,6-trinitrophenyl) hydrazyl (DPPH, 103.2 μM in methanol) in a shaker at room temperature for 20 h. Absorbance at 515 nm was recorded using a Shimadzu PharmaSpec UV-1700 spectrophotometer (Shimadzu Scientific Instruments, Inc., Columbia, MD). The antioxidant activity was calculated by measuring the decrease in the sample absorbance compared to a methanol sample and quantified from a standard curve developed for Trolox (0-750 μg·mL⁻¹). Antioxidant (AOX) values were expressed as milligrams of trolox equivalent (TE) per gram. The ABTS radical scavenging activity was carried out by the method of Miller and Rice-Evans (1997), in which the ABTS·+ solution was prepared by mixing 25 mL of 8 mM ABTS·+ salt with 25 mL of 3 mM potassium persulphate in water. The solution was held at room temperature in the dark for 16 h before use. The ABTS·+ solution was diluted with 95% ethanol to obtain an absorbance between 0.8 and 1.0 at 734 nm. Fresh ABTS·+ solution was prepared for each analysis. 20 μL of pomegranate extract or Trolox standard solution (0.1, 0.2, 0.3 and 0.4 μM) was mixed with 1 mL ABTS·+ solution and incubated for 30 min at 30 °C. The absorbance at 734 nm was measured using a Shimadzu PharmaSpec UV-1700 spectrophotometer (Shimadzu Scientific Instruments, Inc., Columbia, MD). Ethanol (95%) was used as a blank. The free-radical-scavenging activity was expressed as micromoles of Trolox per gram of sample (micromol TE·g⁻¹ fw or dw).

### 2.11. Statistical Analysis

A full factorial experimental design was performed to study the effect of 4 different preservation methods (cold storage at 5 °C/95% RH, isochoric supercooling at −2.5 °C/0.1 MPa, isochoric freezing at −2.5 °C/12 MPa and isobaric freezing at −2.5 °C/0.1 MPa), four storage times (1 week, 2 weeks, 3 weeks and 4 weeks) and 2 samples (arils in whole pomegranate and ready-to-eat arils) on physicochemical, nutritional and safety properties of arils. The results were statistically analyzed using Minitab version 19 statistical software (Minitab Inc., State Collage, PA, USA). Significant differences between different treatments were assessed by performing analysis of variance (ANOVA) and interval plots at 95% confidence intervals. Statistically significant differences at the level of p≤0.05 were marked with different letters.

### 3. Results and Discussion

### 3.1. Microbiological Analysis

The influence of different preservation technologies on the growth of aerobic mesophilic bacteria, yeast and mold populations after 30 days of storage is shown in Table 1 below.

TABLE 1
Effects of postharvest technology on total aerobic mesophilic bacteria, yeast and mold counts
in pomegranate arils preserved for 30 days.

| | | Total aerobic | |
|---|---|---|---|
| | | mesophilic bacteria | Yeast and mold |
| | Postharvest technology | (log CFU g-1) | (log CFU g-1) |
| Whole fruit | Cold storage 5 °C/95% RH | 1.6 ± 0.6b | 1.5 ± 1.1b |
| | Isoch. SC at −2.5 °C/0.1 MPa | <1.00 | 2.0 ± 0.1b |
| | Isoch. F. at −2.5 °C/12 MPa | <1.00 | <1.00 |
| | Isob. F. at −2.5 °C/0.1 MPa | <1.00 | <1.00 |
| Fresh-cut | Cold storage 5 °C/95% RH | 6.1 ± 0.8a | 6.3 ± 0.5a |
| arils | Isoch. SC at −2.5 °C/0.1 MPa | 2.8 ± 0.9b | 2.1 ± 0.1b |
| | Isoch. F. at −2.5 °C/12 MPa | <1.00 | <1.00 |
| | Isob. F. at −2.5 °C/0.1 MPa | 2.2 ± 0.4b | 2.0 ± 0.6b |

In Table 1, columns in the same group bearing a common letter were insignificantly different at P>0.05. In Table 1, “RH” refers to relative humidity refers to RH, “SC” refers to supercooling, “F” refers to freezing, “Isoch.” Refers to isochoric “Isob.” Refers to “isobaric”.

Initial aerobic mesophilic bacteria and yeast and mold counts on fresh arils were below 1 log CFU·g⁻¹. For whole pomegranate arils after 30 days cold storage at +5 °C, aerobic mesophilic counts and yeast and mold counts have increased during the 30 days storage and were determined to be 1.59 and 1.48 log CFU·g⁻¹, respectively. In comparison, bacteria, yeast, and mold counts remained below the detection limit for whole pomegranate preserved using either isochoric freezing or isobaric freezing or isochoric supercooling at −2.5 °C.

For fresh-cut arils, isochoric freezing was the only preservation technology that effectively inhibited microbial growth to <1.00. In comparison, fresh-cut arils preserved using cold storage at +4 °C, had a higher number of bacteria, yeast, and molds than the original concentration. Isochoric supercooling at −2.5 °C and isobaric freezing at −2.5 °C also had higher numbers of bacteria, yeast, and molds than the original concentration. However, the concentration was substantially lower than in cold storage at +4 °C.

The important finding in this experiment is that a reduction in temperature, had the expected reduction in bacteria, yeast, and molds growth. As anticipated, the lower the temperature the lower the metabolism and the contaminants growth. The finding that such a small elevation in pressure, as the 12 MPa induced by isochoric freezing, had such a profound effect on reducing the contaminant growth was surprising. In comparison, standard methods for high pressure sterilization employ pressures on the order of 600 MPa.

In previous studies in this field, the use of isochoric freezing above temperatures of −15 °C for reduction of microbial contaminants was dismissed. In fact, as discussed in the background, previous studies have found no substantial effect on reduction of level of contaminants for short term, hours long, isochoric freezing above −15 °C. Most likely, because in previous studies, times of application of the isochoric freezing was much shorter than in our studies, because this is the standard in other sterilization techniques. In this disclosure, isochoric freezing temperature, the resultant isochoric freezing pressure, and the storage time together play a key role in the outcome of the preservation, with substantially longer times than conventional preservation way. Furthermore, while the combination of subfreezing temperatures and elevated pressure can be achieved by separately using a device for lowering the temperature and a different device for increasing the pressure, the isochoric freezing system of the present disclosure provides a convenient way to achieve low temperatures and elevated pressures only by controlling the temperature without the need for mechanical means to elevate the pressure. In addition, this finding is the first showing the isochoric freezing can reduce the level of contaminants on solid surfaces.

### 3.2. Mass Changes, Water Content, Total Soluble Solids (TSS), Titratable Acidity (TA) and pH

Isochoric supercooled samples showed a slight increase in aril mass when they were preserved in whole fruit due to the infusion of the external solution into the arils by capillary action or osmosis. In comparison, arils lost about 19% mass after cold storage, 7% mass after isochoric freezing and 4% mass after isobaric freezing (Table 2).

TABLE 2
Effects of postharvest preservation technology on aril mass
change (%), water content, TSS, TA and pH after 30 days.

| | Postharvest | ΔM | Water content | TSS | TA | |
|---|---|---|---|---|---|---|
| | technology | (%) | (%) | (%) | (g/L) | pH |
| Control | | | 82.76 ± 0.52^{a} | 16.7 ± 0.6^{c} | 9.35 ± 0.93^{a} | 3.52 ± 0.10^{ab} |
| Whole fruit | Cold storage | −18.76 ± 2.42^{d} | 81.61 ± 0.10^{a} | 17.9 ± 0.1^{b} | 10.29 ± 0.32^{a} | 3.36 ± 0.01^{b} |
| | 5 °C/95% RH | | | | | |
| | Isoch. SC | 3.15 ± 2.06^{a} | 82.44 ± 0.23^{a} | 16.7 ± 0.1^{c} | 8.58 ± 1.63^{a} | 3.60 ± 0.11^{ab} |
| | at −2.5 °C/0.1 | | | | | |
| | MPa | | | | | |
| | Isoch. F. | −7.12 ± 3.98^{c} | 81.06 ± 0.51^{ab} | 18.4 ± 0.9^{abc} | 9.95 ± 1.29^{a} | 3.51 ± 0.07^{ab} |
| | at −2.5 °C/12 | | | | | |
| | MPa | | | | | |
| | Isob. F. | −3.87 ± 2.13^{b} | 81.25 ± 0.87^{ab} | 17.7 ± 0.8^{abc} | 9.18 ± 0.99^{a} | 3.59 ± 0.09^{ab} |
| | at −2.5 °C/0.1 | | | | | |
| | MPa | | | | | |
| Fresh-cut | Cold storage | −6.10 ± 3.70^{bc} | 81.72 ± 0.22^{a} | 16.9 ± 0.6^{bc} | 8.84 ± 0.71^{ab} | 3.59 ± 0.08^{ab} |
| arils | 5 °C/95% RH | | | | | |
| | Isoch. SC | −8.62 ± 2.54^{c} | 79.00 ± 0.14^{b} | 17.7 ± 0.2^{b} | 6.06 ± 0.07^{b} | 3.55 ± 0.02^{a} |
| | at −2.5 °C/0.1 | | | | | |
| | MPa | | | | | |
| | Isoch. F. | −8.67 ± 0.48^{c} | 81.96 ± 0.58^{a} | 16.9 ± 0.4^{bc} | 6.11 ± 0.15^{b} | 3.60 ± 0.01^{a} |
| | at −2.5 °C/12 | | | | | |
| | MPa | | | | | |
| | Isob. F. | −35.02 ± 0.56^{e} | 78.45 ± 0.30^{b} | 19.6 ± 0.3^{a} | 7.34 ± 0.61^{b} | 3.58 ± 0.02^{a} |
| | at −2.5 °C/0.1 | | | | | |
| | MPa | | | | | |

Columns in the same group bearing a common letter were insignificantly different at P<0.05.

Aril mass loss under cold storage was probably due to fruit respiratory activity, transpiration and some oxidation processes. Isobaric freezing caused partial freezing, leading to slight mass loss. This might be due to chemical and physical damage of the cellular tissue caused by ice crystallization.

The values of TSS, TA and pH for fresh pomegranate were 16.7±0.6%, 9.3±1.9 g·l⁻¹ citric acid and 3.52±0.10, respectively. The range of TSS and TA values found in this study was within the range of those reported by Munhuweyi et al. (2017) for cv. ‘Wonderful’. Arils preserved as whole pomegranates showed a 7% increase in TSS after cold storage. This could be attributed to the water loss in these fruits, leading to concentration of the soluble solids. TA and pH were not significantly (P>0.05) affected by cold storage at 5 °C. The stability in pH was consistent with the study by Elyatem and Kader (1984), who reported no significant difference in pH values in fruits (cv. ‘Wonderful’) stored for 8 weeks at 5 °C. Also, isochoric supercooling, isochoric freezing or isobaric freezing did not significantly affect TSS, TA and pH values (P>0.05). This could be attributed to a decrease in the respiration rate at subfreezing temperatures and low oxygen levels, which resulted in lower consumption of sugars and acids during storage. Fresh-cut pomegranate arils have shown greater respiration rate and water transpiration than whole pomegranates due to an increase in metabolic activities from minimal processing operations (Bhatia and Asrey, 2019). This usually leads to greater mass losses of the extracted arils. In this study, the reduced total mass loss of fresh-cut arils under cold-storage (6%) in comparison with the 19% mass loss for arils preserved as whole fruits was due to the presence of a wrapping film covering the beakers. The film reduced permeability of water vapor during cold storage, which led to an increase in relative humidity inside the beaker and caused moisture condensation. Isochoric freezing and isochoric supercooling caused about 9% mass loss, indicating that the subfreezing temperatures and low oxygen conditions might have reduced metabolic activities but did not eliminate them. The greatest mass loss occurred for samples frozen under isobaric conditions (35.0±2.6%), where ice formation destroyed cellular tissues. This released cellular components and water content, resulting in a concomitant increase in water loss and total mass loss (Mazur, 1970). TSS, TA and pH values for fresh-cut arils did not significantly change during cold storage. The consumption of sugar and acids during respiration might have been counteracted by concentration of sugar and acids due to water loss. The main effect of isochoric supercooling and isochoric freezing on fresh-cut arils was a decrease in TA. This could be due to the organic acids being used as substrates for respiratory activity. Isobaric freezing caused a 17% increase in TSS and a 21% decrease in TA. These results could be explained by the increase in mass transfer between pomegranate arils and the surrounding aqueous S/AA solution due to irreversible cell damage and loss of cell membrane integrity induced by freezing.

### 3.3. Visual Appearance and Color

The visual qualities and color characteristics of pomegranate arils are presented in FIG. 10 and Table 3. Table 3 shows that arils preserved as whole fruits using isochoric supercooling or isochoric freezing maintained all color parameters, which resulted in low color difference values (ΔE*). In comparison, cold storage caused a significant reduction in color tone (hue angle, h°) and isobaric freezing caused a significant reduction in h° and yellowness (b*) parameters, though these differences were not visually apparent (FIG. 10).

TABLE 3
Effects of postharvest preservation technology on color parameters of arils preserved for 30 days.

| | Postharvest | | | | | | |
|---|---|---|---|---|---|---|---|
| | technology | L* | a* | b* | C* | h° | ΔE* |
| Control | | 27.3 ± 1.8^{a} | 9.81 ± 5.01^{ab} | 4.66 ± 2.31^{a} | 10.97 ± 5.37^{ab} | 26.93 ± 7.20^{a} | — |
| Whole | Cold storage | 26.6 ± 1.3^{ab} | 11.98 ± 3.21^{ab} | 3.95 ± 1.29^{ab} | 12.71 ± 3.35^{ab} | 17.08 ± 2.20^{b} | 4.95 ± 0.24^{a} |
| fruit | 5 °C/95% RH | | | | | | |
| | Isoch. SC | 27.9 ± 0.4^{a} | 11.78 ± 1.22^{ab} | 4.18 ± 0.38^{ab} | 12.56 ± 1.00^{a} | 19.39 ± 3.34^{ab} | 3.35 ± 0.49^{b} |
| | at −2.5 °C/0.1 | | | | | | |
| | MPa | | | | | | |
| | Isoch. F. | 26.6 ± 1.2^{ab} | 9.62 ± 2.19^{ab} | 3.55 ± 1.79^{ab} | 10.38 ± 2.26^{ab} | 20.25 ± 9.72^{ab} | 3.00 ± 1.18^{b} |
| | at −2.5 °C/12 | | | | | | |
| | MPa | | | | | | |
| | Isob. F. | 25.6 ± 0.6^{ab} | 8.12 ± 2.82^{b} | 2.00 ± 0.93^{bc} | 8.44 ± 2.95^{b} | 13.45 ± 2.54^{b} | 4.76 ± 0.97^{a} |
| | at −2.5 °C/0.1 | | | | | | |
| | MPa | | | | | | |
| Fresh-cut | Cold storage | 25.8 ± 3.5^{ab} | 9.35 ± 4.69^{ab} | 2.95 ± 1.42^{b} | 9.91 ± 4.67^{ab} | 19.11 ± 10.81^{ab} | 5.98 ± 1.73^{a} |
| arils | 5 °C/95% RH | | | | | | |
| | Isoch. SC | 25.5 ± 2.4^{ab} | 12.01 ± 2.06^{a} | 2.59 ± 1.50^{b} | 12.35 ± 2.19^{a} | 11.61 ± 6.34^{b} | 4.79 ± 0.92^{a} |
| | at −2.5 °C/0.1 | | | | | | |
| | MPa | | | | | | |
| | Isoch. F. | 26.8 ± 1.7^{a} | 9.40 ± 1.42^{b} | 0.66 ± 0.99^{c} | 9.44 ± 1.45^{b} | 3.91 ± 5.55^{c} | 4.50 ± 1.34^{a} |
| | at −2.5 °C/12 | | | | | | |
| | MPa | | | | | | |
| | Isob. F. | 24.8 ± 1.5^{b} | 11.09 ± 2.54^{ab} | 2.48 ± 0.98^{b} | 11.40 ± 2.56^{ab} | 12.77 ± 4.66^{b} | 4.47 ± 1.39^{a} |
| | at −2.5 °C/0.1 | | | | | | |
| | MPa | | | | | | |

Columns in the same group bearing a common letter were insignificantly different at P<0.05.

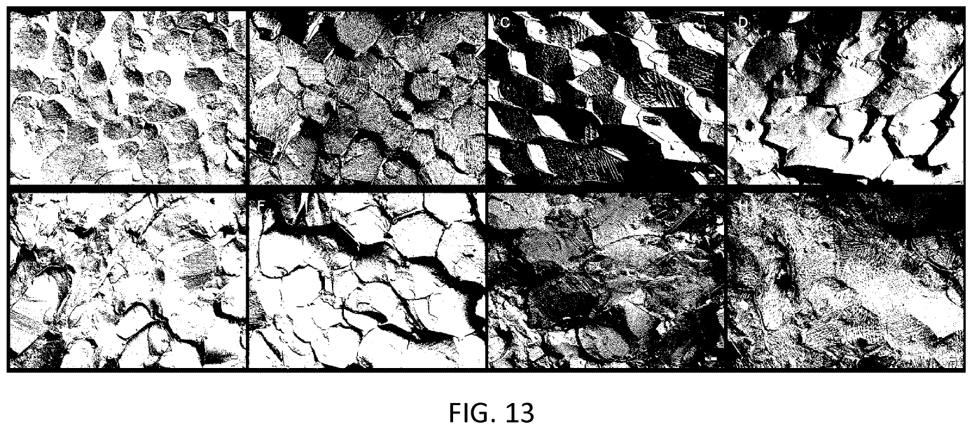

The different postharvest technologies did not significantly affect redness (a*) values of fresh-cut arils. However, all postharvest technologies caused significant decreases in b* and h° values. The color of pomegranate arils is due to the presence of anthocyanin pigments, which decreased for all samples (FIG. 13). The loss of visual quality was evident for refrigerated samples. These samples showed microbial decay with the development of external surface mycelia and some browning caused by the oxidation of phenolic compounds (Gil et al., 1996b). The characteristic bright color of fresh arils was preserved during isochoric supercooling, but the color tone appeared faded. In comparison, the characteristic bright color and color tone of pomegranate arils faded after isochoric or isobaric freezing. Injured cells might have caused accelerated discoloration due to the migration of pigments from pulp to solution, enzymatic browning, and degradation of anthocyanins. In isobaric frozen arils, visual appearance was also strongly affected by weight loss (Table 2), as shown by the visible shriveling.

### 3.4. Effects of Postharvest Preservation Technology on Mechanical Properties

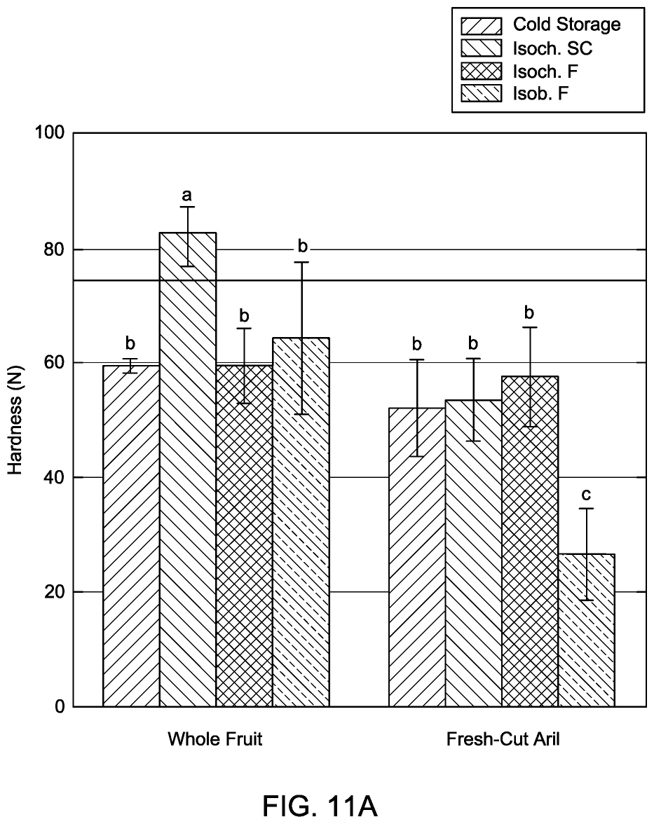

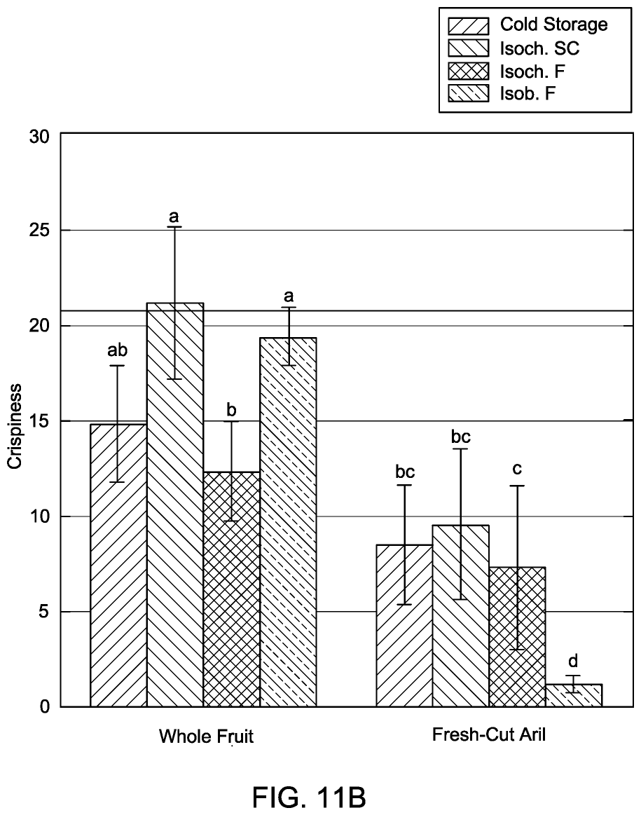

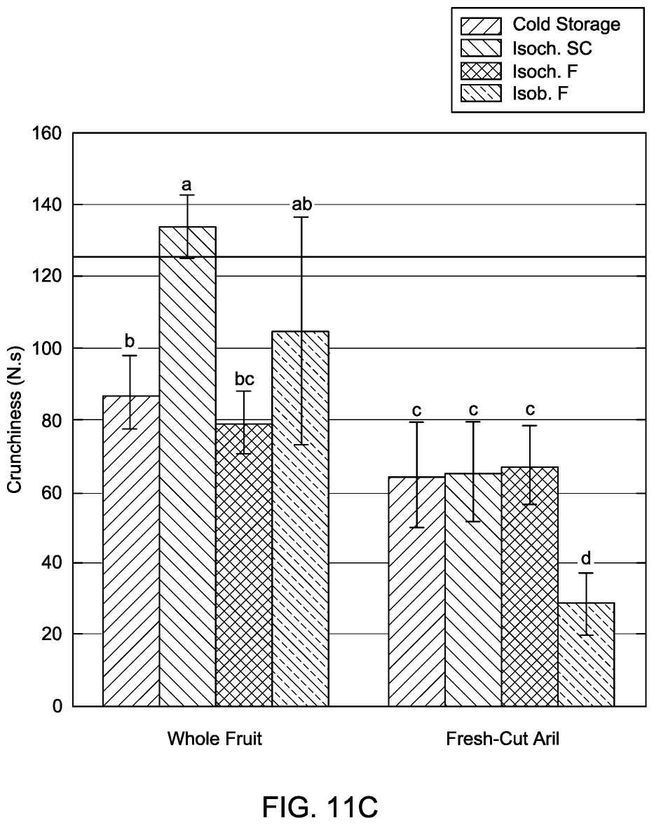

The texture properties of isochoric supercooled arils preserved as whole pomegranates showed no significant differences (P>0.05) with those of fresh arils (FIG. 11). In comparison, cold storage, isochoric freezing and isobaric freezing caused a decrease in all textural properties. The greatest loss in texture occurred for isochoric frozen arils. These samples lost 22% hardness, 41% crispiness and 37% crunchiness, indicating physiological damage due to pressure. Similarly, cold stored arils lost 22% hardness, 29% crispiness and 30% crunchiness due to ongoing metabolic processes. Partial freezing of isobaric frozen arils caused large variations in texture properties as indicated by large standard deviations. On average, isobaric frozen samples lost 15% hardness, 7% crispiness and 17% crunchiness.

FIG. 11A-C shows that the different postharvest technologies caused a greater texture loss when arils were preserved without their peel. Greater texture losses could be attributed to the absence of the rind, thick spongy albedo and spongy membranes that provide cushioning to the arils inside. Also, an increase in the metabolic activities in response to increased fruit stress might have caused further texture losses. Therefore, cold stored arils lost 32% hardness, 59% crispiness and 49% crunchiness. Also, the large level of microbial infection in cold stored arils (Table 1) might have contributed to texture loss. In addition, isochoric supercooled and isochoric frozen samples experienced similar texture losses. For these two isochoric technologies, aril immersion in the aqueous solution might have contributed to the softening and loss in crispiness and crunchiness. Isobaric freezing caused the greatest texture loss with ice formation during freezing weakening the integrity of the cell membranes and walls. This caused cell lysis and subsequent leakage of water and cellular components, leading to softer arils with loss in cell turgor and consequently, loss in crispiness and crunchiness.

### 3.5. Structural Analysis

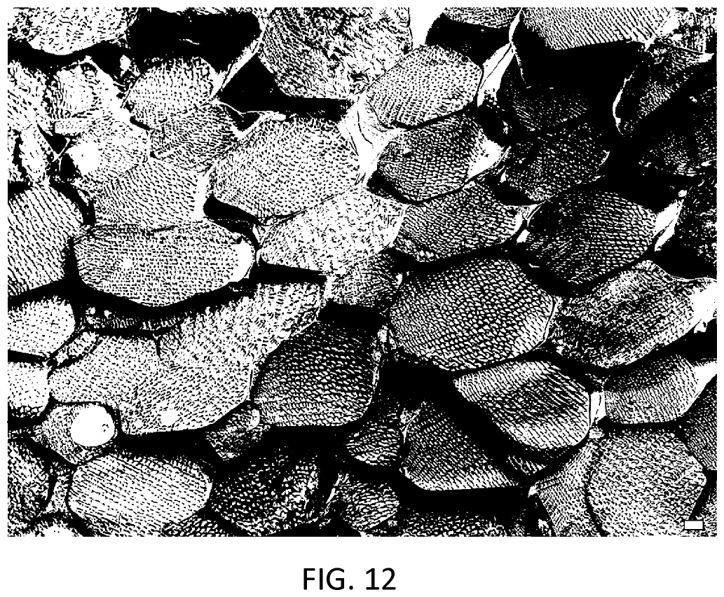

FIG. 12 shows the microstructures of the fresh arils. Cellular tissue of fresh arils showed isodiametric cells with regular shape and well-organized structure. Pomegranate arils are formed by tubular cells joined to the seed by a transition tissue of spherical cells (Castro-Giráldez et al., 2013). The micrographs of the arils preserved as whole fruits were similar to those of the fresh samples, regardless of the postharvest preservation technology (FIG. 13A-D). The cells preserved their integrity with well-defined cell walls and similar cell structures to those shown in fresh tissue cells. The fresh-cut arils, in general, showed more cellular tissue damage. Cold-stored arils had torn cells with irregular shapes due to the loss of turgor (FIG. 13E). Isochoric supercooling better preserved the cellular structure of the arils, with minimal visible changes in the structure of the tissue and clearly differentiated cells (FIG. 13F). In comparison, the micrograph of isochoric frozen arils showed cells with irregular shapes as well as some broken cells (FIG. 13G), indicating that the hydrostatic pressure generated during isochoric freezing caused significant changes in the aril tissue structure. Isobaric frozen arils showed a great degree of cell damage, as indicated by the poor definition of the cell walls (FIG. 13H). The cells were harder to differentiate and appeared irregular in shape. Numerous studies reviewed by van der Sman (2020) had shown that during freezing, ice nucleation and ice crystal growth damaged cell walls and membranes with subsequent loss in cell compartmentation. The decompartmentalization prevented the return of water to the intracellular medium during thawing, causing loss in cell turgidity and the modification of the cellular structure. Also, the water in the intracellular space and the extracellular capillary space is only held by capillary forces, and consequently it can drain easily via gravity, appearing as drip loss after thawing.

### 3.6. Effects of Postharvest Preservation Technology on Anthocyanin Content in Pomegranate Arils

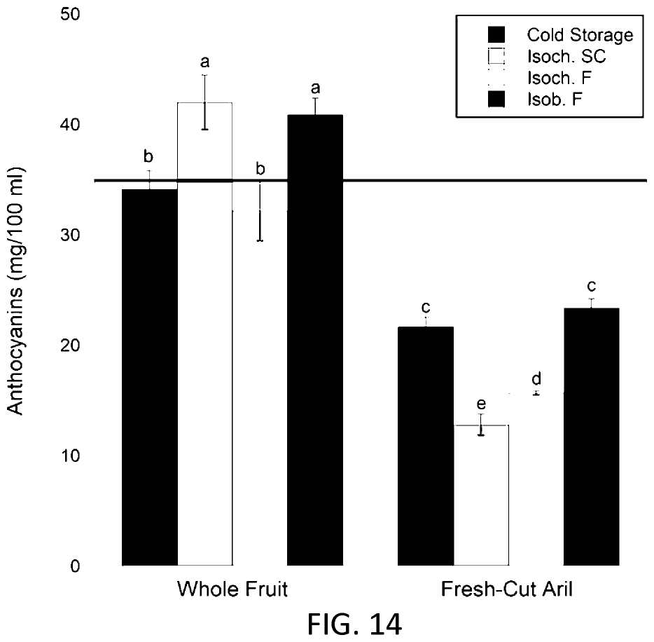

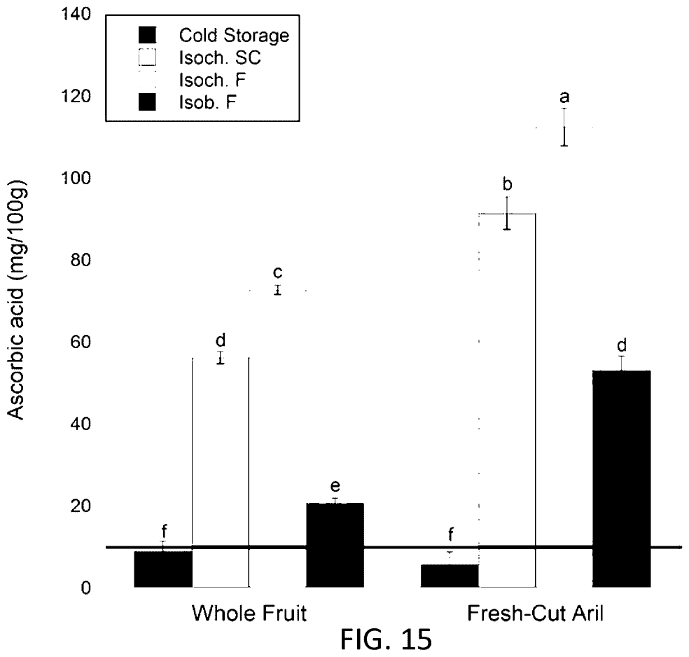

Anthocyanins are polyphenolic compounds responsible for the typical red color in pomegranate fruit peel and arils (Arendse et al., 2014). Anthocyanin content for fresh pomegranate arils was 35.2±2.0 mg/100 mL juice. This value was similar to those reported in previous studies (Ayhan and Eşturk, 2009; Ashtari et al., 2019). FIG. 14 shows the effects of postharvest preservation technology on the anthocyanin contents in arils. Anthocyanins are unstable and susceptible to degradation during processing and storage. Various factors such as storage conditions and exposure to light and air can affect the stability of anthocyanins (Maghoumi et al., 2013b). FIG. 14 shows that the presence of the pomegranate peel might have reduced light exposure and oxygen required for the enzymatic oxidation reaction of anthocyanin. In addition, pomegranate peel has strong antioxidant activity, in fact the antioxidant activity of pomegranate peel is 10 times higher than the antioxidant activity of pomegranate pulp (Li et al., 2006), which could have prevented anthocyanin oxidation in the arils. This protective role was more pronounced in arils preserved using isochoric supercooling and isobaric freezing, which showed 31% and 27% increases in anthocyanin contents, respectively. This increase was due to the continuation of anthocyanin synthesis in harvested fruit, even at low storage temperatures. Cold-stored fruits showed a 6% increase in anthocyanin content. This lower increase in anthocyanin content for cold-stored fruits in comparison with isochoric supercooled or isobaric frozen arils might be related to a decrease in the protective effect of the peel due to peel desiccation (Sudhakar Rao, 2018). Isochoric frozen arils from whole pomegranates showed no significant differences in anthocyanin content when compared with fresh fruits. FIG. 14 also showed that all preservation technologies significantly reduced the total anthocyanin contents in fresh-cut arils. Cold storage caused a 38% decrease in anthocyanin content, which was consistent with previous studies that showed a decrease in anthocyanin contents of pomegranate arils with an increase in storage time (Art\acute{ }es et al., 2000; Caleb et al., 2013b). Anthocyanin degradation may be due to physical stress during the fruit peeling or oxidation process (Ghasemnezhad et al., 2015). The isochoric frozen arils, isochoric supercooled arils and isobaric frozen arils showed decreases in anthocyanin contents of 64%, 55% and 34%, respectively. Besides physical stress, the decrease in the anthocyanin content for these samples might also be due to the presence of ascorbic acid. Previous studies had shown that ascorbic acid accelerated the degradation of anthocyanins and enhanced the formation of polymer pigments, which resulted in anthocyanin pigment bleaching (Poei-Langston and Wrolstad, 1981; Levy et al., 2019). In this study, the extent of anthocyanin loss was correlated (R²=0.61) with ascorbic acid concentrations in the arils (FIG. 15).

### 3.6. Effects of Postharvest Preservation Technology on Ascorbic Acid Content in Pomegranate Arils

Ascorbic acid content for fresh pomegranate arils was 12.68 mg 0.100 g⁻¹ juice. This value was within the range of values reported by Karav et al., (2015) for cv. ‘Wonderful’. Results presented in FIG. 15 showed that ascorbic acid content in whole pomegranate declined during cold storage as previously reported in another study (Lotfi et al., 2022). The residual ascorbic acid content after cold storage was 70% of the initial value. The rest of the treatments showed a marked increase in AA since pomegranate fruits were immersed in S/AA solution and pomegranate peel had numerous minute pores that permitted free movement of solution. The isochoric frozen samples showed the greatest increase in AA content due to an increase in mass transfer in response to elevated pressures. This led to pressure-induced impregnated pomegranates (McHugh et al., 2022). In comparison, the isobaric frozen samples showed the lowest increase in AA content due to freezing of the external solution. This limited the free movement of the solution components through the peel.

FIG. 15 also showed that fresh cut arils in cold storage had lower AA content when compared with arils from whole pomegranate fruit. This was due to increased exposure to oxygen and higher respiration rate of the arils following peeling and extraction. The residual ascorbic acid content of arils after cold storage was 44% of the initial value. In comparison, fresh-peeled arils preserved using the other technologies showed greater AA contents compared with those of whole fruits. The isochoric frozen samples had the highest increase in AA content due to pressure-induced impregnation, followed by isochoric supercooled samples and isobaric frozen samples. The increase in AA content for isochoric supercooled samples could be explained by the migration of AA to the arils through cell membranes as they lose their integrity during storage. For isobaric frozen arils, ice crystals might have damaged the integrity of the cellular compartments. Consequently, the cellular membranes lost their semi-permeability, resulting in mass transfer between the arils and the surrounding S/AA solution.

### 3.8. Effects of Postharvest Preservation Technology on Antioxidant Activity in Pomegranate Arils

DPPH and ABTS·⁺ assays were used to determine the total antioxidant capacity of the arils. The correlation coefficient between the DPPH and ABTS·⁺ assays was 0.90, suggesting they were consistent in total antioxidant activity measurements. The antioxidant activity in fresh pomegranate arils was determined to be 3.96±0.37 mg TE·g⁻¹ from the DPPH assay and 3.94±0.34 mg TE·g⁻¹, from the ABTS·⁺ assay.

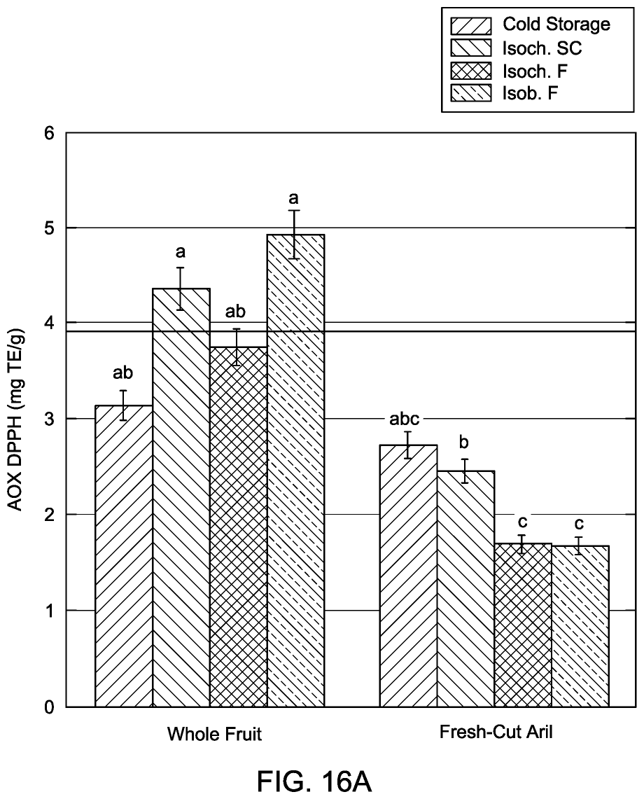

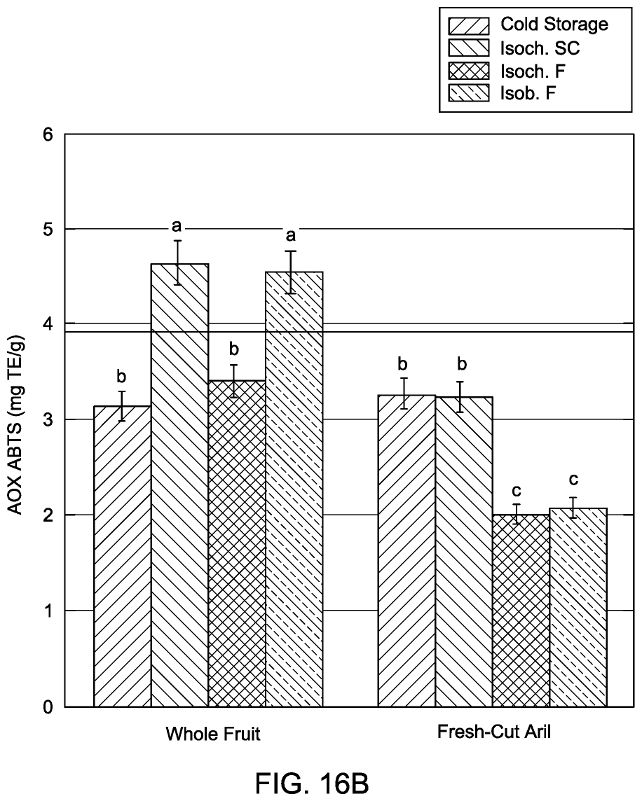

FIG. 16A showed that antioxidant activity of arils from whole pomegranates declined during cold storage. In comparison, antioxidant activity increased for isochoric supercooled and isobaric frozen samples. FIG. 16B also showed that fresh-cut arils had lower antioxidant activity when compared with arils from whole pomegranates, regardless of the postharvest preservation technology. The cold stored and isochoric supercooled arils had the highest antioxidant activities, whereas the isochoric frozen and isobaric frozen arils showed the greatest loss in antioxidant activities. In addition, Karav et al. (2015) found a higher linear correlation between total antioxidant activity and total anthocyanins (r 2=0.94) than between total antioxidant capacity and ascorbic acid content (r 2=0.75) in pomegranate fruits. In this study, a linear correlation was found between total antioxidant activity and total anthocyanins (r 2=0.75), but no correlation was found between antioxidant activity and ascorbic acid content. Thus, other compounds besides anthocyanins were responsible for the antioxidant activity of pomegranate arils. Previous studies had shown that hydrolyzable tannins (punicalagins and punicalins) and phenolic acids (e.g. ellagic acid) were key compounds that contributed to the antioxidant activity of pomegranate fruits (Gil et al., 2000; Calin-Sanchez et al., 2013).

### 4. Conclusions

The important finding in this experiment is that a reduction in temperature, has the expected reduction in bacteria, yeast, and molds growth. As anticipated, the lower the temperature the lower the metabolism and the contaminants growth. The finding that such a small elevation in pressure, as the 12 MPa induced by isochoric freezing, has such a profound effect on reducing the contaminant growth is surprising. In comparison, standard methods for high pressure sterilization employ pressures on the order of 600 MPa.

In previous studies in this field, the use of isochoric freezing above temperatures of −15 °C for reduction of microorganism contaminants was dismissed. In fact, as discussed in the background, previous studies have found no substantial effect on reduction of level of contaminants for short term, hours long, isochoric freezing below −15 °C. Most likely, because in previous studies, the times of application of the isochoric freezing was much shorter than in our studies, because this is the standard in other sterilization techniques. Here we show that: Isochoric freezing temperature, the resultant isochoric freezing pressure and the storage time together play a key role in the outcome of the preservation, with substantially longer times than conventional required at temperatures above −15 °C. It should be emphasized that while the combination of subfreezing temperatures and elevated pressure can be achieved by separately using a device for lowering the temperature and a different device for increasing the pressure, isochoric freezing, provides a convenient way to achieve low temperatures and elevated pressures only by controlling the temperature without the need for mechanical means to elevate the pressure. Furthermore, this finding is the first showing the isochoric freezing can reduce the level of contaminants on solid surfaces.

Isochoric supercooling of whole pomegranates at −2.5 °C maintained aril quality in terms of mass, appearance, color, and texture properties. Isochoric supercooling was also useful in maintaining characteristics that contributed to organoleptic quality, such as TSS, TA and pH. In addition, isochoric supercooling increased ascorbic acid and anthocyanin contents. On the other hand, isochoric freezing at −2.5 °C of whole pomegranates proved to be more beneficial in increasing ascorbic acid content by pressure-induced impregnation, and inhibiting microbial growth while preserving total soluble solids, titratable acidity, pH, color, and anthocyanin content. However, the hydrostatic pressures developed during isochoric freezing adversely affected the texture of the arils.

Isochoric supercooling at −2.5 °C was the most effective preservation technology for fresh-cut arils. Isochoric supercooling minimized microbial growth and better maintained color and texture properties while increasing ascorbic acid content. Cold storage caused visible microbial decay and quality loss in terms of mass, color, texture, and phytochemical contents. Isobaric freezing caused the greatest mass loss, leading to significant deterioration in the arils' color and texture. In comparison, isochoric freezing at −2.5 °C inhibited microbial growth.

### 2. Long Term Preservation of Carrot Juice

### 1. The Purpose of the Example

This example demonstrates that isochoric freezing and isochoric supercooling can be used to reduce microorganism contamination during storage in the interior of a liquid food product. This example was not published but is ready for submission for publication.

Isochoric freezing of unprocessed carrot juice (i.e. raw and that has not undergone sterilization prior to preservation) was preserved at −5 °C/77 MPa and −10 °C/100 MPa for 12 weeks. The juice qualities were compared to those treated and preserved by conventional means, using heat treatment at 95 °C for 15 seconds prior to preservation followed by cold storage at 4 °C. The native population of total aerobic bacteria, yeasts and molds in isochoric frozen juice remained below the detection limit for 12 weeks. In comparison, microbes started to grow in heat-treated juices after 3 weeks of refrigeration. The color of isochoric frozen juice appeared more deep orange than the fresh juice due to an increase in carotenoid extractability. Isochoric freezing was not effective in reducing the activities of peroxidase, polyphenol oxidase and pectin methyl esterase compared with heat treatment. However, the isochoric samples showed higher carotenoid content, polyphenol content and antioxidant capacity compared to the fresh and heat-treated juices. In addition, the isochoric samples retained a comparable viscosity to the fresh juice.

### 2. Materials and Methods

### 2.1. Isochoric System

Two different pressure chambers were used for the isochoric experiments. The juice treated at −10 °C/100 MPa was processed in an OC-9 pressure chamber made of grade 316 stainless steel with a total volume capacity of 500 ml and pressure-rated for up to 275 MPa (High Pressure Equipment Company, Erie, PA, USA). The juice treated at −5 °C/70 MPa was processed in an isochoric chamber made of grade 7075 aluminum with a total volume capacity of 2 liters and pressure-rated for up to 100 MPa (BioChoric Inc., Bozeman, MT). Each chamber was connected to an electronic pressure transducer (Stork Solutions Ltd., Hampshire, 114 UK) to monitor the pressure over time. The chambers were cooled using a chest freezer (Magic Chef Model #HMCF9W3, MC Appliance Corporation, Wood Dale, IL).

### 2.2. Experimental Protocol

Carrot juice was produced from fresh carrots purchased from a local market in Richmond, California. Before processing, carrots were sanitized for 10 min with hypochlorite sodium (100 ppm) solution (Parish et al., 2006). The carrot juice was obtained using a juice extractor (Waring commercial model 6001C Stamford, Connecticut, USA) and aseptically collected in a polyethylene sterile bag.

For the experiments with cold storage at +4 °C, heat treatment (HT) was conducted prior to the storage in a multipurpose sterilization unit (UHT/HTST Lab Microthermics model 25EHVH, Raleigh NC). Carrot juice was preheated to 65 °C and pasteurized at 95 °C for 15 seconds. The carrot juice was aseptically collected in sterilized glass bottles through the drain out line and divided into 18 sterilized polypropylene tubes containing 50 mL of liquid each. The tubes were stored at 4 °C for up to 12 weeks. The samples were tested immediately after the heat treatment to measure their microbiological quality and assess physicochemical changes. The fresh, untreated juice was used as a control sample.

For the isochoric freezing (IF) treatments, the carrot juice was not sterilized prior to isochoric freezing and was used without any pretreatments. Four bags with about 40 ml of carrot juice in each bag were processed for each treatment. The bags were heat-sealed with negligible headspace and immediately processed by placing them inside the isochoric chamber filled with water. The chamber was cooled to preset temperatures of −5 °C and −10 °C inside the chest freezer and maintained for various periods of time in increments of 1 week to 12 weeks. After the treatment, the sample bags were slowly thawed at 5 °C for 14 h.

After HT and IF, carrot juice was filtered through a number 20 sieve with a 0.0331″ (850 μm) nominal sieve opening. This sample was then used for total soluble solids content (TSS), pH, carotenoids content, total phenolic content, and antioxidant capacity measurements.

### 2.3. Microbiological Analyses

Decimal dilutions were prepared for total plate count, yeast, and molds. Appropriate dilutions were plated on agar (PCA; Sigma Aldrich, St Louis, MO, USA) for mesophilic aerobic bacteria and incubated at 30 °C for 48 h. Dilutions were plated on potato dextrose agar for yeast and molds and incubated at 25 °C for 72 h. Each treatment was performed in triplicate and results were expressed as log CFU mL⁻¹.

### 2.4. Total Soluble Solids and pH

The total soluble solids content (expressed as ° Brix) of the filtered juice was determined by measuring the refractive index of the juice with a digital refractometer (Maselli LR-01, Masseli Misure s.p.a., Parma, Italy). The pH of the filtered juice was determined using a pH meter (Hanna instruments, USA). All analyses were performed in triplicate.

### 2.5. Viscosity

Viscosity of carrot juice was measured with a DHR-3 rheometer (TA Instrument, New Castle, DE) using a concentric cylinder geometry (28.04 mm bob diameter and 21.10 mm bob length with 30 mm diameter cup) at 20 °C. Eight mL of carrot juice was pipetted into the concentric cylinder cup and equilibrated at 20 °C for three minutes. The shear rate was varied from 0.1 to 200 s⁻¹. The viscosity of the sample was determined at a shear rate of 100 s⁻¹. Three replicates were performed for each sample.

### 2.6. Color Measurements

The color of the juice samples was measured using a tristimulus colorimeter (CM508D, Konica-Minolta Inc., Ramsey, NJ, USA) with a sample holder (CM-A128) and an 8 mm diameter target mask (CM-A195). Carrot juice (10 mL) was pipetted into the sample holder and each sample was measured three times. Results were expressed as L* (lightness), a* (redness/greenness) and b* (yellowness/blueness) in the CIE Lab system. These values were used to calculate the Chroma (C*) and Hue angle (h*) according to the following equations:

$${C}^{*} = \sqrt{{a}^{* 2} + {b}^{* 2}} \qquad ( 1 )$$

$${h}^{*} = arctan \frac{{b}^{*}}{{a}^{*}} \times \frac{180}{π} ( degrees ) \qquad ( 2 )$$

### 2.7. Determination of Enzymes Activity: Peroxidase (POD), Polyphenoloxidase (PPO) and Pectin Methylesterase (PME)

Polyphenol oxidase (POD) and peroxidase (PPO) activities were measured according to the method of Szczepańska, Barba, Skąpska, & Marszałek, (2020). An extraction solution containing 1M sodium chloride, 4% (w/v) polyvinylpolypyrrolidone (PVPP) and 1% (v/v) triton X-100 was prepared using 0.2 M sodium phosphate (pH of 6.5). Four ml each of the extraction solution and carrot juice were added to a centrifuge tube, vortexed (VWR Vortexer 2) for 1 minute and centrifuged using a Sorvall RC 5C Plus centrifuge (Kendro Laboratory Products, Newtown, CT) for 30 minutes at 11,000 g and 4 °C. The supernatant was then used to determine POD and PPO.

The POD activity was measured using a Shimadzu UV-1280 UV-Vis Spectrophotometer (Shimadzu Scientific Instruments, Inc., Columbia, MD). A 1% solution of p-phenylenediamine (w/v) was prepared in a 0.05 M sodium phosphate solution (pH of 6.5). Also, a 1.5% hydrogen peroxide solution was prepared. Then, 3 mL of 0.05 M sodium phosphate, 50 μL of the 1% p-phenylenediamine solution and 50 μL of the 1.5% hydrogen peroxide solution was added to a cuvette and zeroed as the background on the spectrophotometer. The supernatant (50 μL) from the extraction was added to the cuvette and measurements were taken immediately in the kinetic mode at 485 nm. For the blank sample, 50 μL of the 0.05 M sodium phosphate buffer was used instead of the supernatant.

The PPO activity was measured using a Shimadzu UV-1280 UV-Vis Spectrophotometer. Catechol (+99%, Agros Organics) was used as the substrate and was prepared as a 0.07 M solution using 0.05 M sodium phosphate. The substrate (3 mL) was added to a cuvette and zeroed as the background on the spectrophotometer. The juice supernatant (300 μL) was added to the cuvette and measurements were taken immediately in the kinetic mode at 420 nm. For the blank sample, 300 μL of the 0.05 M sodium phosphate buffer was used instead of the supernatant.

Pectin methylesterase activity was measured according to the method of Yeom, Zhang, & Chism (2002). A 1% citrus pectin and sodium chloride solution were prepared one day in advance. Carrot juice (5 mL) was added to 20 mL of the 1% pectin-salt solution, homogenized at 15,000 rpm for 30 seconds and then incubated in a 30 °C water bath for 30 minutes. The solution was adjusted to a pH of 7.0 with 2 N NaOH under continuous stirring. After this, 50 μL of 0.05 N NaOH was added to the sample. Under continuous stirring, the time was measured until the solution reached a pH of 7.7. Activity was calculated using the following equation:

$$Pectin Methylesterase Units = \frac{( 0.05 N NaOH ) ( 0.05 mL of NaOH )}{( 5 mL of sample ) ( Time in min )} \qquad ( 3 )$$

The relative activity (RA) for all analyzed enzymes was calculated according to:

$$R A ( \% ) = \frac{A}{{A}_{0}} \times 100 \qquad ( 4 )$$

where A was the activity of the treated juice and A₀ was the activity of the fresh juice.

### 2.8. Total Carotenoid Content

Total carotenoids were determined by the method of Knockaert, Lemmens, Van Buggenhout, Hendrickx, & Van Loey, (2012) with slight modifications. Carrot juice (25 ml) was mixed with 80 mL of an extraction solution (50% hexane, 25% acetone, 25% ethanol and 0.1% BHT) in a separation funnel. The mixture was shaken and held for 10 min. After separation, the organic phase containing the carotenoids was separated from the water phase. The aqueous phase was extracted two more times using 15 mL of the extraction solution. Total carotenoids were determined at 450 nm using a Shimadzu UV-1280 UV-Vis Spectrophotometer.

The total carotenoid concentration was determined by using:

$$Total Carotenoids Content ( microg {g}^{- 1} ) = \frac{{A}_{450} \cdot {V}_{organic extract ( ml )} \cdot {10}^{4}}{E * {Mass}_{sample}} \qquad ( 5 )$$

where A₄₅₀ was the absorbance at 450 nm, V_{organic extract} was the total volume of extract and E was the extinction coefficient (2560 for β-carotene in hexane). Analyses were performed in triplicate.

### 2.9. Total Soluble Polyphenolic (TSP) Content and Antioxidant Activity

Total soluble phenolic content was determined by using the Folin-Ciocalteu assay as described by Singleton and Rossi (1965). Absorbance readings at 725 nm were taken using a Shimadzu PharmaSpec UV-1700 spectrophotometer. A blank prepared with methanol was used as control. The total amount of phenols was determined using a gallic acid standard curve and results were expressed as μg of gallic acid equivalent (GAE) per ml of juice. Three replicates were performed for each sample.

The DPPH scavenging activity was evaluated according to Brand-Williams, Cuvelier, & Berset, (1995). The absorbance was measured at 517 nm using a Shimadzu PharmaSpec UV-1700 spectrophotometer. The antioxidant activity was determined by plotting a Trolox calibration curve and the results were expressed as μM of trolox equivalent (TE). Three replicates were performed for each sample.

### 2.10. Statistical Analysis

The results were analyzed using Minitab version 19 statistical software (Minitab Inc., State Collage, PA, USA). Significant differences between different treatments were assessed by performing analysis of variance (ANOVA) and interval plots at 95% confidence intervals.

### 3. Result and Discussion

### 3.1. Microbiological Evaluation

Table 4 shows the effects of heat and isochoric freezing (IF) treatments on the inactivation of microorganisms in carrot juice. Initial total plate counts (TPC) and yeast and molds (Y&M) of freshly squeezed carrot juice were 4.3 and 4.1 log CFU mL⁻¹, respectively. These values were consistent with a previous study (Gouma, Álvarez, Condón, & Gayán, 2020). TPC and Y&M both decreased to 2.9 log CFU mL⁻¹ when carrot juice was extracted from carrots sanitized with 200 μL L⁻¹ sodium hypochlorite. Total microbial inactivation was achieved by the heat treatment at 95 °C for 15 seconds, which indicated sufficient pasteurization. However, The TPC and Y&M count of heat-treated carrot juice exceeded the limit of detection (1 log CFU mL⁻¹) after 3 weeks and continued to increase during the rest of the storage time. The TPC eventually reached 4.9 log CFU mL⁻¹ and the Y&M count reached 4.4 log CFU mL⁻¹ at the end of 12 weeks.

In comparison, IF reduced the microbial load of fresh carrot juice below the limit of detection and remained below this limit for the rest of the storage time. Pressures are commonly used for food preservation. Dede et al. (2007) found that HPP (250 MPa, 35 °C for 15 min) reduced the microbial load of carrot juice to undetectable levels with no microbial growth observed throughout the storage period of 30 days at 4 °C. Similarly, Patterson, McKay, Connolly, and Linton (2012) found that HPP (500 MPa or 600 MPa, 20 °C for 1 min) reduced the total viable counts in carrot juice from 5.8 log CFU mL⁻¹ to 1.7 log CFU mL⁻¹. When the juice was stored at 4 °C, little growth occurred over the 22 days storage period. These authors also reported that using a storage temperature of 12 °C led to a significant increase in the total microbial counts to 10⁷ CFU mL⁻¹ by day 10. The study in this example revealed that total inactivation from a native concentration of microorganisms could also be achieved at lower pressures (77 MPa) if the juice was stored by isochoric freezing under low temperature and pressure conditions. This effect occurs at much higher isochoric freezing temperatures than those in the published literature reference earlier in this example. The main reason is because the previous studies did not examine the effect over sufficiently long periods of time.

TABLE 4
Effects of heat treatment (HT) and isochoric freezing (IF) on total
plate count (TPC) and yeast and molds (Y&M) in carrot juice.

| | | TPC | Y&M |
|---|---|---|---|
| Treatment | Time | (log CFU ml⁻¹) | (log CFU ml⁻¹) |
| HT 95 °C/15 s + | 1 week | <1.00 | <1.00 |
| cold storage 4 °C | 2 weeks | <1.00 | <1.00 |
| | 3 weeks | 2.0 ± 1.3 | 1.3 ± 1.7 |
| | 4 weeks | 1.5 ± 2.6 | 1.5 ± 2.6 |
| | 8 weeks | 1.5 ± 2.7 | <1.00 |
| | 12 weeks | 4.9 ± 0.6 | 4.4 ± 1.7 |
| IF −5 °C/77 MPa | 1 week | <1.00 | <1.00 |
| | 2 weeks | <1.00 | <1.00 |
| | 3 weeks | <1.00 | <1.00 |
| | 4 weeks | <1.00 | <1.00 |
| | 8 weeks | <1.00 | <1.00 |
| | 12 weeks | <1.00 | <1.00 |
| IF −10 °C/100 | 1 week | <1.00 | <1.00 |
| MPa | 2 weeks | <1.00 | <1.00 |
| | 3 weeks | <1.00 | <1.00 |
| | 4 weeks | 2.3 ± 0.6 | 2.1 ± 1.0 |
| | 8 weeks | <1.00 | <1.00 |
| | 12 weeks | <1.00 | <1.00 |

### 3.2. pH, Total Soluble Solid (TSS) and Viscosity

The pH, TSS and viscosity of the carrot juices are shown in Table 5. The pH of fresh juice was 6.37±0.08. Heat treatment led to a slight increase in pH value to 6.61±0.11 and the pH did not significantly change in value throughout storage. Negri et al. (2021) obtained similar results and observed a slight increase in the pH value of thermally treated carrot juice. The IF treated carrot juices generally had slightly higher pH values than that of the fresh juice. This might be due to the cell damage from pressure that led to diffusion of cell components to the medium.

The total soluble solids content (° Brix) of the fresh sample was 10.3±0.7° Brix. The ° Brix value for the heat treated juice was close to the fresh sample (p>0.05). In comparison, the TSS for the IF −5 °C and IF −10 °C samples increased almost 1° Brix after one week. This value then remained constant until the 12^{th} week. At this point, the TSS decreased to 10.1° Brix for IF −5 °C and 10.4° Brix for IF −10 °C.

The viscosity of fresh carrot juice was 2.12±0.04 mPa·s at a shear rate of 100 s⁻¹, which was slightly higher than the values reported by other authors (Reiter, Stuparić, Neidhart, & Carle, 2003; Xiang et al., 2013; Gouma et al., 2020). Heat treated samples had slightly, but not significantly higher viscosity values (2.19 mPa·s) for the first 4 weeks. However, the viscosity significantly increased in value during the 8^{th} week and reached 2.62 mPa·s after the 12th week. This might have been due to microbial growth. Several studies had previously shown that thermal treatment increased carrot juice viscosity, which was attributed to the solubilization of pectin and cellulose from cell walls and particle flocculation (Chen, Zhao, Yang, & Zhang, 2012; Liu, Li, Wang, Bi, & Liao, 2014; Vandresen, Quadri, de Souza, & Hotza, 2009). In comparison, the IF −5 °C sample did not show significant changes in its viscosity during storage. Meanwhile, the IF −10 °C sample had fluctuations in its viscosity values over time. The increase in viscosity might be due to the dispersion of carrot cells and tissues and the diminishing of juice particles subjected to pressure since larger particles might sediment and not contribute to viscosity (Zhang et al., 2016), whereas the decrease in viscosity might be due to incomplete inactivation of PME (Table 6).

TABLE 5
Effects of heat treatment (HT) and isochoric freezing (IF) on the pH,
total soluble solids and viscosity of carrot juice.

| | Storage | | | Viscosity |
|---|---|---|---|---|
| Treatment | time | pH | TSS (°Brix) | (mPa·s⁻¹) |
| Fresh | | 6.37 ± 0.08 ^{b} | 10.29 ± 0.66 ^{b} | 2.12 ± 0.04 ^{b} |
| HT 95 °C/ | 1 week | 6.54 ± 0.06 ^{ab} | 10.38 ± 0.16 ^{b} | 2.19 ± 0.01 ^{b} |
| 15 s + cold | 2 weeks | 6.52 ± 0.08 ^{ab} | 10.00 ± 0.07 ^{b} | 2.19 ± 0.01 ^{b} |
| storage 4 °C | 3 weeks | 6.58 ± 0.09 ^{ab} | 10.53 ± 0.53 ^{b} | 2.19 ± 0.01 ^{b} |
| | 4 weeks | | 10.42 ± 0.18 ^{b} | 2.20 ± 0.01 ^{b} |
| | 8 weeks | 6.58 ± 0.05 ^{ab} | 10.25 ± 0.07 ^{b} | 2.46 ± 0.10 ª |
| | 12 weeks | 6.39 ± 0.09 ^{b} | 10.35 ± 0.07 ^{b} | 2.59 ± 0.20 ª |
| | | 6.35 ± 0.07 ^{b} | | |
| IF −5 °C/77 | 1 week | 6.45 ± 0.06 ^{b} | 11.16 ± 0.28 ^{ab} | 2.27 ± 0.11 ^{ab} |
| MPa | 2 weeks | 6.53 ± 0.04 ^{ab} | 11.68 ± 0.30 ª | 2.24 ± 0.12 ^{ab} |
| | 3 weeks | 6.64 ± 0.10 ^{ab} | 11.14 ± 0.09 ^{ab} | 2.17 ± 0.03 ^{b} |
| | 4 weeks | 6.52 ± 0.02 ^{b} | 11.23 ± 0.31 ^{ab} | 2.09 ± 0.11 ^{b} |
| | 8 weeks | 6.53 ± 0.04 ^{b} | 11.68 ± 0.30 ª | 2.12 ± 0.19 ^{b} |
| | 12 weeks | 6.62 ± 0.10 ^{ab} | 10.08 ± 0.14 ^{b} | 2.10 ± 0.11 ^{b} |
| IF −10 °C/ | 1 week | 6.39 ± 0.02 ^{b} | 11.08 ± 0.13 ^{ab} | 2.05 ± 0.01 ^{b} |
| 100 MPa | 2 weeks | 6.64 ± 0.01 ª | 12.47 ± 0.46 ª | 2.46 ± 0.02 ª |
| | 3 weeks | 6.46 ± 0.03 ^{b} | 11.25 ± 0.23 ^{ab} | 2.06 ± 0.06 ^{b} |
| | 4 weeks | 6.52 ± 0.13 ^{ab} | 11.07 ± 0.15 ^{ab} | 2.10 ± 0.08 ^{b} |
| | 8 weeks | 6.42 ± 0.06 ^{b} | 11.98 ± 0.20 ª | 2.33 ± 0.14 ª |
| | 12 weeks | 6.59 ± 0.05 ª | 10.43 ± 0.12 ^{b} | 2.02 ± 0.02 ^{b} |

Columns in the same group bearing a common letter were insignificantly different at P < 0.05.

### 3.3. Color Attributes

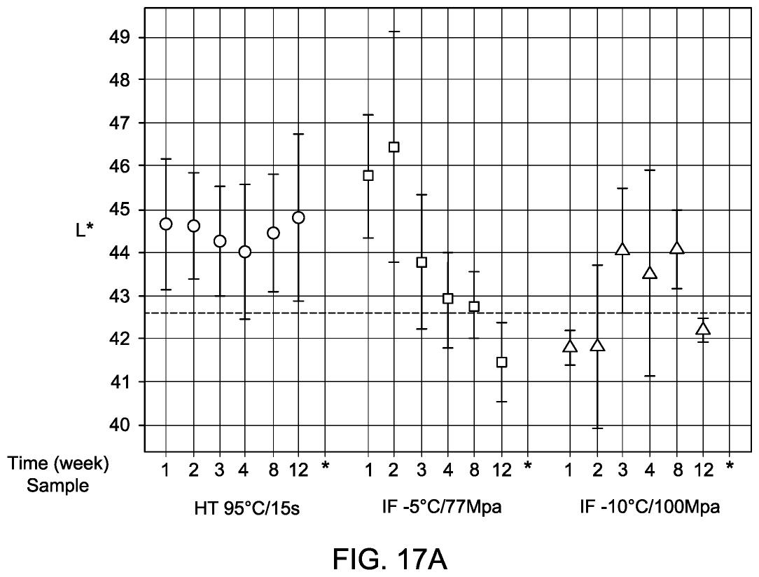

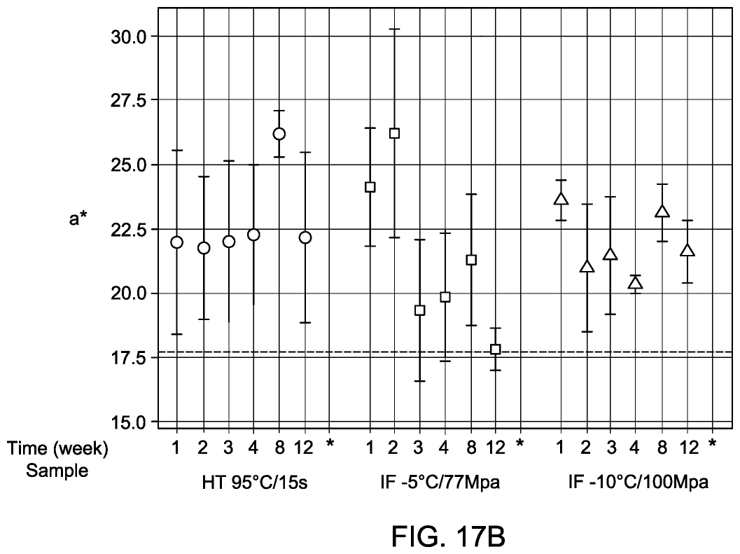

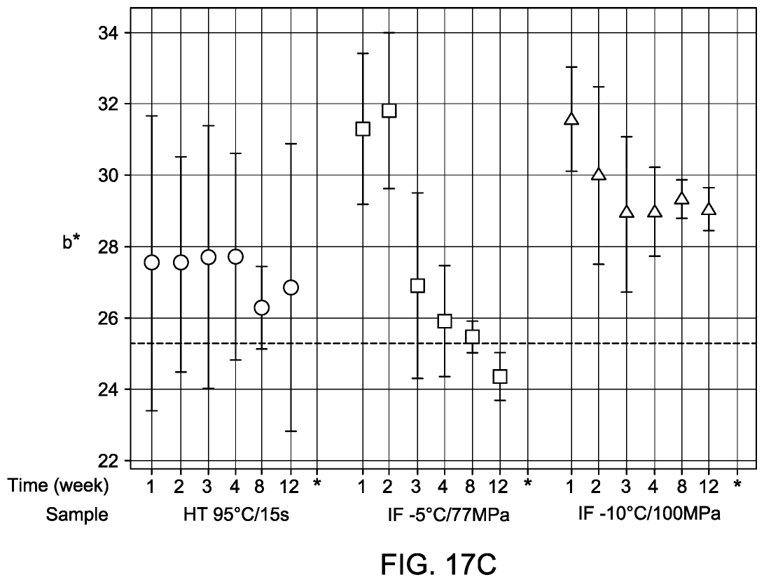

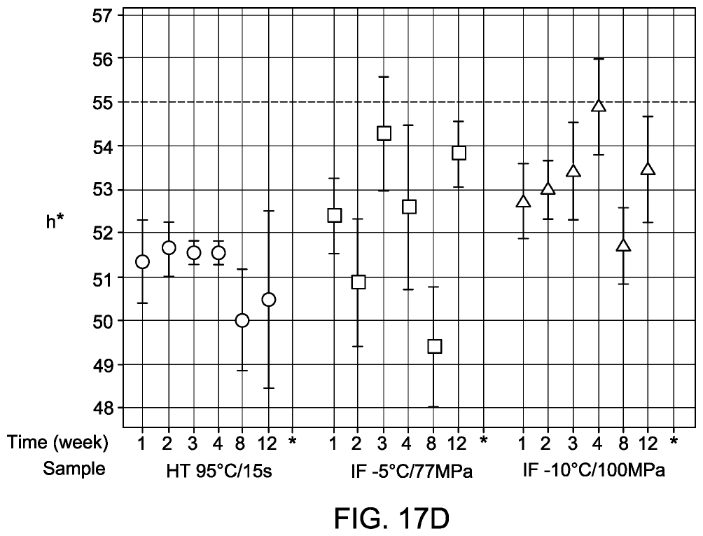

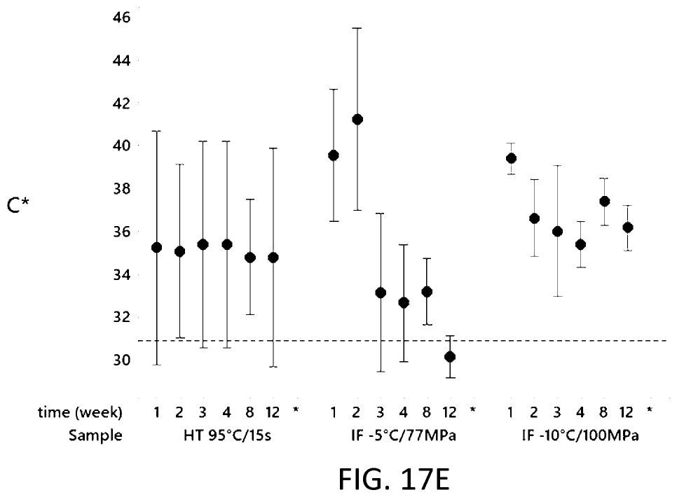

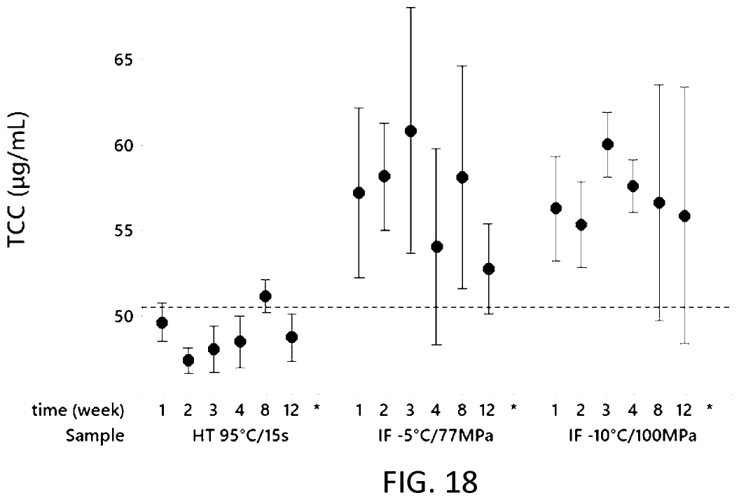

The color attributes of fresh and treated carrot juices are shown in FIG. 17A-17E. The lightness (L*), redness (a*) and yellowness (b*) of fresh carrot juice were 42.5±1.7, 17.8±3.5 and 25.3±3.0, respectively. Thermal treatment led to a slight increase in the L* value by 5% and a significant increase in the a* value by 23%. These results were consistent with those obtained by Patras et al. (2009) and Negri et al. (2021), who found that thermally treated carrot juice showed an increase in a* values but no changes in b* values. The increase in redness had been attributed to the improvement in availability of carotenoids due to breaking of crystalline carotenoid complexes formed with proteins (Nguyen and Schwartz, 1999). However, our heat-treated samples did not show increases in carotenoid contents (FIG. 18). Instead, the increase in redness might be due to non-enzymatic Maillard reactions (Wellner, Huettl, Henle, 2011). Also, the heat-treated juices had relatively constant color values during storage. This might be due to the heat treatment reducing POD and PPO enzyme activities (Table 6), which inhibited browning and improved the color retention of the carrot juice during storage.

Isochoric freezing resulted in samples with higher a* and b* values, indicating more redness and yellowness, respectively. The IF −5 °C sample had greater increases in L, a*, b* values (7%, 26%, and 24%, respectively) than the IF −10 °C sample (3.4%, 18% and 19%, respectively). The hue (h*), which represented the visual color of the juice based on a* and b* values, decreased (p≤0.05) by 5.4% for IF −5 °C and 4.0% for IF −10 °C, indicating red color development. Furthermore, chroma also increased by 28% for both IF samples. These results indicated that IF samples had a deeper orange color, which might be due to the increases in carotenoid contents from better extractability (FIG. 18). The better extractability of nutritional compounds can also lead to better bioaccessibility of these compounds (Briones-Labarca et al., 2011). The IF samples showed a decrease in color attributes during storage, with the IF −10 °C sample showing better color retention than the IF −5 °C sample. In fact, the IF −10 °C sample had a*, b* and C* values that were still significantly greater than those of the fresh carrot juice after 12 weeks of storage. The main reasons for color changes during storage included oxidation, degradation and co-precipitation of carotenoids with larger molecules during cloud loss due to PME activity (Chen et al., 2015). The lower processing temperature for the IF −10 °C sample might have minimized discoloration reactions. The IF −10 °C sample also had greater POD and PPO inactivation than the IF −5 °C sample (Table 6), which minimized browning reactions and darkening of the carrot juice color. Previous studies on HPP of carrot juice under different conditions (Szczepańska et al., 2020; Jabbar et al., 2014) found decreases in all color values (L*, a* and b*), which the authors speculated were due to browning reactions caused by PPO and POD activity.

### 3.4. Enzyme Activity (POD, PPO and PME)

The POD, PPO and PME activities of the heat treated and IF carrot juices are shown in Table 6. Heat treatment inhibited 47% of POD and 38% of PPO activity. After one week in refrigeration, enzyme inhibition reached 92% of POD and 84% of PPO activity. After this point, the heat treated samples showed no significant changes in POD and PPO activity during the rest of the storage period. Heat treatment had previously been shown to inactivate POD and PPO activity. For instance, Negri et al. (2021) found that heat treatment (80 °C/7 min.) of carrot juice reduced PPO activity by 68% and POD activity to undetectable levels. Similarly, Soysal, Söylemez, & Bozoğlu (2004) achieved complete inactivation of carrot POD after heat treatment (75 °C/10 min).

Isochoric freezing was less efficient than heat treatment for the inactivation of POD and PPO in carrot juice. The IF −10 °C sample showed greater POD inactivation (57% on average) than the IF −5 °C sample (24% on average). Also, The IF −10 °C sample showed a decrease in PPO activity (14% on average), whereas the IF −5 °C sample showed an increase in PPO activity (102% on average). In general, processing time did not significantly affect POD or PPO activity. Also, IF led to large variability in POD and PPO residual activities. This large variability might be due to pressure enhancing or inhibiting enzymatic reactions depending on the positive or negative value of the reaction (or activation) volume (Cheftel, 1992). In addition, isochoric freezing might have imparted a pressure-induced enzyme activation due to the release of membrane-bound enzymes, as well as pressure-related inactivation by reversible or irreversible changes in the enzyme conformation (Cheftel, 1992).

Many previous studies had focused on the effects of high pressure on POD and PPO activity. The results were not conclusive, but in general, high pressure did not effectively inhibit enzyme activity. Szczepańska et al. (2020) and Stinco et al. (2019) examined enzyme activity in carrot juice and found that lower pressure led to higher PPO, but lower POD inactivation. The maximum inactivation was 31% for POD and 58% for PPO. Also, Jabbar et al. (2014) reported that POD and PPO activity in carrot juice gradually decreased in value with an increase in pressure, with maximum inactivation of 51% for POD and 55% for PPO.

Heat treatment almost totally inactivated PME activity (>90%), with no further significant changes during refrigerated storage. The IF −5 °C sample showed slightly greater PME inactivation than the IF −10 °C sample. The IF −5 °C sample also showed a gradual decrease in PME activity over time with 12% activity after 8 weeks. After this time, the residual PME activity increased up to 74%. The same trend occurred for the IF −10 °C sample with PME activity falling to 32% after 3 weeks and increasing for longer processing times. Balogh, Smout, Nguyen, Van Loey, & Hendrickx, (2004) found that carrot PME was very stable under pressure and required a combination of very high pressure (800 MPa) and long time (36 min) at 10 °C to reduce PME activity by 90%.

TABLE 6
Effects of heat treatment (HT) and isochoric freezing (IF) on residual
enzymatic activity of carrot juice.

| | Storage | | | |
|---|---|---|---|---|
| Treatment | time | POD RA (%) | PPO RA (%) | PME RA (%) |
| HT 95 °C/ | 1 week | 7.6 ± 13.1 ^{b} | 16.1 ± 8.8 ^{c} | 6.5 ± 2.5 ^{c} |
| 15 s + cold | 2 weeks | 13.1 ± 4.7 ^{b} | 23.6 ± 2.6 ^{c} | 9.5 ± 6.3 ^{bc} |
| storage | 3 weeks | 4.8 ± 4.2 ^{b} | 20.1 ± 6.7 ^{c} | 2.7 ± 3.8 ^{c} |
| 4 °C | 4 weeks | 13.4 ± 9.7 ^{b} | 26.1 ± 3.0 ^{c} | — |
| | 8 weeks | 19.5 ± 9.5 ^{b} | 30.3 ± 2.6 ^{c} | 4.6 ± 0.3 ^{c} |
| | 12 weeks | undetected | 27.4 ± 0.4 ^{c} | 11.4 ± 3.3 ^{bc} |
| IF −5 °C/ | 1 week | 43.3 ± 26.4 ^{ab} | 104.4 ± 15.7 ^{ab} | — |
| 77 MPa | 2 weeks | 91.1 ± 27.3 ª | 51.6 ± 16.9 ^{b} | 62.6 ± 3.1 ª |
| | 3 weeks | 70.4 ± 41.6 ^{ab} | 107.1 ± 9.4 ^{b} | 47.2 ± 28.5 ^{ab} |
| | 4 weeks | 74.8 ± 18.1 ^{ab} | 159.0 ± 13.1 ª | 14.7 ± 6.1 ^{b} |
| | 8 weeks | 88.0 ± 6.6 ª | 92.9 ± 19.5 ^{ab} | 12.0 ± 20.0 ^{b} |
| | 12 weeks | 89.5 ± 27.5 ^{ab} | 95.9 ± 11.7 ^{b} | 74.1 ± 15.0 ^{a} |
| IF −10 °C/ | 1 week | 34.7 ± 10.9 ^{b} | 79.2 ± 17.3 ^{b} | — |
| 100 MPa | 2 weeks | 77.0 ± 39.8 ^{ab} | 107.2 ± 14.9 ^{ab} | 61.9 ± 8.9 ^{ab} |
| | 3 weeks | 36.2 ± 37.2 ^{ab} | 86.2 ± 4.8 ^{b} | 32.9 ± 13.1 ^{b} |
| | 4 weeks | 44.4 ± 25.7 ^{ab} | 90.5 ± 13.3 ^{b} | 38.0 ± 1.1 ^{b} |
| | 8 weeks | 18.6 ± 10.8 ^{b} | 70.0 ± 18.7 ^{b} | 71.1 ± 4.0 ª |
| | 12 weeks | 48.3 ± 26.4 ^{ab} | 82.1 ± 11.1 ^{b} | 125.0 ± 26.0 ª |

Columns in the same group bearing a common letter were insignificantly different at P < 0.05.

### 3.5. Total Carotenoids

The effects of thermal and IF treatment on total carotenoid content of carrot juice are shown in FIG. 18. The total carotenoid content of fresh carrot juice was 50.6±4.5 μg/mL, which was in the range (30-300 μg/mL) specified by the Code of Practice of the European Fruit Juice Association—AIJN (Anonymous, 2015). The heat-treated samples had total carotenoid contents that were not significantly different than that for fresh carrot juice. Negri et al. (2021) also found that heat treatment of carrot juice (80 °C/7 min) did not significantly affect its carotenoid content. In addition, heat treated samples did not show significant changes in total carotenoid contents throughout the refrigerated storage. In comparison, the IF treated samples showed significant increases (p<0.05) in total carotenoid contents (FIG. 18). The total carotenoid contents for both samples increased about 12% after one week. The highest contents occurred after 3 weeks, with 20% increases in contents. These increases might be due to better extraction of the carotenoids from juice tissue due to disintegration of chromoplasts under high pressure (Patras et al., 2009). Our results were consistent with previous studies that also found increases in total carotenoids in carrot juice following high pressure treatments (Pokhrel et al., 2019; Patras et al., 2009; De Ancos, Ibanez, Reglero, & Cano, 2000). After three weeks, the carotenoid contents gradually decreased in value during the rest of the storage time. This might be due to an increased vulnerability to oxidative degradation of the released carotenoids. However, the IF −5 °C and IF −10 °C samples still showed 4% and 10% higher carotenoid contents, respectively, than fresh carrot juice after 12 weeks of storage. Szczepańska, Skąpska, Lorenzo, & Marszałek (2021) also reported a significant 5-7% increase in carotenoid content in carrot juice subjected to high pressure (300 MPa-600 MPa). However, they reported 37-58% decreases in carotenoid contents after 12 weeks of storage at 4 °C.

### 3.6. Total Soluble Phenolic Content (TSP) and Antioxidant Capacity

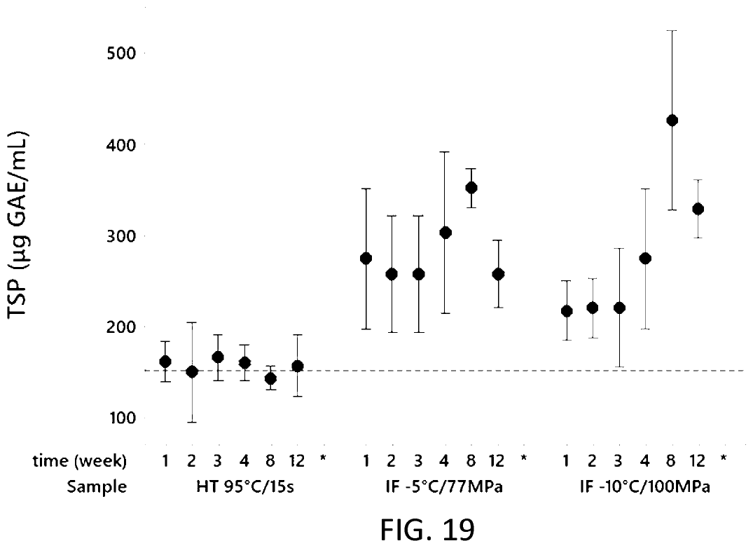

The TSP content of fresh carrot juice was determined to be 152±47 μg GAE/ml. This value was consistent with that reported by Szczepańska et al. (2021). Heat treatment did not affect TSP contents in carrot juice and subsequent storage at 4 °C (FIG. 19). In a previous study, Zhang et al. (2016) found a decrease in total phenols in carrot juice after heat treatment at 110 °C for 8.6 seconds. This indicated that the lower temperature (95 °C) and longer time (15 seconds) treatment used in this study better preserved phenolic contents in carrot juice.

Phenolic contents of all IF treated samples were significantly higher than thermally processed samples (FIG. 19). TSP contents of the IF samples increased significantly during storage, with the contents reaching a maximum value after 8 weeks. At this point, the IF −5 °C and IF −10 °C samples had TSP contents that were 132% and 181% greater than that of the fresh sample, respectively. This behavior was previously observed after high-pressure treatment of carrot juice (Szczepańska et al., 2021; Jabbar et al., 2014) and carrot purée (Patras et al., 2009). From FIG. 19, the IF −5 °C sample showed a 70% increase in TSP content compared to the fresh sample after 12 weeks and the IF −10 °C sample showed a 117% increase. These values were higher than the 26% increase reported by Szczepańska ct al. (2021) for HHP treated carrot juice stored at 4 °C for 12 weeks. Other authors had even reported a decrease in TSP during storage. For instance, Zhang et al. (2016) reported that carrot juice treated with HPP at 550 MPa led to 36% degradation in TSP content after 20 days of refrigerated storage. The increase in total phenolic contents in IF samples might be due to an increase in extractability of bonded phenols in tissue due to cell disruption from pressure as well as possible formation of new polyphenols. Szczepańska et al. (2020) detected the formation of new polyphenols such as oleuropein, 4-vinylsyringol, isocoumarin and 4-hydroxybenzaldehyde in carrot juice after high pressure treatment.

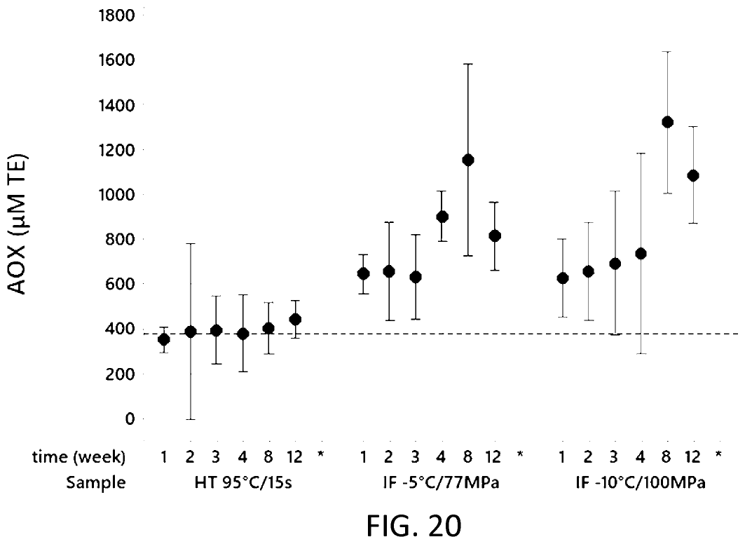

The antioxidant capacity of the heat and IF treated samples followed the same trend as TSP content. The antioxidant capacity of fresh carrot juice was 377±56 μM. Heat treatment did not affect the antioxidant capacity of the juice, whereas IF treatment led to higher total antioxidant capacity during storage (FIG. 20). The IF samples showed a maximum increase in antioxidant capacity after 8 weeks, with the IF −5 °C sample showing a 206% increase compared to the fresh sample and the IF −10 °C sample showing a 214% increase. After 12 weeks, the IF −5 °C sample still showed a 117% increase compared to the fresh sample and the IF −10 °C sample showed a 165% increase. These increases in antioxidant capacity had been related to an increase in extractability of antioxidant components due to pressure treatment. For instance, Oey, Loey, and Hendrick (2004) reported a maximum increase of 33.3% in antioxidant capacity for carrot puree subjected to 600 MPa. Szczepańska et al. (2021) also reported a 49% increase in the antioxidant capacity of pressurized carrot juice at 600 MPa. These authors also found that the increase in antioxidant capacity dropped to 24% after 12 weeks.

Generally, antioxidant capacity could be related to the antioxidant vitamins, carotenoids and polyphenol contents of fruits and vegetable products. In this study, a positive correlation (r²=0.925) was found between total phenolic compounds and antioxidant capacity.

### 4. Conclusion

This research showed the suitability of isochoric freezing for preserving the quality of carrot juice and maintaining its microbiological stability for 12 weeks. Isochoric freezing at −5 °C/77 MPa and −10 °C/100 MPa showed insufficient inactivation of peroxidase, polyphenol oxidase and pectin methyl esterase activity in carrot juice compared to heat treatment (95 °C/15 s). However, isochoric frozen juice had a higher total carotenoid content, total soluble phenolic content, and total antioxidant capacity than the fresh and heat-treated juices after 12 weeks. This was due to processing at subfreezing temperatures that prevented the fast degradation of bioactive compounds. In addition, isochoric freezing enhanced the orange color of the juice due to better extractability of coloring pigments as well as preserved the viscosity of the juice.

### 3. Isochoric Freezing for the Preservation of Milk

### 1. Introduction

The goal of this example was to examine the effect of isochoric freezing on storage of raw milk, as a means to extend the period of time in which the raw milk could be preserved.

### 2.1. Isochoric System

Isochoric freezing at −5 °C/77 MPa and −10 °C/100 MPa was used to preserve raw milk for two weeks. The raw milk was treated using a pressure chamber made of Aluminum-7075 with Type-II anodize coating and with a total volume capacity of 1500 ml and pressure-rated for up to 275 MPa (Biochoric LLC, Bozeman, MT, USA). The chamber was connected to a pressure gauge to monitor the pressure over time. The chambers were cooled using a chest freezer (Magic Chef Model #HMCF9W3, MC Appliance Corporation, Wood Dale, IL).

### 2.2. Experimental Protocol

Raw milk was purchased from a local market located in Albany, California. The quality of the purchased raw milk was tested seven days before expiration (time=0), these tests include microbiological activity and physiochemical properties. On the same day, samples of the milk are prepared for isochoric freezing (IF) treatment.

For the IF treatments, three samples of about 150 ml raw milk each, were stored in sterilized bags with no air bubbles. Bags were heat sealed and transferred to an isochoric chamber filled with cold water. The cold water helps lower the chances of bacteria growth as the chambers begin to cool. The chamber is placed in a chest freezer that was set to −5 °C for 14 days. After the treatment, the chamber is then placed at a temperature of 5 °C for 14 h to melt all the ice within the chamber.

After IF, the samples of bags are retested for both microbiological activity and the change in physiochemical properties. Raw milk stored in 4 °C refrigerator (control) was also tested 14 days after its expiration. These tests are explained in more detail below.

### 2.3. Microbiology

Decimal dilutions were prepared for total plate count and Pseudomonas. Appropriate dilutions were plated on plate count agar (PCA) for total aerobic mesophiles (TAM) and incubated at 30 °C for 3 days (ISO 4833:2013).

Numbers of Pseudomonas spp. were determined by spread plating appropriate dilutions on Pseudomonas agar base with CFC supplement (Oxoid Ltd., Basingstoke, Hampshire, U.K.) and incubated for 72 h at 25 °C.

2.4. pH/Titration

The pH of the raw milk was determined in triplicate using a pH meter (Hanna instruments, USA).

The titratable acidity (TA) of the raw milk samples was determined by titrating 10 mL of diluted raw milk (4 mL of milk in 6 mL of DI water) to pH 8.4 with sodium hydroxide 0.01 M solution. The results were expressed as grams of lactic acid per liter of milk based on equation.

$$T A = \frac{N NaOH \times ml NaOH \times 90.08}{ml of sample} \qquad ( 1 )$$

### 2.5. Color

The color of the raw milk was measured using a tristimulus colorimeter (CM508D, Konica-Minolta Inc., Ramsey, NJ, USA) with a sample holder (CM-A128) and an 8 mm diameter target mask (CM-A195). Milk samples (10 mL) was pipetted into the sample holder covered with the black background and each sample was measured three times. Results were expressed as L* (lightness), a* (redness/greenness) and b* (yellowness/blueness) in the CIE Lab system. These values were used to calculate the percent difference and overall color difference with respect to the fresh raw milk (ΔE*) according to the following equations:

$$Δ {L}^{*} \% = \frac{{L}^{*} - {L}_{o}^{*}}{{L}_{o}^{*}} * 100 \% \qquad ( 2 )$$

$$Δ a \% = \frac{{a}^{*} - {a}_{o}^{*}}{{a}_{o}^{*}} * 100 \% \qquad ( 3 )$$

$$Δ b \% = \frac{{b}^{*} - {b}_{o}^{*}}{{b}_{o}^{*}} * 100 \% \qquad ( 4 )$$

$$Δ {E}^{*} \% = \sqrt{{( Δ {L}^{*} \% )}^{2} + {( Δ {a}^{*} \% )}^{2} + {( Δ {b}^{*} \% )}^{2}} \qquad ( 5 )$$

With

$${L}_{o}^{*} , {a}_{o}^{*} , and {b}_{o}^{*}$$

representing the respective parameter at the value of fresh raw milk (day 0)).

### 2.6. Viscosity

Milk viscosity measurements were performed on a DHR-3 rheometer (TA Instrument, New Castle, DE) at 20 °C. A concentric cylinder geometry (28.04 mm bob diameter and 21.10 mm bob length) was used for testing. Three replicates were performed on each sample. For each replicate, 8 mL of raw milk was pipetted into the concentric cylinder cup and equilibrated at 20 °C for three minutes. The shear rate shear rate was increased logarithmically from 0.1 to 200 s⁻¹. The viscosity of the sample was determined at a shear rate of 100 s⁻¹.

### 2.7. Lactoperoxidase Activity

The lactoperoxidase (LPO) activity assay was performed based on the method described by Marin et al., 2006. Briefly, raw milk was mixed with a solution of 0.65 mM ABTS (in 0.1 M sodium phosphate buffer, pH 6.0) and left for 30 min at 20 °C, and then 0.1 mM hydrogen peroxide was added and mixed quickly to initiate the reaction, with the absorbance (Abs₄₁₂ₙₘ) measured for 1 min. The enzymatic activity was calculated as the slope of the curve relating Abs increment versus time and expressed as ΔAbs₄₁₂ₙₘ AU/min.

All enzymatic assays were performed in triplicates for each storage condition, with the residual activity calculated by

$$Residual activity ( \% ) = \frac{A}{{A}_{o}} * 100 \% \qquad ( 6 )$$

where A is the enzymatic activity in raw milk samples after storage and A₀ is the enzymatic activity of the sample at time 0.

### 3. Result and Conclusion

### 3.1. Microbiological Evaluation

Table 7 shows the effects of isochoric freezing (IF) treatments on the inactivation of microorganisms in raw milk. Initial total plate counts (TPC) and Pseudomonas spp. (PS) of raw milk were 6.2 and 6.4 log CFU mL⁻¹, respectively. Growth resumed in untreated milk with TPC and PS both increased to 7.9 log CFU mL⁻¹ and 7.3 log CFU mL⁻¹ after 14 days of storage. Both initial values and refrigerated values were consistent with a previous study (Alexandros Ch. Stratakos, Elena S. Inguglia, Mark Linton, 2019).

In comparison, IF reduced the microbial load in raw milk. For −5 °C/70 MPa treatment, TPC and PS were reduced to 3.7 and to 4.7 log CFU/ml, respectively. This corresponds to a percentage reduction of 99.68% for TPC and 98% for PS. For −10 °C/100 MPa treatment, TPC and PS reduction was even greater at 1.5 and 1.8 log CFU/ml, respectively. Corresponding to a percentage reduction of 99.998% and 99.99% for TPC and PS, respectively. Our study shows that IF treatment reduces the microbial load in raw milk when compared to RF (refrigeration) and could lead to a longer shelf life.

TABLE 7
Comparison of changes (log CFU/ml) in total plate count (TPC),
and Pseudomonas spp. (PS) of refrigerated vs isochoric
freezing (IF) raw milk.

| | | TPC | PS |
|---|---|---|---|
| Treatment | Time | (log CFU/ml) | (log CFU/ml) |
| Raw milk (initial) | 0 | 6.2 | 6.4 |
| Raw milk (4 °C) | 2 weeks | 7.9 | 7.3 |
| IF −5 °C/77 MPa | 2 weeks | 3.7 | 4.7 |
| IF −10 °C/100 MPa | 2 weeks | 1.5 | 1.6 |

3.2. pH/Titration

The pH and titration of the different batches of raw milk are shown in Table 8. The average pH of fresh (time=0) raw milk was 6.74±0.03. IF treated raw milk for both −5 °C/70 MPa and −10 °C/100 MPa had a slight increase in pH value to 6.79±0.03. Kim et. al (2008) obtained similar results where high pressure (200 MPa) and low temperature (−4 °C) treatments on raw milk for a duration 10, 20, and 30 min did not have significant effects on the pH levels in the milk samples. As for RF, average pH was 6.75±0.02. Lactic acid bacteria (LAB) convert lactose sugar into lactic acid and are responsible for lowering the pH of milk as it spoils. A possible explanation for the slight increase in pH in IF treated raw milk, could be that IF treatment deactivates LAB, leading to a decrease in lactic acid formation (Inácio (2014)).

As for titratability, the average initial value for fresh raw milk was observed to be 1.58±0.04 g/L lactic acid. Raw milk stored at 4 °C for 14-days had a substantial increase in TA with values reaching 1.98±0.03 g/L. These values are similar to what is found in literature (Ricardo et al. (2022)). For IF treatments, samples stored at −5 °C/70 MPa showed little to no variation to fresh raw milk and had a value of 1.58±0.06, while samples stored at −10 °C/100 MPa had a slight increase in TA to 1.73±0.06 g/ml. An explanation for the substantial increase in TA for RF milk could be that LAB continues to grow in the milk leading to more acidic conditions and having a higher TA. A good correlation between acidity and microorganisms is reported in Odriozola-Serrano et al. (2006). As for the IF treatments, due to the deactivation of LAB the TA stays roughly the same.

TABLE 8
Change in pH and titratable acidity (TA) values of different
storage treatments and 4 °C

| Treatment | Time | pH | TA(g/ml) |
|---|---|---|---|
| Raw milk (initial) | 0 | 6.74 ± .03 | 1.58 ± .03 |
| Raw milk (4 °C) | 2 weeks | 6.75 ± .02 | 1.98 ± .03 |
| IF −5 °C/77 MPa | 2 weeks | 6.79 ± .03 | 1.58 ± .06 |
| IF −10 °C/100 MPa | 2 weeks | 6.79 ± .03 | 1.73 ± .06 |

### 3.3. Color

The color parameters L*, a*, and b* were monitored in the different treatments and compared to that of fresh milk (Table 9). The total color change (ΔE*) is calculated by comparing treatment values to the initial values of fresh raw milk. In the case of L-values, IF −5 °C treatment did not show significantly different L-values from the raw milk (same whiteness). As for a and b-values, IF −5 °C treatment slightly decreased 9%±5% and 7%±3%, respectively.

For IF −10 °C and RF treatment, L-values both significantly decreased (less white) by 34%±1%. For IF −10 °C treatment, a-values dramatically increased (indicates less green) by 54%±3%. For the same treatment, b-value significantly decreased by 84%±4%. For RF treatment, a-values increased by 30%±3%, while b-values decreased by 175±4% (indicates bluer).

For all storage condition except treatment IF −5 °C, L* (measure of whiteness) decreased significantly. It is believed that the white color in milk is due to the scattering of light of casein particles (Harte et al. (2003)). Changes in the particle size of casein result in different light scatter Alexandros Ch. Stratakos (2019). While both storage methods, RF and IF −10 °C have reduced L*, they are for different reasons. In RF, lactic acid from LAB cause casein to coagulate or clump, resulting in less light scatter. In IF −10 °C case, a possible reason for a lower L* could be that high pressures cause an increase in casein micelles size which would affect the translucency of the milk, this was reported by Alexandros Ch. Stratakos (2019). In the case of IF −5 °C treatment, the slightly lower pressures could have less clumping effects on casein and therefore less effect on L*.

Surprisingly, in all treatment conditions a* tended to increase (less green). This was most significant in IF −10 °C treatment. Regarding b* (yellowness), changes varied between the different storage conditions. For both IF −10 °C and RF milk there is a significant reduction in b* (less yellow), refrigerated more so than IF −10 °C. As for IF −5 °C, there was a slight increase b* value. Some authors reported similar results with high pressure and low temperature treatment (Kim et. al (2008)). More work must be done to investigate these results as time increases.

TABLE 9
Percent change in color (L*%, a*%, b*%), and Lactoperoxidase
(LPO) activity of different storage methods compared to initial values.

| Treatment | Time | ΔL*% | Δa*% | Δb*% | LPO% |
|---|---|---|---|---|---|
| Raw milk (initial) | 0 | 0% | 0% | 0% | 0% |
| Raw milk (4 °C) | 2 weeks | −34 ± 1% | 30 ± 3% | −17 ± 4% | 0% |
| IF −5 °C/77 MPa | 2 weeks | 0% | −9 ± 5% | −7 ± 3% | 0% |
| IF −10 °C/100 MPa | 2 weeks | −34 ± 1% | 54 ± 3% | −84 ± 4% | 0% |

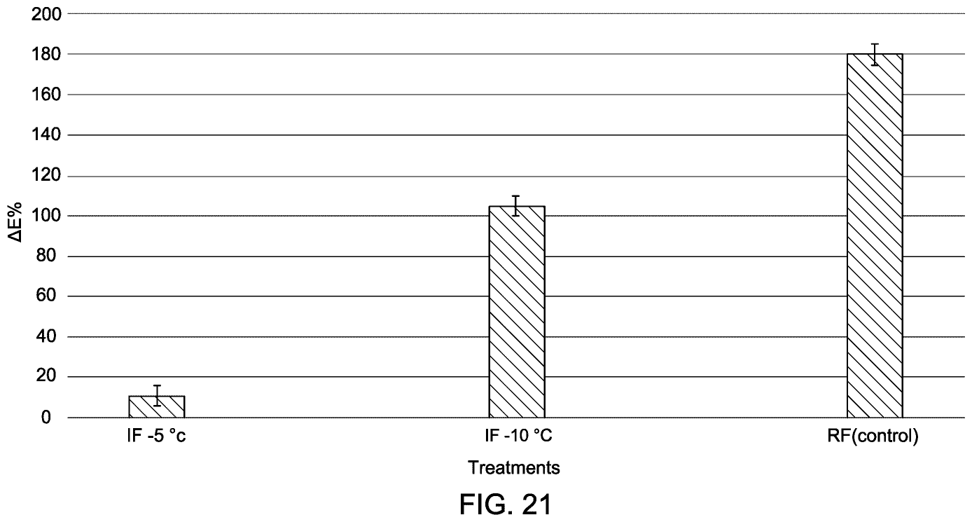

The total percent change ΔE %, is shown in FIG. 21. In terms of overall color change, ΔE %, the degree of color difference is classified as not noticeable (0-4%), slightly noticeable (4-12%), noticeable (12-24%), well visible (24-48%), and great (>48%) (Cserhalmi et al., 2006). According to this, IF −5 °C treatment had slightly noticeable color change, while both IF −10 °C and RF had great color difference.

### 3.4. Lactoperoxidase Activity

LPO is an important enzyme that has antimicrobial agents. With this property, LPO is only present when milk is of good microbiological quality, making LPO activity a good indicator of the quality of milk. No significant differences were found among all the different treatments (Table 9). Ricardo et al. observed a decrease in activity when applying similar pressures at room temperature. Enzyme activity is dependent on many variables such as pH, environment, pressure and temperature (Olfa et al. 2013). This makes it hard to find exact correlations between the effects of IF treatment on enzyme activity. Knowledge on the effects of high pressures (70-200 MPa) and low temperature (<0 °C) environments on enzyme activity is scarce and requires more work. Longer time periods might also be needed to note the effects of IF treatment in relation to RF raw milk.

### 3.5. Viscosity

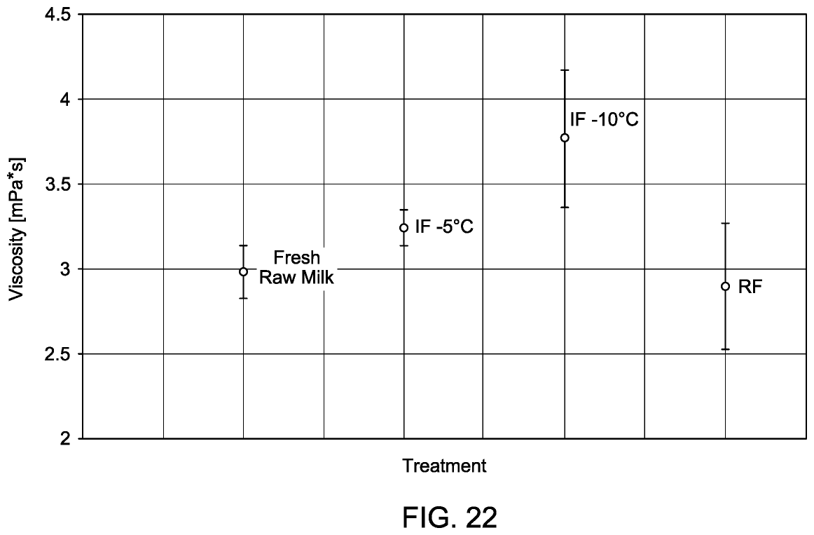

Viscosity is an important physical property that's correlated to the creaming rate of milk and in turn the shelf life. Viscosity values were measured initially (fresh raw milk) and for all the different treatments (FIG. 22). The initial viscosity of fresh raw milk was 3.00±0.15 mPa*s, similar to the values reported in literature (Ricardo et al. (2022)). There was no significant difference between IF −5 °C and RF compared to the initial viscosity, with values at 3.24±0.1 and 2.9±0.37 mPa*s. As for IF −10 °C, a slight increase in viscosity was observed. Several studies have shown that pressures above 200 MPA for 30 minutes can cause an increase in viscosity (Huppertz et al., 2003). Like color, these changes occur because of pressures effects on casein micelles, which change shape and affect the viscosity of the milk. It was reported that at pressures of 70 and 100 MPa, these changes did not occur (Ricardo et al. (2022)). Regardless of the treatment, the differences in viscosity were not visibly noticeable.

### 4. Conclusion

The effects of isochoric freezing (IF) on raw milk were investigated. Here also, as in the previous example, isochoric freezing to −5 °C and −10 °C results in substantial reduction in the microorganism load, while preservation at +4 °C results in an increase in the microbial load during preservation. While the percentage reduction here is similar to that in the previous carrot example, the residual concentrations of microorganisms are substantially higher, because the initial concentration in the raw milk was very high.

### 4. Mild Isochoric Freezing for the Preservation of Milk

### 1. Purpose of the Example

To prove the theory that a combination of milder conditions achieves the dual goals of inhibiting microbial growth without adversely affecting the milk's inherent qualities, this example was designed to explore the efficacy of milder isochoric freezing conditions, specifically focusing on lower pressures combined with sub-freezing temperatures. The purpose of the example was to determine whether these gentler conditions could provide a balanced solution, preserving both the microbial safety and the nutritional and sensory qualities of raw cow milk.

### 2.1. Mild Isochoric Freezing Conditions

A central feature of Isochoric freezing preservation (IFP) is the combination of elevated pressure and sub-zero temperature for achieving microbial inhibition. This innovative combination allows for pressures below 15 MPa to halt microbial growth—much lower than those required in standard hyperbaric storage (HS), which is as high as 50 MPa. These milder pressure conditions are high enough to exert inhibitory effects on bacteria, but gentle enough to not affect the structure of pressure-sensitive milk proteins and overall composition. The absence of ice formation within the milk also ensures that the nutritional components do not change structure, thereby preserving the nutritional profile.

In this Example, Isochoric freezing at −1.5 °C/15 MPa was used to preserve raw milk for two weeks and 5 weeks. The raw milk was treated using a pressure chamber made of Aluminum-7075 with Type-II anodize coating and with a total volume capacity of 1500 ml and pressure-rated for up to 275 MPa (Biochoric LLC, Bozeman, MT, USA). The chamber was connected to a pressure gauge to monitor the pressure over time. The chambers were cooled using a chest freezer (Magic Chef Model #HMCF9W3, MC Appliance Corporation, Wood Dale, IL).

### 2.2. Experimental Protocol

Among various food items, raw cow milk is an ideal candidate for investigating innovative preservation methods. Milk is not only one of the most nutritionally complete natural foods but also presents unique preservation challenges due to its composition and nearly neutral pH, which make it a fertile environment for bacterial growth. Additionally, raw milk inherently contains a diverse bacterial population, providing a rigorous test scenario for any preservation technique.

Raw milk was purchased from a local market located in Albany, California. The quality of the purchased raw milk was tested seven days before expiration (time=0), these tests include microbiological activity and physiochemical properties. On the same day, samples of the milk are prepared for isochoric freezing (IF) treatment.

Over a five-week period, various quality indicators such as microbiology, pH, titratable acidity, enzyme activity, viscosity, and volatile organic compounds were monitored. Additionally, pressure-sensitive proteins were analyzed using SDS PAGE to assess any changes in structure.

### 3. Result and Conclusion

### 3.1. Microbiological Evaluation

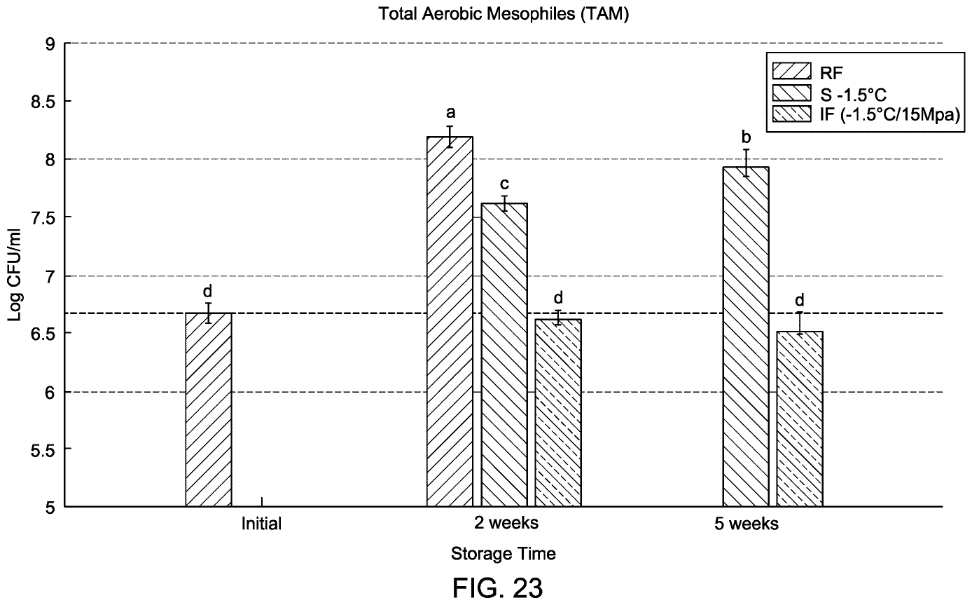

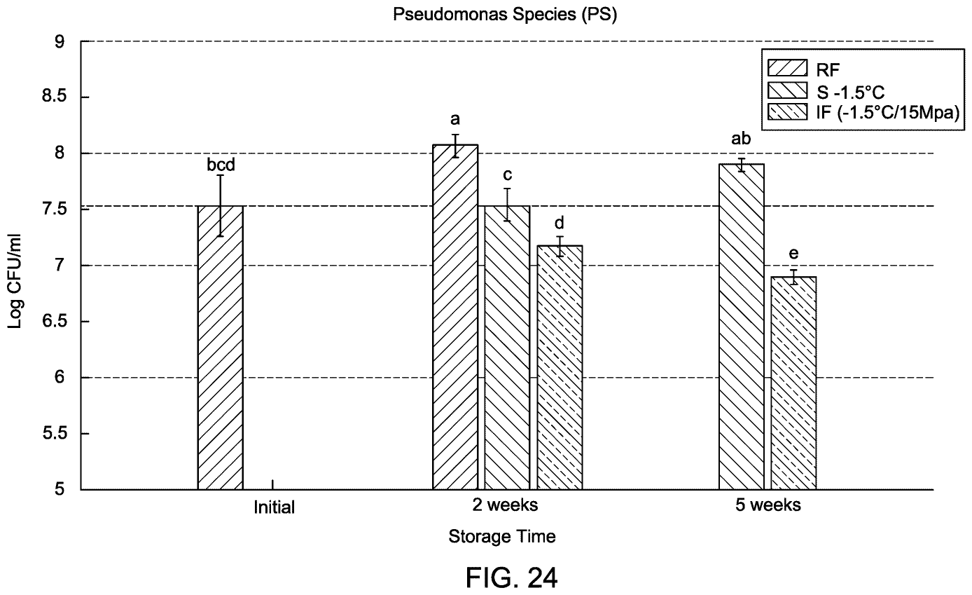

FIG. 23 and FIG. 24 show comparison of microbial evolution in Total Aerobic Mesophiles (TAM) and Pseudomonas Species (PS) under different storage conditions in raw milk: atmospheric pressure (0.1 MPa) at 4 °C (RF), supercooled at −1.5 °C (S), and isochoric freezing (IF) at −1.5 °C/15 MPa. Values are the means of data sets, and the standard deviations are indicated by the vertical error bars. a, b, c, d, e: Different letters for the same parameter indicate significantly different means (ANOVA; p<0.05).

Initial total Aerobic Mesophiles (TAM) of raw milk were about 6.7 log CFU mL⁻¹. Total Aerobic Mesophiles (TAM) under atmospheric pressure (0.1 MPa) at 4 °C (RF) condition increased to about 8.2 log CFU mL⁻¹ after 2 weeks of storage. Total Aerobic Mesophiles (TAM) under supercooled condition (at −1.5 °C) increased to 7.7 log CFU mL⁻¹ after 2 weeks of storage and further increased to about 7.9 log CFU mL⁻¹ after 4 weeks of storage. Total Aerobic Mesophiles (TAM) under isochoric freezing (IF) at −1.5 °C/15 MPa decreased to about 6.7 log CFU mL⁻¹ after 2 weeks of storage and further decreased to about 6.5 log CFU mL⁻¹ after 4 weeks of storage.

Initial total Pseudomonas Species (PS) of raw milk were about 7.5 log CFU mL⁻¹. Total Pseudomonas Species (PS) under atmospheric pressure (0.1 MPa) at 4 °C (RF) condition increased to about 8.1 log CFU mL⁻¹ after 2 weeks of storage. Total Pseudomonas Species (PS) under supercooled condition (at −1.5 °C) was not changed and was the same as the initial total Pseudomonas Species (PS) after 2 weeks of storage and increased to about 7.9 log CFU mL⁻¹ after 4 weeks of storage. Total Pseudomonas Species (PS) under isochoric freezing (IF) at −1.5 °C/15 MPa decreased to about 7.2 log CFU mL⁻¹ after 2 weeks of storage and further decreased to about 6.9 log CFU mL⁻¹ after 4 weeks of storage.

### 3.2. Conclusion

This example shows that milder isochoric freezing (IF) treatment also reduces the microbial load in raw milk when compared to RF (refrigeration) and supercooled condition and could lead to a longer shelf life.

The results show that while supercooled milk expired within the study period, milk stored under isochoric conditions retained high quality, comparable to fresh raw milk. Microbial growth was effectively inhibited under isochoric conditions, whereas it increased under supercooled conditions. Notably, protein structures were not affected by the isochoric freezing conditions, even after five weeks. These findings underscore the potential of isochoric freezing, utilizing moderate pressures and mild sub-freezing temperatures, to significantly extend the shelf life of perishable liquids without compromising their nutritional integrity.

Our successful application of isochoric freezing to extend the shelf life and maintain the nutritional integrity of raw cow milk under mild pressure and temperature conditions demonstrates the effectiveness of our method. The results obtained from milk, due to its complex composition of proteins, fats, and carbohydrates, as well as its inherent bacterial diversity, can reasonably be extrapolated to other perishable liquids and potentially more stable food products. The general principles of inhibiting microbial growth through controlled isochoric conditions, while preserving structural integrity and preventing nutrient loss, are applicable across a broad range of food types.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

What is claimed is:

1. A method for inhibiting biological contaminants during long term preservation of a biological matter while preserving nutritional and sensory qualities of the biological matter, comprising:
placing a biological matter in a fluid in an isochoric chamber; and
applying long term isochoric freezing to the fluid in the isochoric chamber at subfreezing temperature.

2. The method of claim 1, wherein the long term is from hours to years.

3. The method of claim 2, wherein the long term is more than 24 hours and up to about 10 years.

4. The method of any one of claims 1 to 3, wherein the subfreezing temperature is in the range of between 0 °C and −15 °C.

5. The method of claim 4, wherein the subfreezing temperature is in the range of 0 °C to about −10 °C.

6. The method of claim 4, wherein the subfreezing temperature is in the range of 0 °C to about −5 °C or 0 °C to about −2 °C.

7. The method of any one of claims 1 to 6, wherein the isochoric freezing is at a pressure in the range of about 0.1 MPa to about 150 Mpa.

8. The method of claim 7, wherein the pressure of the isochoric freezing is in the range of about 0.1 Mpa to about 100 Mpa.

9. The method of claim 7, wherein the pressure of the isochoric freezing is in the range of about 0.1 Mpa to about 35 Mpa.

10. The method of any one of claims 1 to 3, wherein the isochoric freezing is mild isochoric freezing, wherein pressure of the mild isochoric freezing is in the range of about 0.1 Mpa to about 15 Mpa and temperature of the mild isochoric freezing is in the range of −0.1 °C to about −5 °C.

11. The method of any one of claims 1 to 10, wherein the biological matter is directly placed in the isochoric chamber.

12. The method of any one of claims 1 to 10, wherein the biological matter is placed in a matter container.

13. The method of any one of claims 1 to 11, wherein the isochoric chamber contains a nucleating agent.

14. The method of any one of claims 1 to 13, wherein the biological matter is a cell, an organ, an organism, a biomedical product, an agricultural product, a food product, a fruit, or a beverage.

15. The method of claim 14, wherein the beverage is carrot juice, pomegranate juice, or milk.

16. The method of claim 14, wherein the fruit includes a whole fruit, a fresh-cut fruit, or arils.

17. The method of claim 14, wherein the fruit is a whole pomegranate or pomegranate arils.

18. The method of any one of claims 1 to 17, wherein the biological contaminants are microorganisms, mold, fungi, pathogens, viruses, or spores.

19. A method for reducing or eliminating biological contaminants during long term preservation of a biological matter while preserving nutritional and sensory qualities of the biological matter, comprising:
placing a biological matter in a fluid in an isochoric chamber, and
applying long term isochoric freezing to the fluid in the isochoric chamber at subfreezing temperature.

20. The method of claim 19, wherein the long term is from hours to years.

21. The method of claim 20, wherein the long term is more than 24 hours and up to 10 years.

22. The method of any one of claims 19 to 21, wherein the subfreezing temperature is in the range of between 0 °C and about −15 °C.

23. The method of claim 22, wherein the subfreezing temperature is in the range of 0 °C to about −10 °C.

24. The method of claim 22, wherein the subfreezing temperature is in the range of 0 °C to about −5 °C, or 0 °C to about −2 °C.

25. The method of any one of claims 19 to 24, wherein the isochoric freezing is at a pressure in the range of about 0.1 MPa to about 150 MPa.

26. The method of claim 25, wherein the pressure of the isochoric freezing is in the range of about 0.1 Mpa to about 100 MPa.

27. The method of claim 25, wherein the pressure of the isochoric freezing is in the range of about 0.1 Mpa to about 35 MPa.

28. The method of any one of claims 19 to 21, wherein the isochoric freezing is mild isochoric freezing, wherein pressure of the mild isochoric freezing is in the range of about 0.1 Mpa to about 15 Mpa and temperature of the mild isochoric freezing is in the range of −0.1 °C to about −5 °C.

29. The method of any one of claims 19 to 28, wherein the biological matter is directly placed in the isochoric chamber.

30. The method of any one of claims 19 to 28, wherein the biological matter is placed in a matter container.

31. The method of any one of claims 19 to 29, wherein the isochoric chamber contains a nucleating agent.

32. The method of any one of claims 19 to 31, wherein the biological matter is a cell, an organ, an organism, a biomedical product, an agricultural product, a food product, a fruit, or a beverage.

33. The method of claim 32, wherein the food product is dairy product or milk product.

34. The method of claim 32 or 33, wherein the biological matter is not sterilized before preservation process.

35. The method of any one of claims 19 to 34, wherein the biological contaminants are microorganisms, mold, fungi, pathogens, viruses, or spores.

36. A device for long term preservation of a biological matter and inhibiting or reducing biological contaminants in the biological matter while preserving nutritional and sensory qualities of the biological matter, comprising:
an isochoric chamber filled with a fluid containing a biological matter, wherein the isochoric chamber is applied to long term isochoric freezing at subfreezing temperature.

37. The device of claim 36, wherein the long term is from hours to years.

38. The device of claim 36 or 37, wherein the long term is more than 24 hours and up to about 10 years.

39. The device of any one of claims 36 to 38, wherein the subfreezing temperature is in the range of between 0 °C and about −15 °C.

40. The device of claim 39, wherein the subfreezing temperature is in the range of 0 °C to about −10 °C.

41. The device of claim 39, wherein the subfreezing temperature is in the range of 0 °C to about −5 °C.

42. The device of any one of claims 36 to 41, wherein the isochoric freezing is at a pressure in the range of about 0.1 MPa to about 150 MPa.

43. The device of claim 42, wherein the pressure of the isochoric freezing is in the range of about 0.1 Mpa to about 100 MPa.

44. The device of claim 42, wherein the pressure of the isochoric freezing is in the range of about 0.1 Mpa to about 35 MPa.

45. The device of any one of claims 36 to 38, wherein the isochoric freezing is mild isochoric freezing, wherein pressure of the mild isochoric freezing is in the range of about 0.1 Mpa to about 15 Mpa and temperature of the mild isochoric freezing is in the range of −0.1 °C to about-5 °C.

46. The device of any one of claims 36 to 45, wherein the biological matter is directly placed in the isochoric chamber.

47. The device of any one of claims 36 to 45, wherein the biological matter is placed in a matter container.

48. The device of any one of claims 36 to 46, wherein the fluid in the isochoric chamber is an aqueous solution or water.

49. The device of any one of claims 36 to 48, wherein the isochoric chamber contains a nucleating agent.

50. The device of any one of claims 36 to 49, wherein the biological matter is a cell, an organ, an organism, a biomedical product, an agricultural product, a food product, a fruit, or a beverage.

51. The device of claim 50, wherein the beverage is carrot juice or pomegranate juice.

52. The device of claim 50, wherein the fruit is a whole fruit, a fresh-cut fruit, or arils.

53. The device of claim 50, wherein the food product is a dairy product or a milk product.

54. The device of any one of claims 50 to 53, wherein the biological matter is not sterilized before preservation process.

55. The device of any one of claims 36 to 54, wherein the contaminants are microorganisms, mold, fungi, pathogens, viruses, or spores.

56. A method for preserving pomegranate or pomegranate arils, comprising:
placing the pomegranate or pomegranate arils in a container in an isochoric chamber, wherein the isochoric chamber is filled with fluid; and
applying long term isochoric freezing to the fluid in the isochoric chamber at subfreezing temperature, wherein the long term is from hours to years and the subfreezing temperature is in the range of 0 °C to about −10 °C.

57. The method of claim 56, wherein the isochoric freezing is mild isochoric freezing, wherein pressure of the mild isochoric freezing is in the range of about 0.1 Mpa to about 15 Mpa and temperature of the mild isochoric freezing is in the range of −0.1 °C to about −5 °C.

58. A method for preserving carrot juice, comprising:
placing the carrot juice in a container in an isochoric chamber, wherein the isochoric chamber is filled with fluid; and
applying long term isochoric freezing to the fluid in the isochoric chamber at subfreezing temperature, wherein the long term is from hours to years and the subfreezing temperature is in the range of 0 °C to about −10 °C.

59. The method of claim 58, wherein the isochoric freezing is mild isochoric freezing, wherein pressure of the mild isochoric freezing is in the range of about 0.1 Mpa to about 15 Mpa and temperature of the mild isochoric freezing is in the range of −0.1 °C to about −5 °C.

60. A method for preserving milk, comprising:
placing the milk in a container in an isochoric chamber, wherein the isochoric chamber is filled with fluid; and
applying long term isochoric freezing to the fluid in the isochoric chamber at subfreezing temperature, wherein the long term is from hours to years and the subfreezing temperature is in the range of 0 °C to about −10 °C.

61. The method of claim 60, wherein the isochoric freezing is mild isochoric freezing, wherein pressure of the mild isochoric freezing is in the range of about 0.1 Mpa to about 15 Mpa and temperature of the mild isochoric freezing is in the range of −0.1 °C to about −5 °C.
